(19) United States
(12) Patent Application Publication
(10) Pub. No.: US 2023/0265346 A1
(43) Pub. Date: Aug. 24, 2023

(54) LIQUID CRYSTAL COMPOSITION, OPTICALLY ANISOTROPIC LAYER, LAMINATE, AND IMAGE DISPLAY DEVICE

(71) Applicant: FUJIFILM Corporation, Tokyo (JP)

(72) Inventors: Wataru HOSHINO, Kanagawa (JP); Hiroshi MATSUYAMA, Kanagawa (JP); Keigo SHIGA, Kanagawa (JP)

(73) Assignee: FUJIFILM Corporation, Tokyo (JP)

(21) Appl. No.: 18/151,893

(22) Filed: Jan. 9, 2023

Related U.S. Application Data
(63) Continuation of application No. PCT/JP2021/024929, filed on Jul. 1, 2021.

(30) Foreign Application Priority Data
Jul. 14, 2020 (JP) 2020-120620

(51) Int. Cl. C09K 19/52; C09K 19/60

(52) U.S. Cl. CPC C09K 19/52; C09K 19/60; C09K 2019/528

(57) ABSTRACT

An object of the present invention is to provide a liquid crystal composition capable of forming an optically anisotropic layer with suppressed alignment defects and an excellent alignment degree, an optically anisotropic layer, a laminate, and an image display device. The liquid crystal composition of the present invention includes a rod-like liquid crystal compound, and an interface improver having a repeating unit B1 represented by Formula (N-1) and a repeating unit B2 having a fluorine atom. In Formula (N-1), R^{B11} and R^{B12} each independently represent a hydrogen atom or a substituent, and R^{B13} represents a hydrogen atom, an alkyl group having 1 to 5 carbon atoms, a halogen atom, or a cyano group. Here, in a case where R^{B11} and R^{B12} represent a substituent, R^{B11} and R^{B12} may be linked to each other to form a ring.

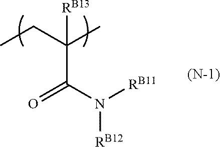

### CROSS-REFERENCE TO RELATED APPLICATIONS

This application is a Continuation of PCT International Application No. PCT/JP2021/024929 filed on Jul. 1, 2021, which claims priority under 35 U.S.C. § 119(a) to Japanese Patent Application No. 2020-120620 filed on Jul. 14, 2020. The above applications are hereby expressly incorporated by reference, in their entirety, into the present application.

### BACKGROUND OF THE INVENTION

### 1. Field of the Invention

The present invention relates to a liquid crystal composition, an optically anisotropic layer, a laminate, and an image display device.

### 2. Description of the Related Art

Optical films such as optical compensation sheets and phase difference films are used in various image display devices from the viewpoints of eliminating image coloration and expanding a viewing angle.

A stretched birefringence film has been used as an optical film. However, in recent years, it has been suggested to use an optically anisotropic layer (liquid crystal layer) formed of a liquid crystal compound in place of the stretched birefringence film.

Further, an optical film is usually required to have a uniform thickness in a plane. In order to achieve such a uniform thickness, in a case where a base material is coated with a liquid crystal composition, the coating is required to be made uniformly.

A liquid crystal composition containing a surfactant (interface improver) is used in some cases in order to make the coating uniformly, and a surfactant containing a fluorine atom is frequently used as the surfactant.

For example, WO2017/057005A describes an optical film including a layer (optically anisotropic layer) of a cured product obtained by curing a liquid crystal composition that contains a polymerizable liquid crystal compound and a surfactant having a fluorine atom. (claim 1).

### SUMMARY OF THE INVENTION

In recent years, an optically anisotropic layer formed of a liquid crystal composition has been required to further improve the performance, and specifically, an optically anisotropic layer with suppressed alignment defects and an excellent alignment degree has been required.

As a result of examination on the optically anisotropic layer as described in WO2017/057005A, the present inventors found that the alignment degree and the suppression of alignment defects do not satisfy the levels required in recent years in some cases depending on the kind of the interface improver used for forming the optically anisotropic layer, and thus there is room for improvement.

Therefore, an object of the present invention is to provide a liquid crystal composition capable of forming an optically anisotropic layer with suppressed alignment defects and an excellent alignment degree, an optically anisotropic layer, a laminate, and an image display device.

As a result of intensive examination conducted by the present inventors in order to achieve the above-described object, it was found that an optically anisotropic layer with suppressed alignment defects and an excellent alignment degree can be formed by using a liquid crystal composition containing an interface improver having a repeating unit B 1 represented by Formula (N-1) and a repeating unit B2 having a fluorine atom, thereby completing the present invention.

That is, the present inventors found that the above-described problems can be solved by employing the following configurations.

[1] A liquid crystal composition comprising: a rod-like liquid crystal compound; and an interface improver having a repeating unit B1 represented by Formula (N-1) and a repeating unit B2 having a fluorine atom,

in Formula (N-1), R^{B11} and R^{B12} each independently represent a hydrogen atom or a substituent, and R^{B13} represents a hydrogen atom, an alkyl group having 1 to 5 carbon atoms, a halogen atom, or a cyano group, where in a case where R^{B11} and R^{B12} represent a substituent, R^{B11} and R^{B12} may be linked to each other to form a ring.

The liquid crystal composition according to [1], in which in Formula (N-1), a total molecular weight of R^{B11} and R^{B12} is 100 or less.

The liquid crystal composition according to [1] or [2], in which in Formula (N-1), R^{B11} and R^{B12} each independently represent a hydrogen atom or an organic group having 1 to 15 carbon atoms.

The liquid crystal composition according to any one of [1] to [3], in which a content of the repeating unit B1 is in a range of 3% to 75% by mass with respect to all repeating units of the interface improver.

The liquid crystal composition according to any one of [1] to [4], in which the rod-like liquid crystal compound includes a polymer liquid crystal compound.

The liquid crystal composition according to [5], in which the rod-like liquid crystal compound further includes a low-molecular-weight liquid crystal compound.

The liquid crystal composition according to any one of [1] to [6], in which the repeating unit B2 includes at least one of a repeating unit represented by Formula (F-1) or a repeating unit represented by Formula (F-2),
in Formula (F-1),
LF1 represents a single bond or a divalent linking group,
R1 represents a hydrogen atom, a fluorine atom, a chlorine atom, or an alkyl group having 1 to 20 carbon atoms,
RF1 represents a group containing at least one of groups (a) to (e),
   (a) a group represented by Formula (1), (2), or (3),
   (b) a perfluoropolyether group,
   (c) an alkyl group having 1 to 20 carbon atoms, which has a hydrogen bond between a proton-donating functional group and a proton-accepting functional group and in which at least one carbon atom has a fluorine atom as a substituent,
   (d) a group represented by Formula (1-d), and
   (e) a group represented by Formula (1-e),
in Formula (1-d), X represents a hydrogen atom or a substituent, T10 represents a terminal group, 1 represents an integer of 1 to 20, m represents an integer of 0 to 2, n represents an integer of 1 or 2, and m + n is 2,
in Formula (1-e), R2 represents a hydrogen atom, a fluorine atom, a chlorine atom, or an alkyl group having 1 to 20 carbon atoms, LF2 represents a single bond or a divalent linking group, RF11 and RF12 each independently represent a perfluoropolyether group, and * represents a bonding position with respect to LF1 in Formula (F-1),
in Formula (F-2),
R2 represents a hydrogen atom, a fluorine atom, a chlorine atom, or an alkyl group having 1 to 4 carbon atoms, and LF2 represents the same group as LF1 in Formula (F-1),
SP21 and SP22 each independently represent a spacer group,
DF2 represents an (m2 + 1)-valent group,
T2 represents a terminal group,
RF2 represents a group having a fluorine atom,
n2 represents an integer of 2 or greater, m2 represents an integer of 2 or greater, and m2 is greater than or equal to n2.

The liquid crystal composition according to any one of [1] to [7], further comprising a dichroic substance.

An optically anisotropic layer which is formed of the liquid crystal composition according to any one of [1] to [8].

A laminate comprising: a base material; and the optically anisotropic layer according to [9] which is provided on the base material, in which the rod-like liquid crystal compound contained in the optically anisotropic layer is fixed in a state of being aligned in a horizontal direction.

The laminate according to [10], further comprising: a λ/4 plate provided on the optically anisotropic layer.

An image display device comprising: the optically anisotropic layer according to [9]; or the laminate according to [10] or [11].

According to the present invention, it is possible to provide a liquid crystal composition capable of forming an optically anisotropic layer with suppressed alignment defects and an excellent alignment degree, an optically anisotropic layer, a laminate, and an image display device.

### BRIEF DESCRIPTION OF THE DRAWINGS

FIG. 1A is a diagram showing an example of a block structure that a specific interface improver may have.

FIG. 1B is a diagram showing an example of a block structure that the specific interface improver may have.

FIG. 1C is a diagram showing an example of a block structure that the specific interface improver may have.

FIG. 1D is a diagram showing an example of a block structure that the specific interface improver may have.

FIG. 1E is a diagram showing an example of a block structure that the specific interface improver may have.

FIG. 2A is a diagram showing an example of a graft structure that the specific interface improver may have.

FIG. 2B is a diagram showing an example of a graft structure that the specific interface improver may have.

FIG. 2C is a diagram showing an example of a graft structure that the specific interface improver may have.

FIG. 2D is a diagram showing an example of a graft structure that the specific interface improver may have.

FIG. 2E is a diagram showing an example of a graft structure that the specific interface improver may have.

FIG. 2F is a diagram showing an example of a graft structure that the specific interface improver may have.

FIG. 2G is a diagram showing an example of a graft structure that the specific interface improver may have.

FIG. 3 is a diagram showing a method of synthesizing the specific interface improver in a case where the specific interface improver has a graft structure.

FIG. 4A is a diagram showing an example of a star structure that the specific interface improver may have.

FIG. 4B is a diagram showing an example of a star structure that the specific interface improver may have.

FIG. 4C is a diagram showing an example of a star structure that the specific interface improver may have.

FIG. 4D is a diagram showing an example of a star structure that the specific interface improver may have.

FIG. 5A is a diagram showing an example of a branched structure that the specific interface improver may have.

FIG. 5B is a diagram showing an example of a branched structure that the specific interface improver may have.

FIG. 5C is a diagram showing an example of a branched structure that the specific interface improver may have.

FIG. 5D is a diagram showing an example of a branched structure that the specific interface improver may have.

FIG. 5E is a diagram showing an example of a branched structure that the specific interface improver may have.

FIG. 5F is a diagram showing an example of a branched structure that the specific interface improver may have.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In addition, in the present specification, a numerical range shown using “to” indicates a range including numerical values described before and after “to” as a lower limit value and an upper limit value.

Further, in the present specification, parallel, orthogonal, horizontal, and vertical do not indicate parallel, orthogonal, horizontal, and vertical in a strict sense, but respectively indicate a range of parallel ±10°, a range of orthogonal ±10°, a range of horizontal ±10°, and a range of vertical ±10°.

Further, in the present specification, materials corresponding to respective components may be used alone or in combination of two or more kinds thereof. Here, in a case where two or more kinds of materials corresponding to respective components are used in combination, the content of the components indicates the total content of the combined materials unless otherwise specified.

Further, in the present specification, “(meth)acrylate” is a notation representing “acrylate” or “methacrylate”, “(meth)acryl” is a notation representing “acryl” or “methacryl”, and “(meth)acryloyl” is a notation representing “acryloyl” or “methacryloyl”.

### Substituent W

A substituent W used in the present specification represents any of the following groups.

Examples of the substituent W include a halogen atom, an alkyl group having 1 to 20 carbon atoms, a halogenated alkyl group having 1 to 20 carbon atoms, a cycloalkyl group having 1 to 20 carbon atoms, an alkylcarbonyl group having 1 to 10 carbon atoms, an alkyloxycarbonyl group having 1 to 10 carbon atoms, an alkylcarbonyloxy group having 1 to 10 carbon atoms, an alkylamino group having 1 to 10 carbon atoms, an alkylaminocarbonyl group, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), or a sulfate group (—OSO₃H), and other known substituents.

The details of the substituent are described in paragraph [0023] of JP2007-234651A.

Further, the substituent W may be a group represented by Formula (W1).

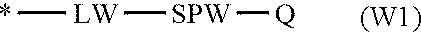

In Formula (W1), LW represents a single bond or a divalent linking group, SPW represents a divalent spacer group, Q represents Q1 or Q2 in Formula (LC) described below, and * represents a bonding position.

Examples of the divalent linking group represented by LW include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —S(O)—, —S(O)(O)—, —(O)S(O)O—, —O(O)S(O)O—, —SC(O)—, and —C(O)S—. LW may represent a group in which two or more of these groups are combined (hereinafter, also referred to as “L-C”).

Examples of the divalent spacer group represented by SPW include a linear, branched, or cyclic alkylene group having 1 to 50 carbon atoms, and a heterocyclic group having 1 to 20 carbon atoms.

The carbon atoms of the alkylene group and the heterocyclic group may be substituted with —O—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent hydrogen, an alkyl group having 1 to 4 carbon atoms, a cycloalkyl group, an aryl group, a cyano group, or a halogen atom), —C≡C—, —N═N—, —S—, —C(S)—, —S(O)—, —SO₂—, —(O)S(O)O—, —O(O)S(O)O—, —SC(O)—, —C(O)S—, or a group obtained by combining two or more of these groups (hereinafter, also referred to as “SP-C”).

Further, the hydrogen atom of the alkylene group and the hydrogen atom of the heterocyclic group may be substituted with a halogen atom, a cyano group, -Z^{H}, —OH—, —OZ^{H}, — COOH, —C(O)Z^{H},— C(O)OZH, —OC(O)Z^{H}, —OC(O)OZ^{H}, —NZ^{H}Z^{H}′, —NZ^{H}C(O)Z^{H}′, — NZ^{H}C(O)OZ^{H}′, —C(O)NZ^{H}Z^{H}′, —OC(O)NZ^{H}Z^{H}′, -NZ^{H}C(O)NZ^{H}′OZ^{H}”, —SH, —SZ^{H}, —C(S)Z^{H}, or (hereinafter, also referred to as “SP-H”). Here, Z^{H} and Z^{H}′ represent an alkyl group having 1 to 10 carbon atoms, a halogenated alkyl group, or —L—CL (L represents a single bond or a divalent linking group, specific examples of the divalent linking group are the same as those of LW and SPW described above, CL represents a crosslinkable group, and examples thereof include a group represented by Q1 or Q2 in Formula (LC), and a crosslinkable group represented by any of Formulae (P-1) to (P-30) is preferable.

### Liquid Crystal Composition

A liquid crystal composition according to the embodiment of the present invention a rod-like liquid crystal compound and an interface improver having a repeating unit B1 represented by Formula (N-1) and a repeating unit B2 having a fluorine atom (hereinafter, also referred to as “specific interface improver”).

According to the liquid crystal composition according to the embodiment of the present invention, an optically anisotropic layer with suppressed alignment defects and an excellent alignment degree can be formed.

Although the details of the reason are not yet clear, the present inventors assume that the reason is as follows.

Since the specific interface improver has the repeating unit B2 having a fluorine atom, the specific interface improver is assumed to be present on a surface of an optically anisotropic layer during the formation of the optically anisotropic layer formed of the liquid crystal composition according to the embodiment of the present invention. That is, the specific interface improver can affect the alignment of the rod-like liquid crystal compound in the vicinity of the surface.

Here, the specific interface improver may be compatible with liquid crystal molecules depending on the kind of the repeating unit other than the repeating unit B2 having a fluorine atom, and in a case where the specific interface improver is compatible with liquid crystal molecules, the alignment in the vicinity of the surface of the optically anisotropic layer is disturbed, and this may result in occurrence of alignment defects or degradation of aligning properties.

On the contrary, it is considered that a repeating unit B1 having an amide structure has a high interaction with the repeating units B1, and thus the compatibility between the specific interface improver and the liquid crystal molecules can be reduced. As a result, it is assumed that an optically anisotropic layer with less alignment defects and an excellent alignment degree is obtained.

Hereinafter, the components contained in the liquid crystal composition according to the embodiment of the present invention and components that can be contained therein will be described.

### Rod-Like Liquid Crystal Compound

Typically, the liquid crystal compound can be classified into a rod type compound and a disk type compound depending on the shape thereof. The liquid crystal composition according to the embodiment of the present invention contains a rod-like liquid crystal compound having a rod shape.

A liquid crystal compound that does not exhibit dichroic properties in a visible region is preferable as the rod-like liquid crystal compound.

As such a rod-like liquid crystal compound, both a low-molecular-weight liquid crystal compound and a polymer liquid crystal compound can be used. Here, the “low-molecular-weight liquid crystal compound” indicates a liquid crystal compound having no repeating units in the chemical structure. Here, the “polymer liquid crystal compound” is a liquid crystal compound having a repeating unit in the chemical structure.

Examples of the low-molecular-weight liquid crystal compound include liquid crystal compounds described in JP2013-228706A.

Examples of the polymer liquid crystal compound include thermotropic liquid crystal polymers described in JP2011-237513A. Further, the polymer liquid crystal compound may contain a crosslinkable group (such as an acryloyl group or a methacryloyl group) at a terminal.

The rod-like liquid crystal compound may be used alone or in combination of two or more kinds thereof.

From the viewpoint that the effects of the present invention are more excellent, the rod-like liquid crystal compound includes preferably a polymer liquid crystal compound and particularly preferably both a polymer liquid crystal compound and a low-molecular-weight liquid crystal compound.

It is preferable that the rod-like liquid crystal compound includes a liquid crystal compound represented by Formula (LC) or a polymer thereof. The liquid crystal compound represented by Formula (LC) or a polymer thereof is a compound exhibiting liquid crystallinity. The liquid crystallinity may be a nematic phase or a smectic phase, and may exhibit both a nematic phase and a smectic phase and preferably at least a nematic phase.

The smectic phase may be a higher-order smectic phase. The higher-order smectic phase here denotes a smectic B phase, a smectic D phase, a smectic E phase, a smectic F phase, a smectic G phase, a smectic H phase, a smectic I phase, a smectic J phase, a smectic K phase, or a smectic L phase. Among these, a smectic B phase, a smectic F phase, or a smectic I phase is preferable.

In a case where the smectic liquid crystal phase exhibited by the liquid crystal compound is any of these higher-order smectic liquid crystal phases, an optically anisotropic layer with a higher alignment degree order can be prepared. Further, the optically anisotropic layer prepared from such a higher-order smectic liquid crystal phase with a high alignment degree order is a layer in which a Bragg peak derived from a higher-order structure such as a hexatic phase or a crystal phase in X-ray diffraction measurement is obtained. The Bragg peak is a peak derived from a plane periodic structure of molecular alignment, and according to the liquid crystal composition according to the embodiment of the present invention, an optically anisotropic layer having a periodic interval of 3.0 to 5.0 Å can be obtained.

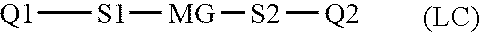

In Formula (LC), Q1 and Q2 each independently represent a hydrogen atom, a halogen atom, a linear, branched, or cyclic alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (-B(OH)₂), a phosphate group (-OPO(OH)₂), a sulfate group (-OSO₃H), or a crosslinkable group represented by any of Formulae (P-1) to (P-30), and it is preferable that at least one of Q1 or Q2 represents a crosslinkable group represented by any of the following formulae.

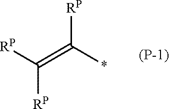

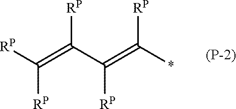

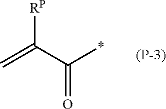

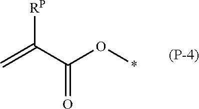

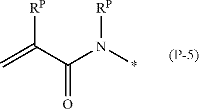

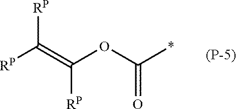

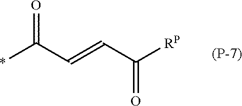

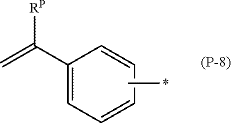

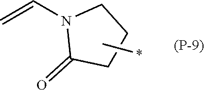

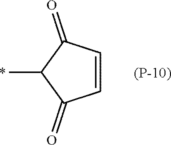 [SMILES: *C1C(=O)C=CC1=O]

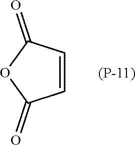

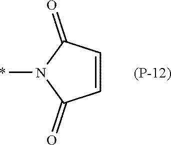 [SMILES: *N1C(=O)C=CC1=O]

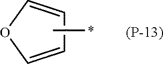

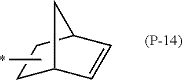

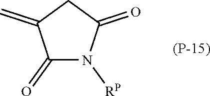

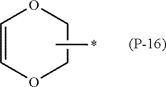

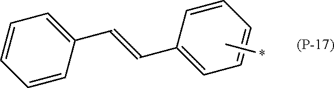

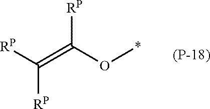

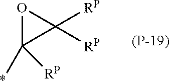

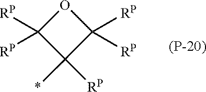

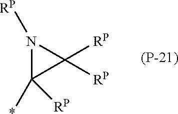

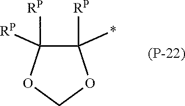

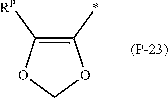

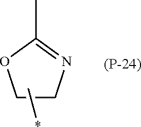

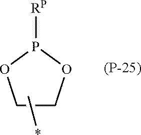

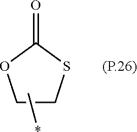

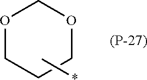

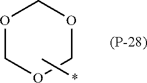

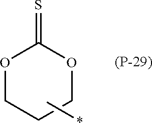

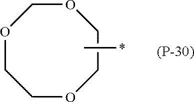

In Formulae (P-1) to (P-30), R^{P} represents a hydrogen atom, a halogen atom, a linear, branched, or cyclic alkylene group having 1 to 10 carbon atoms, a halogenated alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (-B(OH)₂), a phosphate group (—OPO(OH)₂), or a sulfate group (—OSO₃H), and a plurality of R^{P}’s may be the same as or different from each other.

Preferred aspects of the crosslinkable group include a radically polymerizable group and a cationically polymerizable group. As the radically polymerizable group, a vinyl group represented by Formula (P-1), a butadiene group represented by Formula (P-2), a (meth)acryl group represented by Formula (P-4), a (meth)acrylamide group represented by Formula (P-5), a vinyl acetate group represented by Formula (P-6), a fumaric acid ester group represented by Formula (P-7), a styryl group represented by Formula (P-8), a vinylpyrrolidone group represented by Formula (P-9), a maleic acid anhydride represented by Formula (P-11), or a maleimide group represented by Formula (P-12) is preferable. As the cationically polymerizable group, a vinyl ether group represented by Formula (P-18), an epoxy group represented by Formula (P-19), or an oxetanyl group represented by Formula (P-20) is preferable.

In Formula (LC), S1 and S2 each independently represent a divalent spacer group, and suitable aspects of S1 and S2 include the same structures as those for SPW in Formula (W1), and thus the description thereof will not be repeated.

In Formula (LC), MG represents a mesogen group described below. The mesogen group represented by MG is a group showing a main skeleton of a liquid crystal molecule that contributes to liquid crystal formation. A liquid crystal molecule exhibits liquid crystallinity which is in an intermediate state (mesophase) between a crystal state and an isotropic liquid state. The mesogen group is not particularly limited and for example, particularly description on pages 7 to 16 of “FlussigeKristalle in Tabellen II” (VEB Deutsche Verlag fur Grundstoff Industrie, Leipzig, 1984) and particularly the description in Chapter 3 of “Liquid Crystal Handbook” (Maruzen, 2000) edited by Liquid Crystals Handbook Editing Committee can be referred to.

The mesogen group represented by MG has preferably 2 to 10 cyclic structures and more preferably 3 to 7 cyclic structures.

Specific examples of the cyclic structure include an aromatic hydrocarbon group, a heterocyclic group, and an alicyclic group.

From the viewpoints of exhibiting the liquid crystallinity, adjusting the liquid crystal phase transition temperature, and the availability of raw materials and synthetic suitability and from the viewpoint that the effects of the present invention are more excellent, as the mesogen group represented by MG, a group represented by Formula (MG-A) or Formula (MG-B) is preferable, and a group represented by Formula (MG-B) is more preferable.

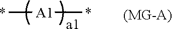

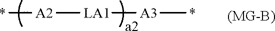

In Formula (MG-A), A1 represents a divalent group selected from the group consisting of an aromatic hydrocarbon group, a heterocyclic group, and an alicyclic group. These groups may be substituted with a substituent such as the substituent W.

It is preferable that the divalent group represented by A1 is a 4- to 15-membered ring. Further, the divalent group represented by A1 may be a monocycle or a fused ring.

Further, * represents a bonding position with respect to S1 or S2.

Examples of the divalent aromatic hydrocarbon group represented by A1 include a phenylene group, a naphthylene group, a fluorene-diyl group, an anthracene-diyl group, and a tetracene-diyl group. From the viewpoints of design diversity of a mesogenic skeleton and the availability of raw materials, a phenylene group or a naphthylene group is preferable.

The divalent heterocyclic group represented by A1 may be any of aromatic or nonaromatic, but a divalent aromatic heterocyclic group is preferable as the divalent heterocyclic group from the viewpoint of further improving the alignment degree.

The atoms other than carbon constituting the divalent aromatic heterocyclic group include a nitrogen atom, a sulfur atom, and an oxygen atom. In a case where the aromatic heterocyclic group has a plurality of atoms constituting a ring other than carbon, these may be the same as or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, a thienooxazole-diyl group, and the following structures (II-1) to (II-4).

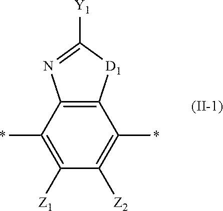

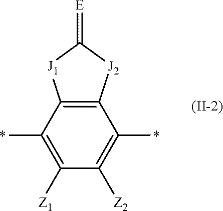

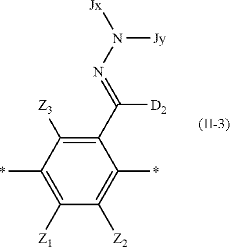

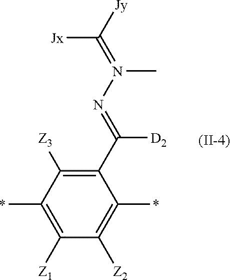

In Formulae (II-1) to (II-4), D₁ represents —S—, —O—, or NR¹¹—, R¹¹ represents a hydrogen atom or an alkyl group having 1 to 6 carbon atoms, Y₁ represents an aromatic hydrocarbon group having 6 to 12 carbon atoms or an aromatic heterocyclic group having 3 to 12 carbon atoms, Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, -NR¹²R¹³, or —SR¹², Z₁ and Z₂ may be bonded to each other to form an aromatic ring or an aromatic heterocyclic ring, R¹² and R¹³ each independently represent a hydrogen atom or an alkyl group having 1 to 6 carbon atoms, J₁ and J₂ each independently represent a group selected from the group consisting of —O—, —NR²¹— (R²¹ represents a hydrogen atom or substituent), —S—, and —C(O)—, E represents a hydrogen atom or a non-metal atom of a Group 14 to a Group 16 to which a substituent may be bonded, Jx represents an organic group having 2 to 30 carbon atoms, which has at least one aromatic ring selected from the group consisting of an aromatic hydrocarbon ring and an aromatic heterocyclic ring, Jy represents a hydrogen atom, an alkyl group having 1 to 6 carbon atoms which may have a substituent, or an organic group having 2 to 30 carbon atoms which has at least one aromatic ring selected from the group consisting of an aromatic hydrocarbon ring and an aromatic heterocyclic ring, the aromatic ring of Jx and Jy may have a substituent, Jx and Jy may be bonded to each other to form a ring, and D₂ represents a hydrogen atom or an alkyl group having 1 to 6 carbon atoms which may have a substituent.

In Formula (II-2), in a case where Y₁ represents an aromatic hydrocarbon group having 6 to 12 carbon atoms, the aromatic hydrocarbon group may be monocyclic or polycyclic. In a case where Y₁ represents an aromatic heterocyclic group having 3 to 12 carbon atoms, the aromatic heterocyclic group may be monocyclic or polycyclic.

In Formula (II-2), in a case where J₁ and J₂ represent —NR²¹—, as the substituent represented by R²¹, for example, paragraphs 0035 to 0045 of JP2008-107767A can be referred to, and the content thereof is incorporated in the present specification.

In Formula (II-2), in a case where E represents a non-metal atom of a Group 14 to a Group 16 to which a substituent may be bonded, ═O, ═S, ═NR′, or ═C(R′)R′ is preferable. R′ represents a substituent, and as the substituent, for example, the description in paragraphs [0035] to [0045] of JP2008-107767A can be referred to, and -NZ^{A1}Z^{A2} (Z^{A1} and Z^{A2} each independently represent a hydrogen atom, an alkyl group, or an aryl group) is preferable.

Specific examples of the divalent alicyclic group represented by A1 include a cyclopentylene group and a cyclohexylene group, and the carbon atoms thereof may be substituted with —O—, —Si(CH₃)₂—, —N(Z)— (Z represents a hydrogen atom, an alkyl group having 1 to 4 carbon atoms, a cycloalkyl group, an aryl group, a cyano group, or a halogen atom), —C(O)—, —S—, —C(S)—, —S(O)—, —SO₂—, or a group obtained by combining two or more of these groups.

In Formula (MG-A), a1 represents an integer of 2 to 10. The plurality of A1′s may be the same as or different from each other.

In Formula (MG-B), A2 and A3 each independently represent a divalent group selected from the group consisting of an aromatic hydrocarbon group, a heterocyclic group, and an alicyclic group. Specific examples and suitable aspects of A2 and A3 are the same as those for A1 in Formula (MG-A), and thus description thereof will not be repeated.

In Formula (MG-B), a2 represents an integer of 1 to 10, a plurality of A2′s may be the same as or different from each other, and a plurality of LA1′s may be the same as or different from each other. From the viewpoint that the effects of the present invention are more excellent, it is preferable that a2 represents 2 or greater.

In Formula (MG-B), LA1 represents a single bond or divalent linking group. Here, LA1 represents a divalent linking group in a case where a2 represents 1, and at least one of the plurality of LA1′s represents a divalent linking group in a case where a2 represents 2 or greater.

In Formula (MG-B), examples of the divalent linking group represented by LA1 are the same as those for LW, and thus the description thereof will not be repeated.

Specific examples of MG include the following structures, the hydrogen atoms on the aromatic hydrocarbon group, the heterocyclic group, and the alicyclic group in the following structures may be substituted with the substituent W described above.

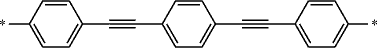 [SMILES: *c1ccc(C#Cc2ccc(C#Cc3ccc(*)cc3)cc2)cc1]

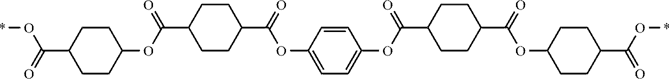 [SMILES: *OC(=O)C1CCC(OC(=O)C2CCC(C(=O)Oc3ccc(OC(=O)C4CCC(C(=O)OC5CCC(C(=O)O*)CC5)CC4)cc3)CC2)CC1]

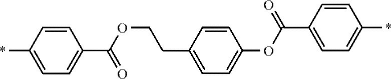 [SMILES: *c1ccc(C(=O)OCCc2ccc(OC(=O)c3ccc(*)cc3)cc2)cc1]

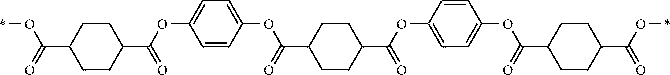 [SMILES: *OC(=O)C1CCC(C(=O)Oc2ccc(OC(=O)C3CCC(C(=O)Oc4ccc(OC(=O)C5CCC(C(=O)O*)CC5)cc4)CC3)cc2)CC1]

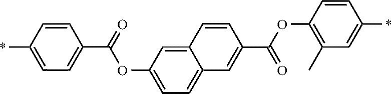 [SMILES: *c1ccc(C(=O)Oc2ccc3cc(C(=O)Oc4ccc(*)cc4C)ccc3c2)cc1]

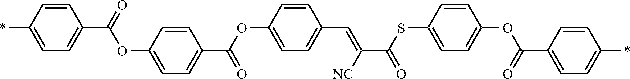 [SMILES: *c1ccc(C(=O)Oc2ccc(SC(=O)/C(C#N)=C/c3ccc(OC(=O)c4ccc(OC(=O)c5ccc(*)cc5)cc4)cc3)cc2)cc1]

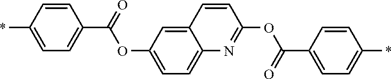 [SMILES: *c1ccc(C(=O)Oc2ccc3nc(OC(=O)c4ccc(*)cc4)ccc3c2)cc1]

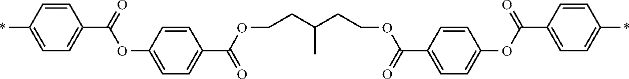 [SMILES: *c1ccc(C(=O)Oc2ccc(C(=O)OCCC(C)CCOC(=O)c3ccc(OC(=O)c4ccc(*)cc4)cc3)cc2)cc1]

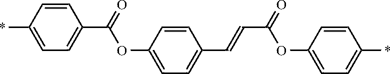 [SMILES: *c1ccc(OC(=O)/C=C/c2ccc(OC(=O)c3ccc(*)cc3)cc2)cc1]

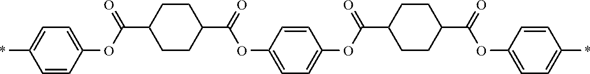 [SMILES: *c1ccc(OC(=O)C2CCC(C(=O)Oc3ccc(OC(=O)C4CCC(C(=O)Oc5ccc(*)cc5)CC4)cc3)CC2)cc1]

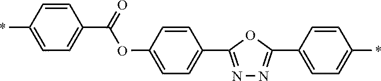 [SMILES: *c1ccc(C(=O)Oc2ccc(-c3nnc(-c4ccc(*)cc4)o3)cc2)cc1]

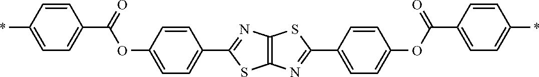 [SMILES: *c1ccc(C(=O)Oc2ccc(-c3nc4sc(-c5ccc(OC(=O)c6ccc(*)cc6)cc5)nc4s3)cc2)cc1]

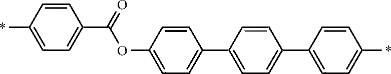 [SMILES: *c1ccc(C(=O)Oc2ccc(-c3ccc(-c4ccc(*)cc4)cc3)cc2)cc1]

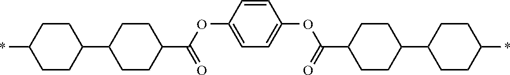 [SMILES: *C1CCC(C2CCC(C(=O)Oc3ccc(OC(=O)C4CCC(C5CCC(*)CC5)CC4)cc3)CC2)CC1]

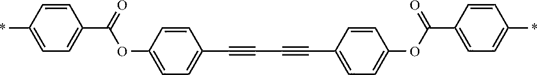 [SMILES: *c1ccc(C(=O)Oc2ccc(C#CC#Cc3ccc(OC(=O)c4ccc(*)cc4)cc3)cc2)cc1]

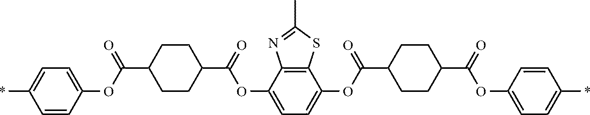 [SMILES: *c1ccc(OC(=O)C2CCC(C(=O)Oc3ccc(OC(=O)C4CCC(C(=O)Oc5ccc(*)cc5)CC4)c4sc(C)nc34)CC2)cc1]

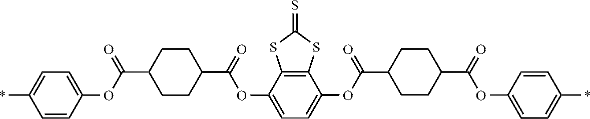 [SMILES: *c1ccc(OC(=O)C2CCC(C(=O)Oc3ccc(OC(=O)C4CCC(C(=O)Oc5ccc(*)cc5)CC4)c4sc(=S)sc34)CC2)cc1]

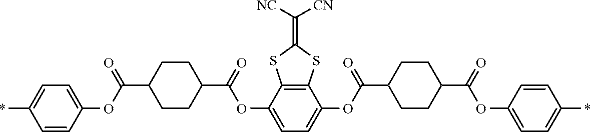 [SMILES: *c1ccc(OC(=O)C2CCC(C(=O)Oc3ccc(OC(=O)C4CCC(C(=O)Oc5ccc(*)cc5)CC4)c4c3SC(=C(C#N)C#N)S4)CC2)cc1]

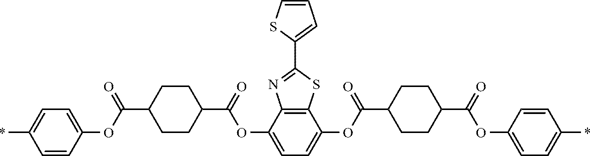 [SMILES: *c1ccc(OC(=O)C2CCC(C(=O)Oc3ccc(OC(=O)C4CCC(C(=O)Oc5ccc(*)cc5)CC4)c4sc(-c5cccs5)nc34)CC2)cc1]

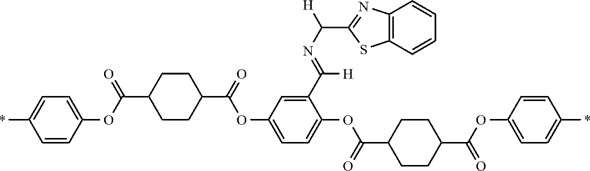 [SMILES: *c1ccc(OC(=O)C2CCC(C(=O)Oc3ccc(OC(=O)C4CCC(C(=O)Oc5ccc(*)cc5)CC4)c(/C=N/Cc4nc5ccccc5s4)c3)CC2)cc1]

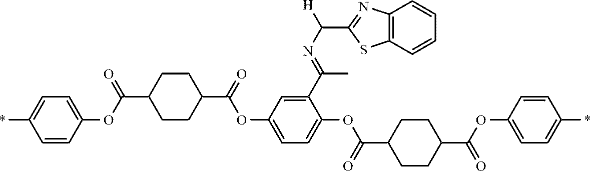 [SMILES: *c1ccc(OC(=O)C2CCC(C(=O)Oc3ccc(OC(=O)C4CCC(C(=O)Oc5ccc(*)cc5)CC4)c(/C(C)=N/Cc4nc5ccccc5s4)c3)CC2)cc1]

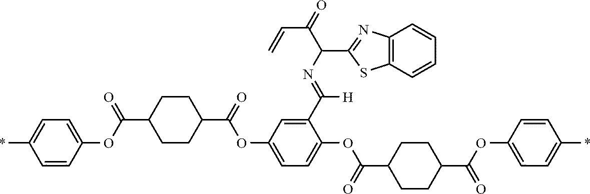 [SMILES: *c1ccc(OC(=O)C2CCC(C(=O)Oc3ccc(OC(=O)C4CCC(C(=O)Oc5ccc(*)cc5)CC4)c(/C=N/C(C(=O)C=C)c4nc5ccccc5s4)c3)CC2)cc1]

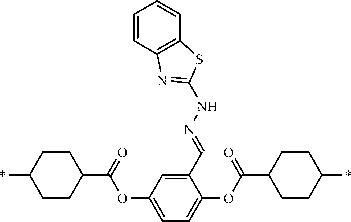 [SMILES: *C1CCC(C(=O)Oc2ccc(OC(=O)C3CCC(*)CC3)c(/C=N/Nc3nc4ccccc4s3)c2)CC1]

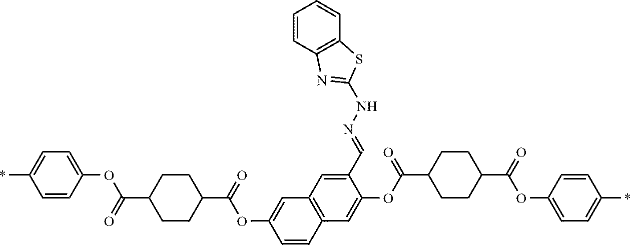 [SMILES: *c1ccc(OC(=O)C2CCC(C(=O)Oc3ccc4cc(OC(=O)C5CCC(C(=O)Oc6ccc(*)cc6)CC5)c(/C=N/Nc5nc6ccccc6s5)cc4c3)CC2)cc1]

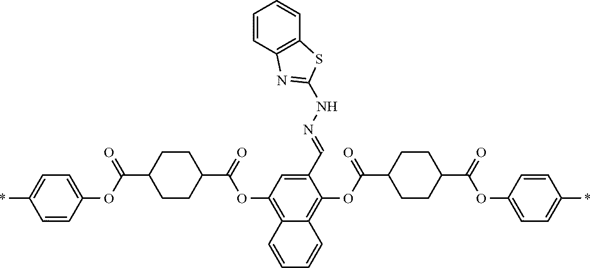 [SMILES: *c1ccc(OC(=O)C2CCC(C(=O)Oc3cc(/C=N/Nc4nc5ccccc5s4)c(OC(=O)C4CCC(C(=O)Oc5ccc(*)cc5)CC4)c4ccccc34)CC2)cc1]

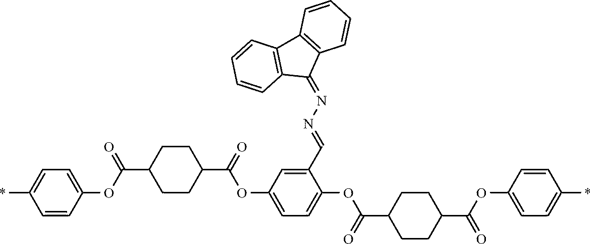 [SMILES: *c1ccc(OC(=O)C2CCC(C(=O)Oc3ccc(OC(=O)C4CCC(C(=O)Oc5ccc(*)cc5)CC4)c(/C=N/N=C4c5ccccc5-c5ccccc54)c3)CC2)cc1]

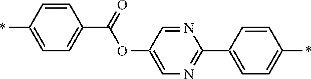 [SMILES: *c1ccc(C(=O)Oc2cnc(-c3ccc(*)cc3)nc2)cc1]

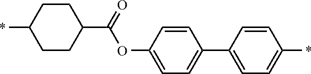 [SMILES: *c1ccc(-c2ccc(OC(=O)C3CCC(*)CC3)cc2)cc1]

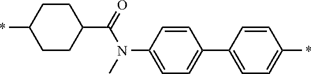 [SMILES: *c1ccc(-c2ccc(N(C)C(=O)C3CCC(*)CC3)cc2)cc1]

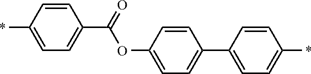 [SMILES: *c1ccc(C(=O)Oc2ccc(-c3ccc(*)cc3)cc2)cc1]

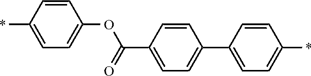 [SMILES: *c1ccc(OC(=O)c2ccc(-c3ccc(*)cc3)cc2)cc1]

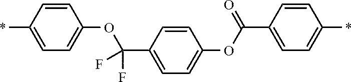 [SMILES: *c1ccc(OC(F)(F)c2ccc(OC(=O)c3ccc(*)cc3)cc2)cc1]

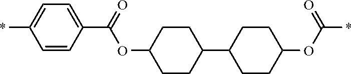 [SMILES: *C(=O)OC1CCC(C2CCC(OC(=O)c3ccc(*)cc3)CC2)CC1]

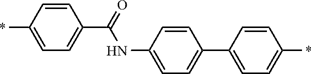 [SMILES: *c1ccc(C(=O)Nc2ccc(-c3ccc(*)cc3)cc2)cc1]

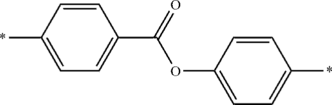 [SMILES: *c1ccc(OC(=O)c2ccc(*)cc2)cc1]

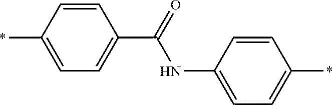 [SMILES: *c1ccc(NC(=O)c2ccc(*)cc2)cc1]

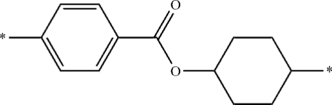 [SMILES: *c1ccc(C(=O)OC2CCC(*)CC2)cc1]

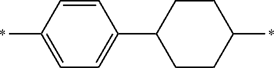 [SMILES: *c1ccc(C2CCC(*)CC2)cc1]

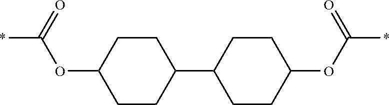 [SMILES: *C(=O)OC1CCC(C2CCC(OC(*)=O)CC2)CC1]

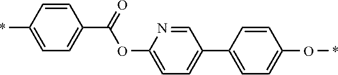 [SMILES: *Oc1ccc(-c2ccc(OC(=O)c3ccc(*)cc3)nc2)cc1]

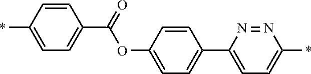 [SMILES: *c1ccc(C(=O)Oc2ccc(-c3ccc(*)nn3)cc2)cc1]

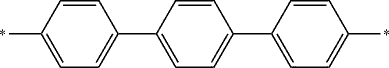 [SMILES: *c1ccc(-c2ccc(-c3ccc(*)cc3)cc2)cc1]

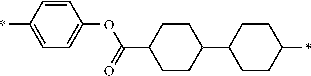 [SMILES: *c1ccc(OC(=O)C2CCC(C3CCC(*)CC3)CC2)cc1]

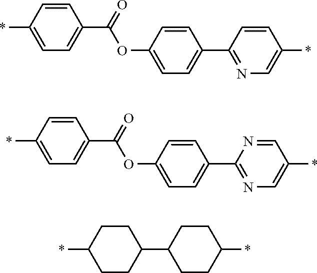 [SMILES: *c1ccc(C(=O)Oc2ccc(-c3ccc(*)cn3)cc2)cc1 ; *c1ccc(C(=O)Oc2ccc(-c3ncc(*)cn3)cc2)cc1 ; *C1CCC(C2CCC(*)CC2)CC1]

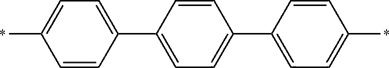 [SMILES: *c1ccc(-c2ccc(-c3ccc(*)cc3)cc2)cc1]

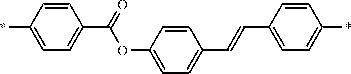 [SMILES: *c1ccc(/C=C/c2ccc(OC(=O)c3ccc(*)cc3)cc2)cc1]

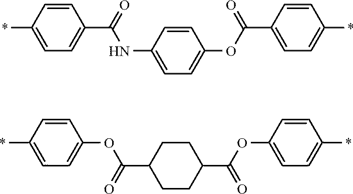 [SMILES: *c1ccc(C(=O)Nc2ccc(OC(=O)c3ccc(*)cc3)cc2)cc1 ; *c1ccc(OC(=O)C2CCC(C(=O)Oc3ccc(*)cc3)CC2)cc1]

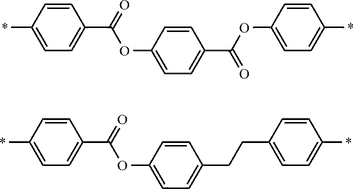 [SMILES: *c1ccc(OC(=O)c2ccc(OC(=O)c3ccc(*)cc3)cc2)cc1 ; *c1ccc(CCc2ccc(OC(=O)c3ccc(*)cc3)cc2)cc1]

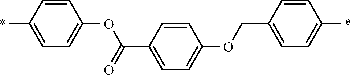 [SMILES: *c1ccc(COc2ccc(C(=O)Oc3ccc(*)cc3)cc2)cc1]

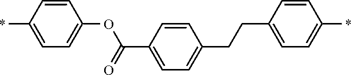 [SMILES: *c1ccc(CCc2ccc(C(=O)Oc3ccc(*)cc3)cc2)cc1]

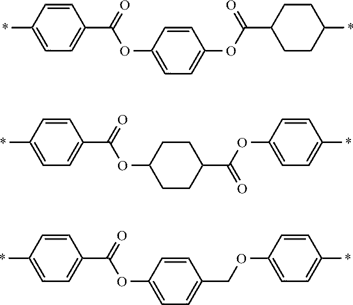 [SMILES: *c1ccc(C(=O)Oc2ccc(OC(=O)C3CCC(*)CC3)cc2)cc1 ; *c1ccc(OC(=O)C2CCC(OC(=O)c3ccc(*)cc3)CC2)cc1 ; *c1ccc(OCc2ccc(OC(=O)c3ccc(*)cc3)cc2)cc1]

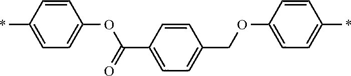 [SMILES: *c1ccc(OCc2ccc(C(=O)Oc3ccc(*)cc3)cc2)cc1]

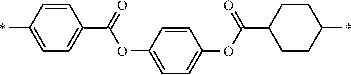 [SMILES: *c1ccc(C(=O)Oc2ccc(OC(=O)C3CCC(*)CC3)cc2)cc1]

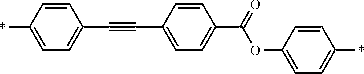 [SMILES: *c1ccc(C#Cc2ccc(C(=O)Oc3ccc(*)cc3)cc2)cc1]

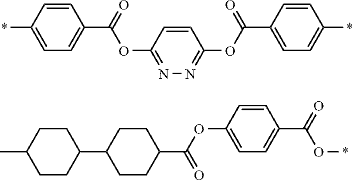 [SMILES: *c1ccc(C(=O)Oc2ccc(OC(=O)c3ccc(*)cc3)nn2)cc1 ; *OC(=O)c1ccc(OC(=O)C2CCC(C3CCC(C)CC3)CC2)cc1]

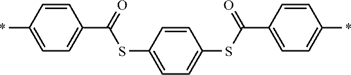 [SMILES: *c1ccc(C(=O)Sc2ccc(SC(=O)c3ccc(*)cc3)cc2)cc1]

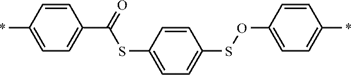 [SMILES: *c1ccc(OSc2ccc(SC(=O)c3ccc(*)cc3)cc2)cc1]

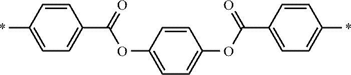 [SMILES: *c1ccc(C(=O)Oc2ccc(OC(=O)c3ccc(*)cc3)cc2)cc1]

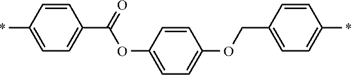 [SMILES: *c1ccc(COc2ccc(OC(=O)c3ccc(*)cc3)cc2)cc1]

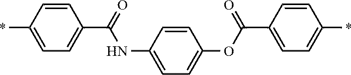 [SMILES: *c1ccc(C(=O)Nc2ccc(OC(=O)c3ccc(*)cc3)cc2)cc1]

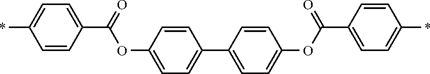 [SMILES: *c1ccc(C(=O)Oc2ccc(-c3ccc(OC(=O)c4ccc(*)cc4)cc3)cc2)cc1]

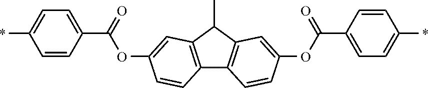 [SMILES: *c1ccc(C(=O)Oc2ccc3c(c2)C(C)c2cc(OC(=O)c4ccc(*)cc4)ccc2-3)cc1]

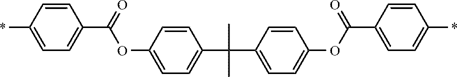 [SMILES: *c1ccc(C(=O)Oc2ccc(C(C)(C)c3ccc(OC(=O)c4ccc(*)cc4)cc3)cc2)cc1]

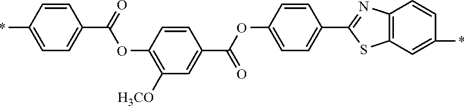 [SMILES: *c1ccc(C(=O)Oc2ccc(C(=O)Oc3ccc(-c4nc5ccc(*)cc5s4)cc3)cc2OC)cc1]

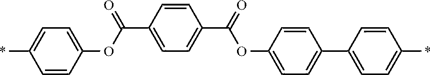 [SMILES: *c1ccc(OC(=O)c2ccc(C(=O)Oc3ccc(-c4ccc(*)cc4)cc3)cc2)cc1]

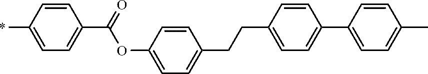 [SMILES: *c1ccc(C(=O)Oc2ccc(CCc3ccc(-c4ccc(C)cc4)cc3)cc2)cc1]

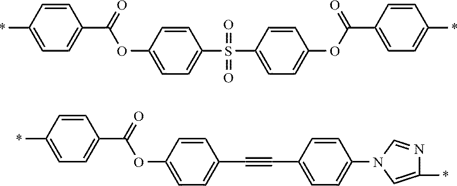 [SMILES: *c1ccc(C(=O)Oc2ccc(S(=O)(=O)c3ccc(OC(=O)c4ccc(*)cc4)cc3)cc2)cc1 ; *c1ccc(C(=O)Oc2ccc(C#Cc3ccc(-n4cnc(*)c4)cc3)cc2)cc1]

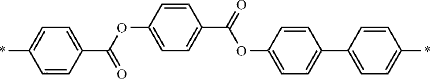 [SMILES: *c1ccc(C(=O)Oc2ccc(C(=O)Oc3ccc(-c4ccc(*)cc4)cc3)cc2)cc1]

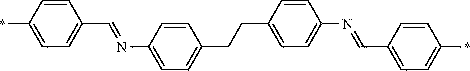 [SMILES: *c1ccc(/C=N/c2ccc(CCc3ccc(/N=C/c4ccc(*)cc4)cc3)cc2)cc1]

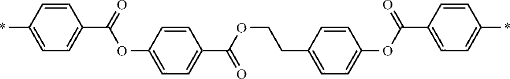 [SMILES: *c1ccc(C(=O)Oc2ccc(CCOC(=O)c3ccc(OC(=O)c4ccc(*)cc4)cc3)cc2)cc1]

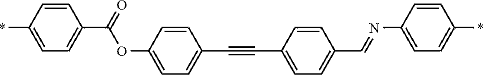 [SMILES: *c1ccc(/N=C/c2ccc(C#Cc3ccc(OC(=O)c4ccc(*)cc4)cc3)cc2)cc1]

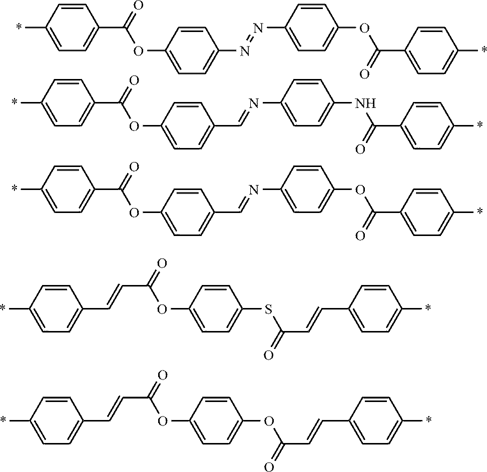

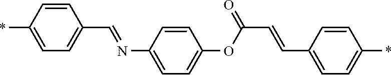 [SMILES: *c1ccc(/C=C/C(=O)Oc2ccc(/N=C/c3ccc(*)cc3)cc2)cc1]

### Low-Molecular-Weight Liquid Crystal Compound

In a case where the liquid crystal compound represented by Formula (LC) is a low-molecular-weight liquid crystal compound, examples of preferred aspects of the cyclic structure of the mesogen group MG include a cyclohexylene group, a cyclopentylene group, a phenylene group, a naphthylene group, a fluorene-diyl group, a pyridine-diyl group, a pyridazine-diyl group, a thiophene-diyl group, an oxazole-diyl group, a thiazole-diyl group, and a thienothiophene-diyl group, and the number of cyclic structures is preferably in a range of 2 to 10 and more preferably in a range of 3 to 7.

Examples of preferred aspects of the substituent W having a mesogen structure include a halogen atom, a halogenated alkyl group, a cyano group, a hydroxy group, a nitro group, a carboxy group, an alkoxy group having 1 to 10 carbon atoms, an alkylcarbonyl group having 1 to 10 carbon atoms, an alkyloxycarbonyl group having 1 to 10 carbon atoms, an alkylcarbonyloxy group having 1 to 10 carbon atoms, an amino group, an alkylamino group having 1 to 10 carbon atoms, an alkylaminocarbonyl group, and a group in which LW in Formula (W1) represents a single bond, SPW represents a divalent spacer group, and Q represents a crosslinkable group represented by any of Formulae (P-1) to (P-30), and preferred examples of the crosslinkable group include a vinyl group, a butadiene group, a (meth)acryl group, a (meth)acrylamide group, a vinyl acetate group, a fumaric acid ester group, a styryl group, a vinylpyrrolidone group, a maleic acid anhydride, a maleimide group, a vinyl ether group, an epoxy group, and an oxetanyl group.

Since the preferred aspects of the divalent spacer groups S1 and S2 are the same as those of the SPW, the description thereof will not be repeated.

In a case where a low-molecular-weight liquid crystal compound exhibiting smectic properties is used, the number of carbon atoms of the spacer group (the number of atoms in a case where the carbon atoms are substituted “SP-C”) is preferably 6 or more and more preferably 8 or more.

In a case where the liquid crystal compound represented by Formula (LC) is a low-molecular-weight liquid crystal compound, a plurality of low-molecular-weight liquid crystal compounds may be used in a combination, preferably a combination of 2 to 6 kinds of low-molecular-weight liquid crystal compounds, and more preferably a combination of 2 to 4 kinds of low-molecular-weight liquid crystal compounds. By using low-molecular-weight liquid crystal compounds in combination, the solubility can be improved and the phase transition temperature of the liquid crystal composition can be adjusted.

Specific examples of the low-molecular-weight liquid crystal compound include compounds represented by Formulae (LC-1) to (LC-77), but the low-molecular-weight liquid crystal compound is not limited thereto.

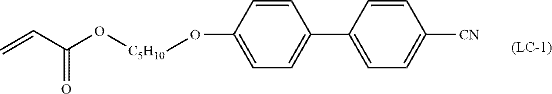

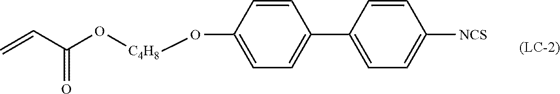

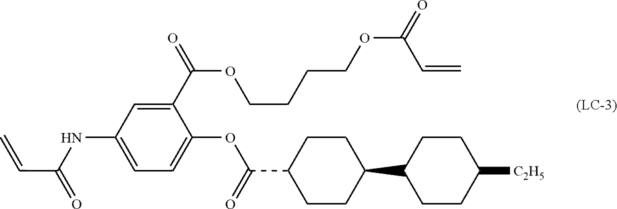

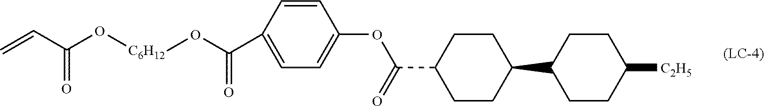

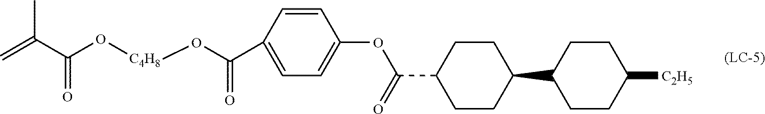

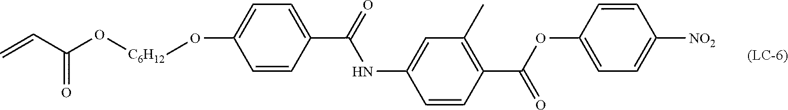

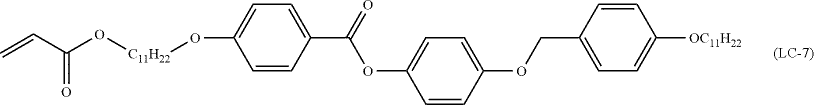

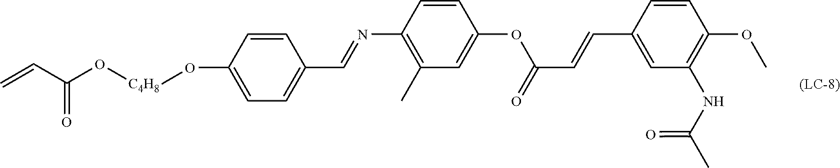

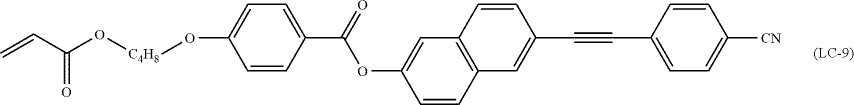

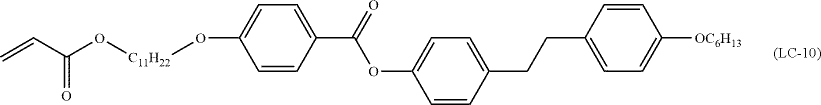

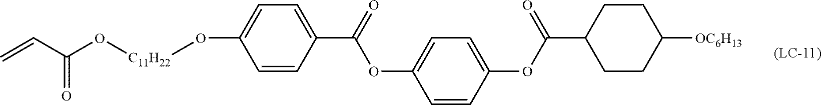

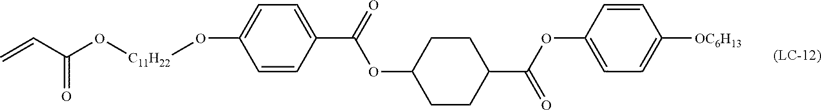

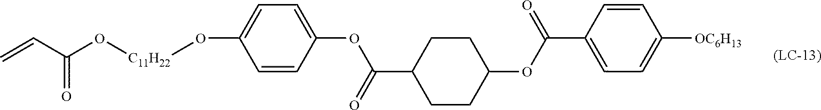

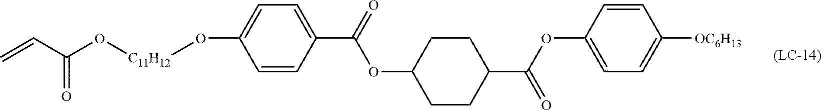

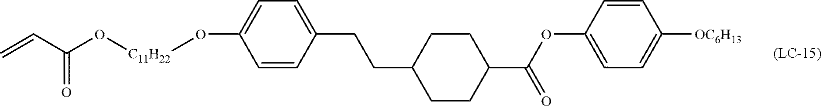

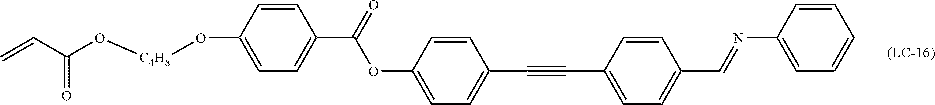

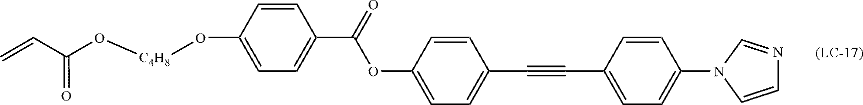

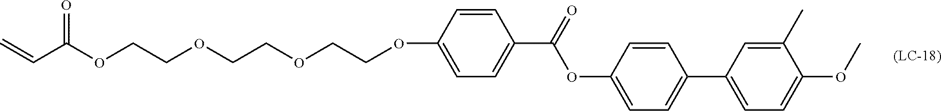 [SMILES: C=CC(=O)OCCOCCOCCOc1ccc(C(=O)Oc2ccc(-c3ccc(OC)c(C)c3)cc2)cc1]

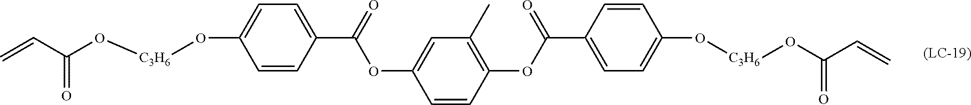

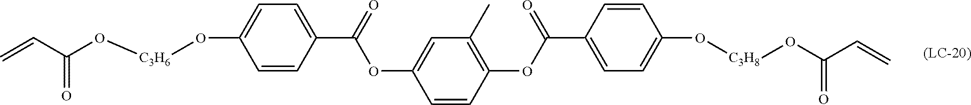

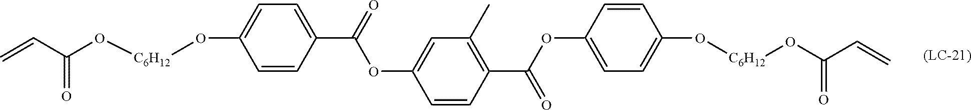

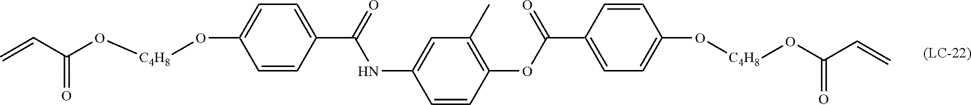

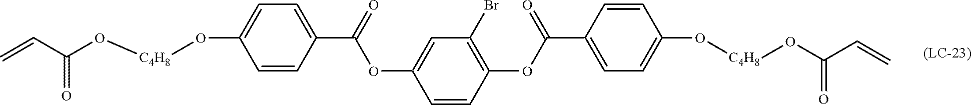

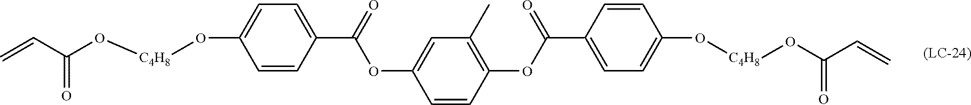

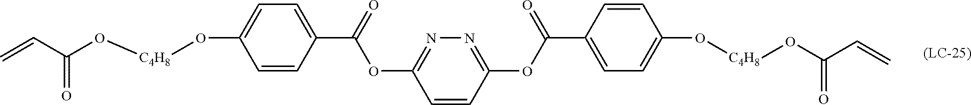

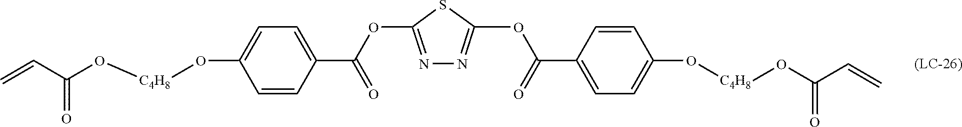

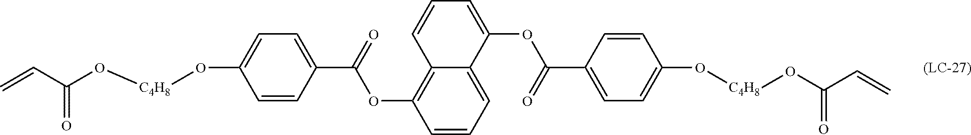

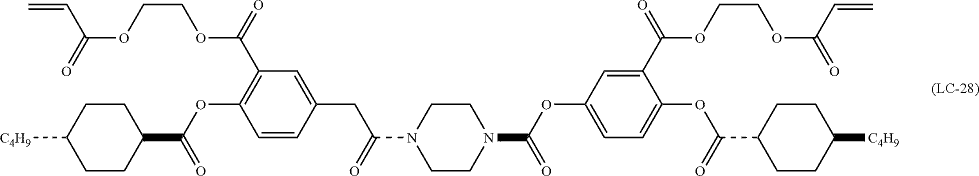

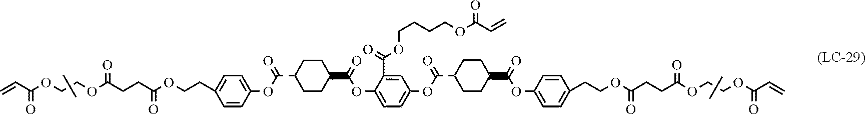

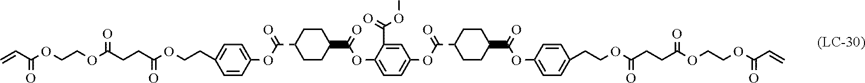 [SMILES: C=CC(=O)OCCOC(=O)CCC(=O)OCCc1ccc(OC(=O)[C@H]2CC[C@H](C(=O)Oc3ccc(OC(=O)[C@H]4CC[C@H](C(=O)Oc5ccc(CCOC(=O)CCC(=O)OCCOC(=O)C=C)cc5)CC4)c(C(=O)OC)c3)CC2)cc1]

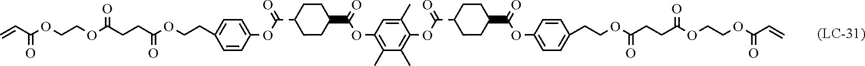 [SMILES: C=CC(=O)OCCOC(=O)CCC(=O)OCCc1ccc(OC(=O)[C@H]2CC[C@H](C(=O)Oc3cc(C)c(OC(=O)[C@H]4CC[C@H](C(=O)Oc5ccc(CCOC(=O)CCC(=O)OCCOC(=O)C=C)cc5)CC4)c(C)c3C)CC2)cc1]

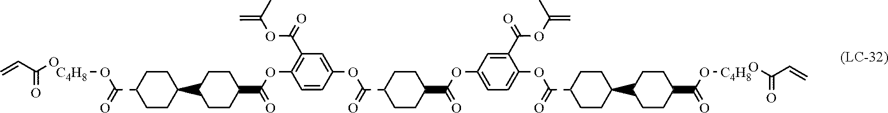

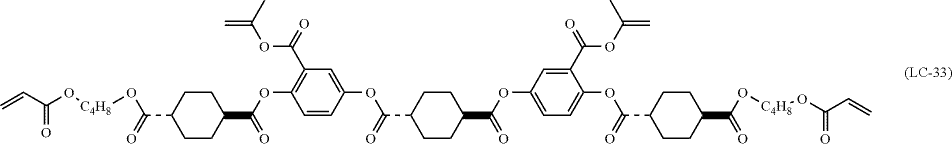

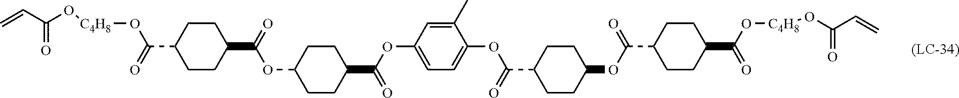

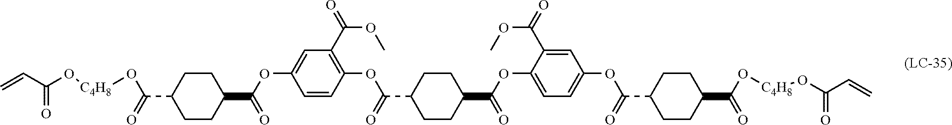

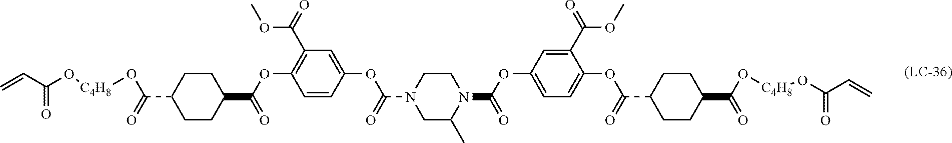

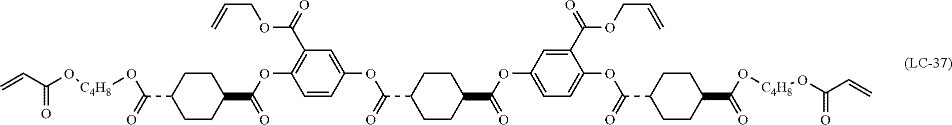

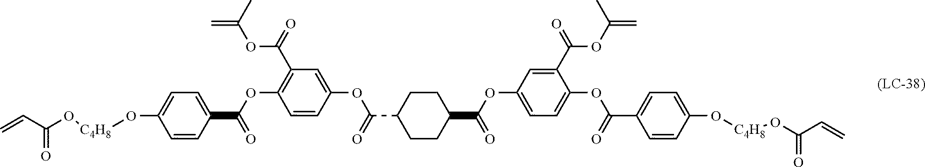

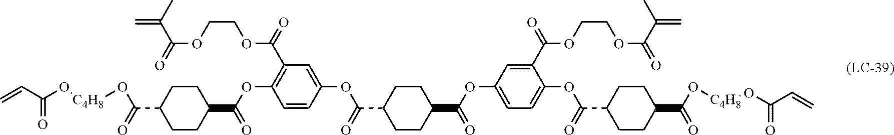

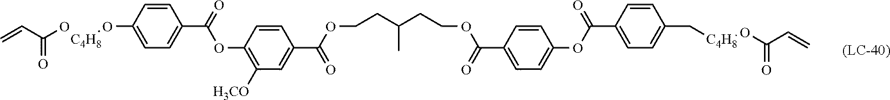

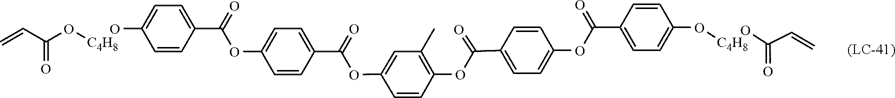

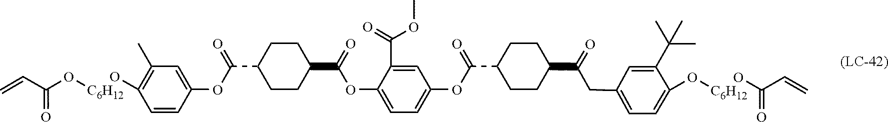

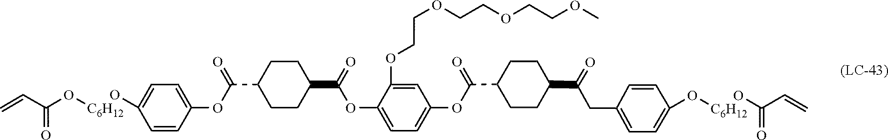

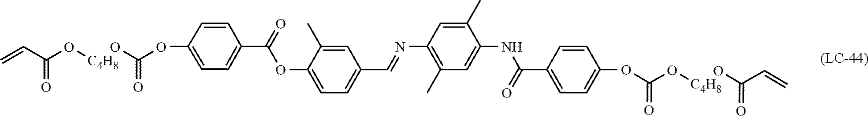

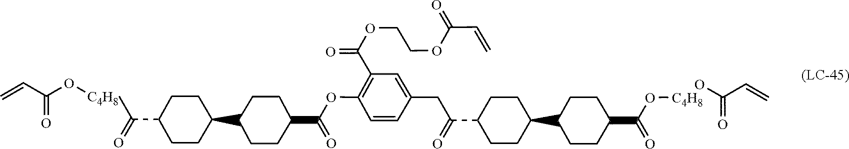

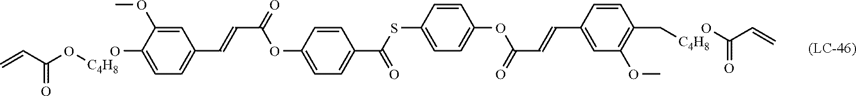

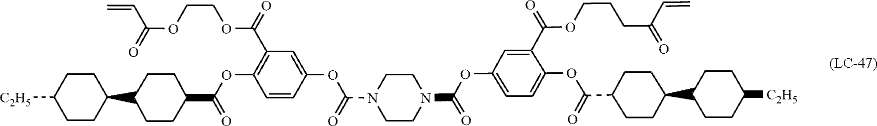

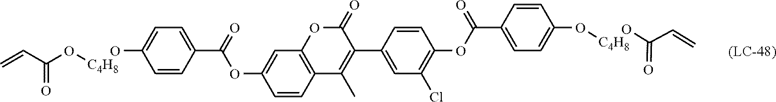

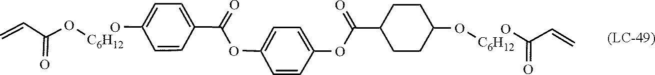

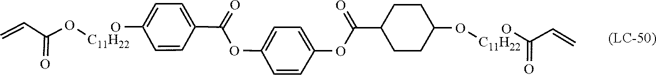

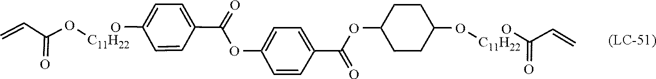

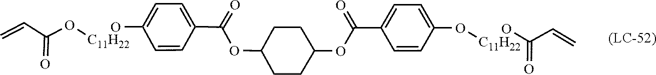

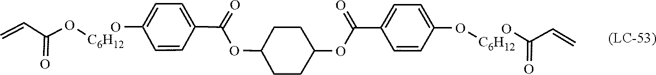

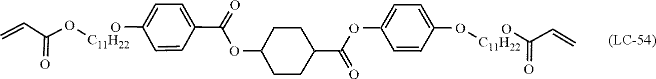

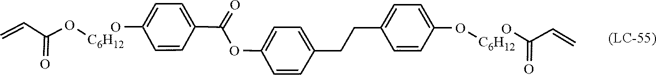

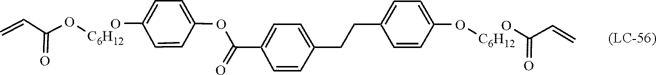

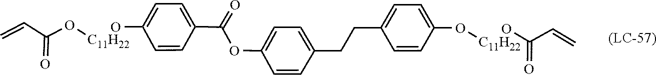

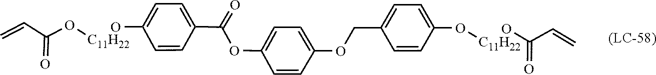

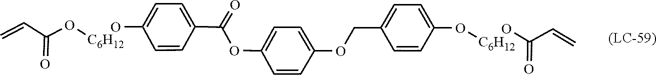

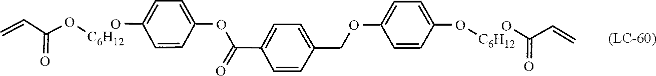

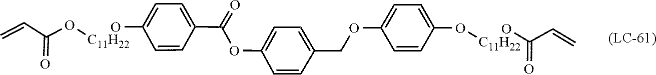

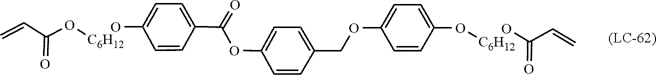

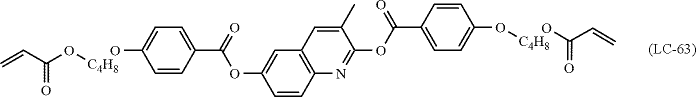

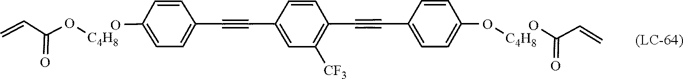

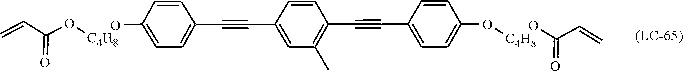

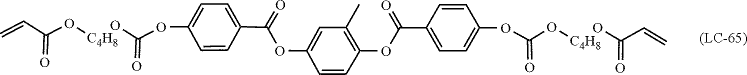

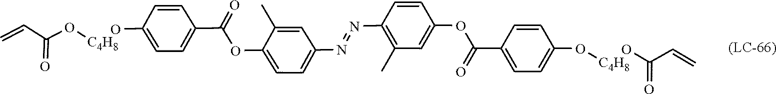

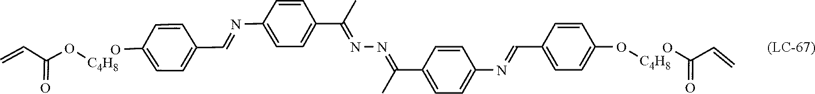

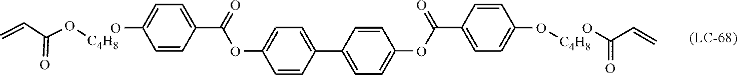

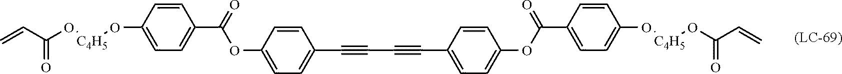

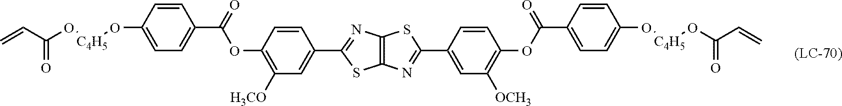

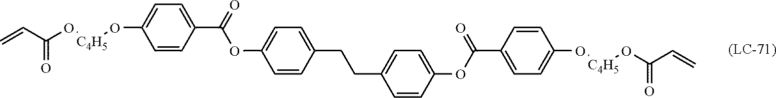

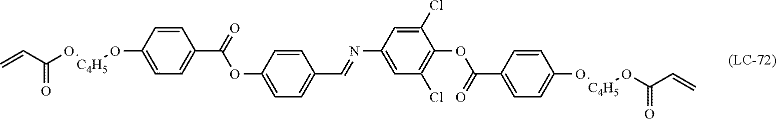

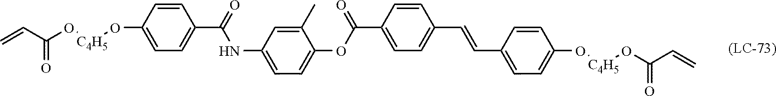

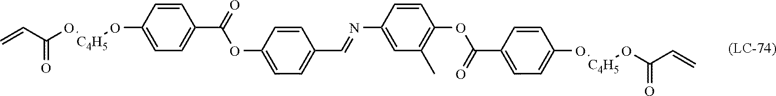

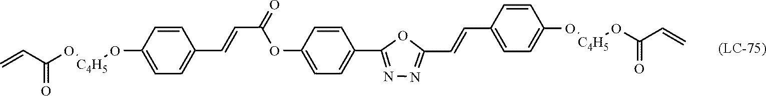

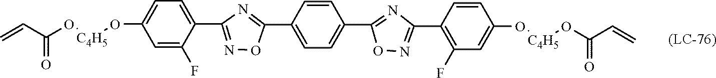

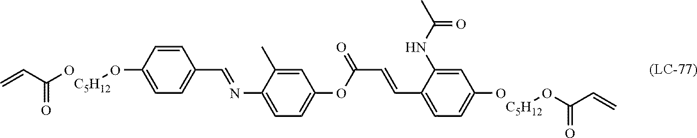

### Polymer Liquid Crystal Compound

The polymer liquid crystal compound is preferably a homopolymer or a copolymer having a repeating unit described below, and may be any of a random polymer, a block polymer, a graft polymer, or a star polymer.

### Repeating Unit (1)

It is preferable that the polymer liquid crystal compound has a repeating unit represented by Formula (1) (hereinafter, also referred to as “repeating unit (1)”).

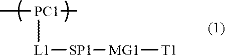

In Formula (1), PC1 represents a main chain of the repeating unit, L1 represents a single bond or a divalent linking group, SP1 represents a spacer group, MG1 represents a mesogen group MG in Formula (LC), and T1 represents a terminal group.

Examples of the main chain of the repeating unit represented by PC1 include groups represented by Formulae (P1-A) to (P1-D). Among these, from the viewpoints of diversity and handleability of a monomer serving as a raw material, a group represented by Formula (P1-A) is preferable.

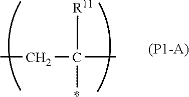

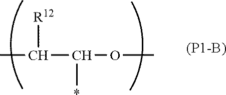

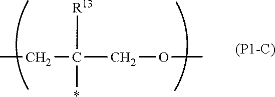

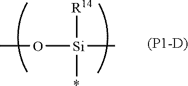

In Formulae (P1-A) to (P1-D), “*” represents a bonding position with respect to L1 in Formula (1). In Formulae (P1-A) to (P1-D), R¹¹, R¹², R¹³, and R¹⁴ each independently represent a hydrogen atom, a halogen atom, a cyano group, an alkyl group having 1 to 10 carbon atoms, or an alkoxy group having 1 to 10 carbon atoms. The alkyl group may be a linear or branched alkyl group or an alkyl group having a cyclic structure (cycloalkyl group). Further, the number of carbon atoms of the alkyl group is preferably in a range of 1 to 5.

It is preferable that the group represented by Formula (P1-A) is a unit of a partial structure of poly(meth)acrylic acid ester obtained by polymerization of (meth)acrylic acid ester.

It is preferable that the group represented by Formula (P1-B) is an ethylene glycol unit formed by ring-opening polymerization of an epoxy group of a compound containing the epoxy group.

It is preferable that the group represented by Formula (P1-C) is a propylene glycol unit formed by ring-opening polymerization of an oxetane group of a compound containing the oxetane group.

It is preferable that the group represented by Formula (P1-D) is a siloxane unit of a polysiloxane obtained by polycondensation of a compound containing at least one of an alkoxysilyl group or a silanol group. Here, examples of the compound containing at least one of an alkoxysilyl group or a silanol group include a compound containing a group represented by Formula SiR¹⁴(OR¹⁵)₂—. In the formula, R¹⁴ has the same definition as that for R¹⁴ in Formula (P1-D), and a plurality of R¹⁵′s each independently represent a hydrogen atom or an alkyl group having 1 to 10 carbon atoms.

The divalent linking group represented by L1 is the same divalent linking group represented by LW in Formula (W1), and preferred aspects thereof include —C(O)O—, —OC(O)—, —O—, —S—, —C(O)NR¹⁶—, —NR¹⁶C(O)—, —S(O)₂—, and —NR¹⁶R¹⁷—. In the formulae, R¹⁶ and R¹⁷ each independently represent a hydrogen atom or an alkyl group having 1 to 6 carbon atoms which may have a substituent (for example, the substituent W described above). In the specific examples of the divalent linking group described above, the bonding site on the left side is bonded to PC1 and the bonding site on the right side is bonded to SP1.

In a case where PC1 represents a group represented by Formula (P1-A), it is preferable that L1 represents a group represented by —C(O)O— or —C(O)NR¹⁶—.

In a case where PC1 represents a group represented by any of Formulae (P1—B) to (P1-D), it is preferable that L1 represents a single bond.

Examples of the spacer group represented by SP1 are the same groups represented by S1 and S2 in Formula (LC), and from the viewpoint of the alignment degree, a group having at least one structure selected from the group consisting of an oxyethylene structure, an oxypropylene structure, a polysiloxane structure, and an alkylene fluoride structure or a linear or branched alkylene group having 2 to 20 carbon atoms is preferable. However, the alkylene group may contain —O—, —S—, —O—CO—, —CO—O—, —O—CO—O—, —O—CNR— (R represents an alkyl group having 1 to 10 carbon atoms), or —S(O)₂—.

From the viewpoints of easily exhibiting liquid crystallinity and the availability of raw materials, it is preferable that the spacer group represented by SP1 is a group having at least one structure selected from the group consisting of an oxyethylene structure, an oxypropylene structure, a polysiloxane structure, and an alkylene fluoride structure.

Here, as the oxyethylene structure represented by SP1, a group represented by *-(CH₂-CH₂O)ₙ₁-* is preferable. In the formula, n1 represents an integer of 1 to 20, and * represents a bonding position with respect to L1 or MG1. From the viewpoint that the effects of the present invention are more excellent, n1 represents preferably an integer of 2 to 10, more preferably an integer of 2 to 6, and most preferably an integer of 2 to 4.

Here, a group represented by *—(CH(CH₃)—CH₂O)ₙ₂—* is preferable as the oxypropylene structure represented by SP1. In the formula, n2 represents an integer of 1 to 3, and * represents a bonding position with respect to L1 or MG1.

Further, a group represented by *—(Si(CH₃)₂—O)ₙ₃—* is preferable as the polysiloxane structure represented by SP1. In the formula, n3 represents an integer of 6 to 10, and * represents a bonding position with respect to L1 or MG1.

Further, a group represented by *—(CF₂—CF₂)ₙ₄—* is preferable as the alkylene fluoride structure represented by SP1. In the formula, n4 represents an integer of 6 to 10, and * represents a bonding position with respect to L1 or MG1.

Examples of the terminal group represented by T1 include a hydrogen atom, a halogen atom, a cyano group, a nitro group, a hydroxy group, —SH, a carboxyl group, a boronic acid group, —SO₃H—, —PO₃H₂—, —NR¹¹R¹² (here, R¹¹ and R¹² each independently represent a hydrogen atom, a substituted or unsubstituted alkyl group having 1 to 10 carbon atoms, a cycloalkyl group, or an aryl group), an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an acyloxy group having 1 to 10 carbon atoms, an acylamino group having 1 to 10 carbon atoms, an alkoxycarbonyl group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a crosslinkable group-containing group.

Examples of the crosslinkable group-containing group include -L-CL described above. L represents a single bond or a linking group. Specific examples of the linking group are the same groups represented by LW and SPW described above. CL represents a crosslinkable group, and examples thereof include a group represented by Q1 or Q2 described above, and a group represented by Formulae (P-1) to (P-30) is preferable. Further, T1 may represent a group obtained by combining two or more of these groups.

From the viewpoint that the effects of the present invention are more excellent, T1 represents preferably an alkoxy group having 1 to 10 carbon atoms, more preferably an alkoxy group having 1 to 5 carbon atoms, and still more preferably a methoxy group. These terminal groups may be further substituted with these groups or the polymerizable groups described in JP2010-244038A.

From the viewpoint that the effects of the present invention are more excellent, the number of atoms in the main chain of T1 is preferably in a range of 1 to 20, more preferably in a range of 1 to 15, still more preferably in a range of 1 to 10, and particularly preferably in a range of 1 to 7. In a case where the number of atoms in the main chain of T1 is 20 or less, the alignment degree of the optically anisotropic layer is further improved. Here, the “main chain” in T1 indicates the longest molecular chain bonded to M1, and the number of hydrogen atoms is not included in the number of atoms in the main chain of T1. For example, the number of atoms in the main chain is 4 in a case where T1 represents an n-butyl group, the number of atoms in the main chain is 3 in a case where T1 represents a sec-butyl group.

The content of the repeating unit (1) is preferably in a range of 40% to 100% by mass and more preferably in a range of 50% to 95% by mass with respect to all the repeating units (100% by mass) of the polymer liquid crystal compound. In a case where the content of the repeating unit (1) is 40% by mass or greater, an excellent optically anisotropic layer can be obtained due to satisfactory aligning properties. Further, in a case where the content of the repeating unit (1) is 100% by mass or less, an excellent optically anisotropic layer can be obtained due to satisfactory aligning properties.

The polymer liquid crystal compound may have only one or two or more kinds of repeating units (1). In a case where the polymer liquid crystal compound has two or more kinds of repeating units (1), the content of the repeating unit (1) denotes the total content of the repeating units (1).

### Log P Value

In Formula (1), a difference (|log P₁- log P₂|) between the log P value of PC1, L1, and SP1 (hereinafter, also referred to as “log P₁”) and the log P value of MG1 (hereinafter, also referred to as “log P₂”) is 4 or greater. Further, from the viewpoint of further improving the alignment degree of the optically anisotropic layer, the difference thereof is preferably 4.25 or greater and more preferably 4.5 or greater.

Further, from the viewpoints of adjusting the liquid crystal phase transition temperature and the synthetic suitability, the upper limit of the difference is preferably 15 or less, more preferably 12 or less, and still more preferably 10 or less.

Here, the log P value is an index for expressing the properties of the hydrophilicity and hydrophobicity of a chemical structure and is also referred to as a hydrophilic-hydrophobic parameter. The log P value can be calculated using software such as ChemBioDraw Ultra or HSPiP (Ver. 4.1.07). Further, the log P value can be acquired experimentally by the method of the OECD Guidelines for the Testing of Chemicals, Sections 1, Test No. 117 or the like. In the present invention, a value calculated by inputting the structural formula of a compound to HSPiP (Ver. 4.1.07) is employed as the log P value unless otherwise specified.

The log P₁ indicates the log P value of PC1, L1, and SP1 as described above. The “log P value of PC1, L1, and SP1” indicates the log P value of a structure in which PC1, L1, and SP1 are integrated and is not the sum of the log P values of PC1, L1, and SP1. Specifically, the log P₁ is calculated by inputting a series of structural formulae of PC1 to SP1 in Formula (1) into the above-described software.

Here, in the calculation of the log P₁, in regard to the part of the group represented by PC1 in the series of structural formulae of PC1 to SP1, the structure of the group itself represented by PC1 (for example, Formulae (P1-A) to (P1-D) described above) may be used or a structure of a group that can be PC1 after polymerization of a monomer used to obtain the repeating unit represented by Formula (1) may be used.

Here, specific examples of the latter (the group that can be PC1) are as follows. In a case where PC1 is obtained by polymerization of (meth)acrylic acid ester, PC1 represents a group represented by CH₂═C(R¹)— (R¹ represents a hydrogen atom or a methyl group). Further, PC1 represents ethylene glycol in a case where PC1 is obtained by polymerization of ethylene glycol, and PC1 represents propylene glycol in a case where PC1 is obtained by polymerization of propylene glycol. Further, in a case where PC1 is obtained by polycondensation of silanol, PC 1 represents silanol (a compound represented by Formula Si(R²)₃(OH), and a plurality of R²′ s each independently represent a hydrogen atom or an alkyl group, where at least one of the plurality of R²′s represents an alkyl group).

The log P₁ may be smaller than the log P₂ or greater than the log P₂ in a case where the difference between log P₁ and log P₂ described above is 4 or greater.

Here, the log P value of a general mesogen group (the log P₂ described above) tends to be in a range of 4 to 6. In a case where the log P₁ is smaller than the log P₂, the value of log P₁ is preferably 1 or less and more preferably 0 or less. Further, in a case where the log P₁ is greater than the log P₂, the value of log P₁ is preferably 8 or greater and more preferably 9 or greater.

In a case where PC1 in Formula (1) is obtained by polymerization of (meth)acrylic acid ester and the log P₁ is smaller than the log P₂, the log P value of SP1 in Formula (1) is preferably 0.7 or less and more preferably 0.5 or less. Further, in a case where PC1 in Formula (1) is obtained by polymerization of (meth)acrylic acid ester and the log P₁ is greater than the log P₂, the log P value of SP1 in Formula (1) is preferably 3.7 or greater and more preferably 4.2 or greater.

Further, examples of the structure having a log P value of 1 or less include an oxyethylene structure and an oxypropylene structure. Examples of the structure having a log P value of 6 or greater include a polysiloxane structure and an alkylene fluoride structure.

### Repeating Units (21) and (22)

From the viewpoint of improving the alignment degree, it is preferable that the polymer liquid crystal compound has a repeating unit having an electron-donating property and/or an electron-withdrawing property at the terminal. More specifically, it is more preferable that the polymer liquid crystal compound has a repeating unit (21) containing a mesogen group and an electron-withdrawing group present at the terminal of the mesogen group and having a σp value of greater than 0 and a repeating unit (22) containing a mesogen group and a group present at the terminal of the mesogen group and having a σp value of 0 or less. As described above, in a case where the polymer liquid crystal compound has the repeating unit (21) and the repeating unit (22), the alignment degree of the optically anisotropic layer to be formed of the polymer liquid crystal compound is further improved as compared with a case where the polymer liquid crystal compound has only one of the repeating unit (21) or the repeating unit (22). The details of the reason for this are not clear, but it is assumed as follows.

That is, it is assumed that since the opposite dipole moments generated in the repeating unit (21) and the repeating unit (22) interact between molecules, the interaction between the mesogen groups in the minor axis direction is strengthened, and the orientation in which the liquid crystals are aligned is more uniform, and as a result, the degree of order of the liquid crystals is considered to be high. In this manner, it is assumed that the aligning properties of the dichroic substance are enhanced, and thus the alignment degree of the optically anisotropic layer to be formed increases.

Further, the repeating units (21) and (22) may be the repeating units represented by Formula (1).

The repeating unit (21) contains a mesogen group and an electron-withdrawing group present at the terminal of the mesogen group and having a σp value of greater than 0.

The electron-withdrawing group is a group that is positioned at the terminal of the mesogen group and has a σp value of greater than 0. Examples of the electron-withdrawing group (a group having a σp value of greater than 0) include a group represented by EWG in Formula (LCP-21) described below, and specific examples thereof are also the same as those described below.

The σp value of the electron-withdrawing group described above is greater than 0. From the viewpoint of further increasing the alignment degree of the optically anisotropic layer, the σp value is preferably 0.3 or greater and more preferably 0.4 or greater. From the viewpoint that the uniformity of alignment is excellent, the upper limit of the σp value of the electron-withdrawing group is preferably 1.2 or less and more preferably 1.0 or less.

The σp value is a Hammett’s substituent constant σp value (also simply referred to as “σp value”) and is a parameter showing the intensity of the electron-donating property and the electron-withdrawing property of a substituent, which numerically expresses the effect of the substituent on the acid dissociation equilibrium constant of substituted benzoic acid. The Hammett’s substituent constant σp value in the present specification indicates the substituent constant σ in a case where the substituent is positioned at the para position of benzoic acid.

As the Hammett’s substituent constant σp value of each group in the present specification, the values described in the document “Hansch et al., Chemical Reviews, 1991, Vol, 91, No. 2, pp. 165 to 195″ are employed. Further, the Hammett’s substituent constant σp values can be calculated for groups whose Hammett’s substituent constant σp values are not described in the document described above using software “ACD/ChemSketch (ACD/Labs 8.00 Release Product Version: 8.08)” based on a difference between the pKa of benzoic acid and the pKa of a benzoic acid derivative having a substituent at the para position.

The repeating unit (21) is not particularly limited as long as the repeating unit (21) contains, at a side chain thereof, a mesogen group and an electron-withdrawing group present at the terminal of the mesogen group and having a σp value of greater than 0, and from the viewpoint of further increasing the alignment degree of the optically anisotropic layer, it is preferable that the repeating unit (21) is a repeating unit represented by Formula (LCP-21).

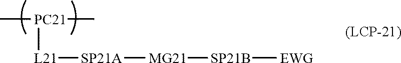

In Formula (LCP-21), PC21 represents the main chain of the repeating unit and more specifically the same structure as that for PC1 in Formula (1), L21 represents a single bond or a divalent linking group and more specifically the same structure as that for L1 in Formula (1), SP21A and SP21B each independently represent a single bond or a spacer group and more specifically the same structure as that for SP1 in Formula (1), MG21 represents a mesogen structure and more specifically a mesogen group MG in Formula (LC), and EWG represents an electron-withdrawing group having a σp value of greater than 0.

Examples of the spacer group represented by SP21A and SP21B are those represented by Formulae S1 and S2, and a group having at least one structure selected from the group consisting of an oxyethylene structure, an oxypropylene structure, a polysiloxane structure, and an alkylene fluoride structure or a linear or branched alkylene group having 2 to 20 carbon atoms is preferable. Here, the alkylene group may contain —O—, —O—CO—, —CO—O—, or —O—CO—O—.

From the viewpoints of easily exhibiting liquid crystallinity and the availability of raw materials, it is preferable that the spacer group represented by SP1 has at least one structure selected from the group consisting of an oxyethylene structure, an oxypropylene structure, a polysiloxane structure, and an alkylene fluoride structure.

It is preferable that SP21B represents a single bond or a linear or branched alkylene group having 2 to 20 carbon atoms. Here, the alkylene group may contain —O—, —O—CO—, —CO—O—, or —O—CO—O—.

Among these, from the viewpoint of further increasing the alignment degree of the optically anisotropic layer, a single bond is preferable as the spacer group represented by SP21B. In other words, it is preferable that the repeating unit 21 has a structure in which EWG that represents an electron-withdrawing group in Formula (LCP-21) is directly linked to MG21 that represents a mesogen group in Formula (LCP-21). In this manner, it is assumed that in a case where the electron-withdrawing group is directly linked to the mesogen group, the intermolecular interaction due to an appropriate dipole moment works more effectively in the polymer liquid crystal compound, and the orientation in which the liquid crystals are aligned is more uniform, and as a result, the degree of order of the liquid crystals and the alignment degree are considered to be high.

EWG represents an electron-withdrawing group having a σp value of greater than 0. Examples of the electron-withdrawing group having a σp value of greater than 0 include an ester group (specifically, a group represented by *—C(O)O—R^{E}), a (meth)acryloyl group, a (meth)acryloyloxy group, a carboxy group, a cyano group, a nitro group, a sulfo group, —S(O)(O)—OR^{E}, —S(O)(O)—R^{E}, —O—S(O)(O)—R^{E}, an acyl group (specifically, a group represented by *—C(O)R^{E}), an acyloxy group (specifically, a group represented by *—OC(O)R^{E}), an isocyanate group (—N═C(O)), *—C(O)N(R^{F})₂, a halogen atom, and an alkyl group substituted with any of these groups (preferably having 1 to 20 carbon atoms). In each of the above-described groups, * represents a bonding position with respect to SP21B. R^{E} represents an alkyl group having 1 to 20 carbon atoms (preferably 1 to 4 carbon atoms and more preferably 1 or 2 carbon atoms). R^{F}’s each independently represent a hydrogen atom or an alkyl group having 1 to 20 carbon atoms (preferably 1 to 4 carbon atoms and more preferably 1 or 2 carbon atoms).

Among the above-described groups, from the viewpoint of further exhibiting the effects of the present invention, it is preferable that EWG represents a group represented by *—C(O)OR^{E}, a (meth)acryloyloxy group, a cyano group, or a nitro group.

From the viewpoint that the polymer liquid crystal compound and the dichroic substance can be uniformly aligned while a high alignment degree of the optically anisotropic layer is maintained, the content of the repeating unit (21) is preferably 60% by mass or less, more preferably 50% by mass or less, and particularly preferably 45% by mass or less with respect to all the repeating units (100% by mass) of the polymer liquid crystal compound.

From the viewpoint of further exhibiting the effects of the present invention, the lower limit of the content of the repeating unit (21) is preferably 1% by mass or greater and more preferably 3% by mass or greater with respect to all the repeating units (100% by mass) of the polymer liquid crystal compound.

In the present invention, the content of each repeating unit contained in the polymer liquid crystal compound is calculated based on the charged amount (mass) of each monomer used for obtaining each repeating unit.

The polymer liquid crystal compound may have only one or two or more kinds of repeating units (21). In a case where the polymer liquid crystal compound has two or more kinds of repeating units (21), there is an advantage in that the solubility of the polymer liquid crystal compound in a solvent is improved and the liquid crystal phase transition temperature is easily adjusted. In a case where the polymer liquid crystal compound has two or more kinds of repeating units (21), it is preferable that the total amount thereof is in the above-described ranges.

In the case where the polymer liquid crystal compound has two or more kinds of repeating units (21), a repeating unit (21) that does not contain a crosslinkable group in EWG and a repeating unit (21) that contains a polymerizable group in EWG may be used in combination. In this manner, the curing properties of the optically anisotropic layer are further improved. Further, preferred examples of the crosslinkable group include a vinyl group, a butadiene group, a (meth)acryl group, a (meth)acrylamide group, a vinyl acetate group, a fumaric acid ester group, a styryl group, a vinylpyrrolidone group, a maleic acid anhydride, a maleimide group, a vinyl ether group, an epoxy group, and an oxetanyl group.

In this case, from the viewpoint of the balance between the curing properties and the alignment degree of the optically anisotropic layer, the content of the repeating unit (21) containing a polymerizable group in EWG is preferably in a range of 1% to 30% by mass with respect to all the repeating units (100% by mass) of the polymer liquid crystal compound.

Hereinafter, examples of the repeating unit (21) will be described, but the repeating unit (21) is not limited to the following repeating units.

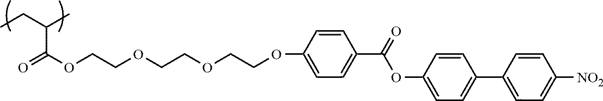

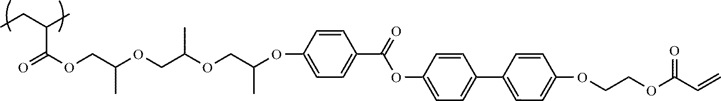

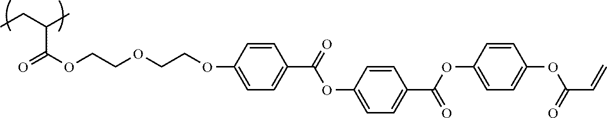

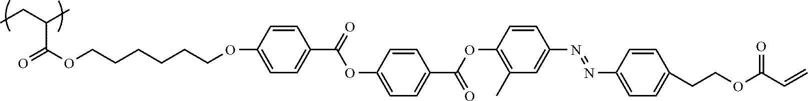

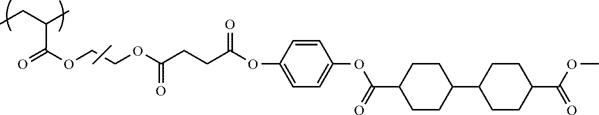

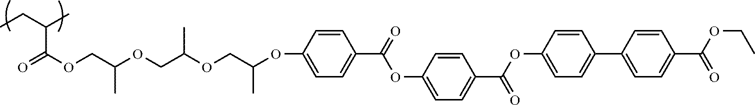

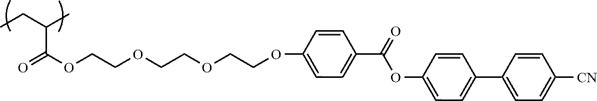

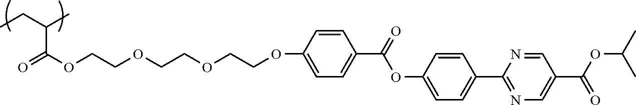

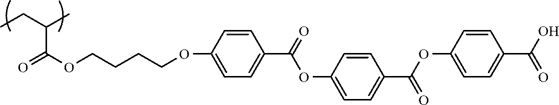

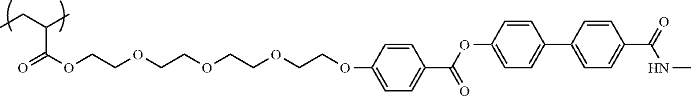

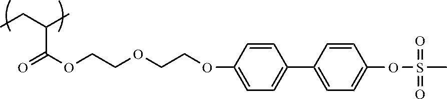

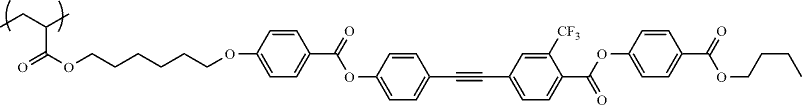

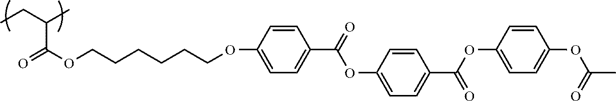

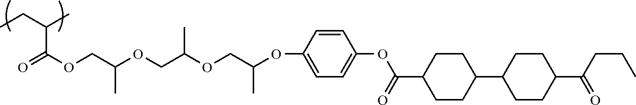

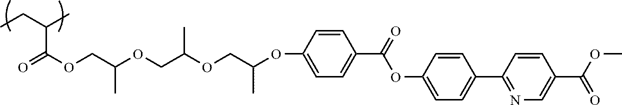

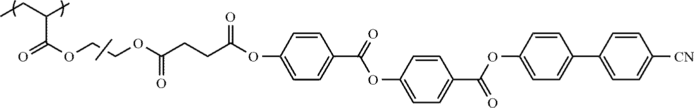

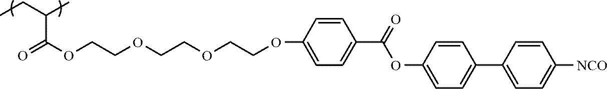

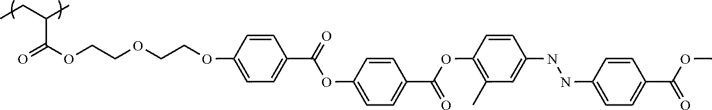

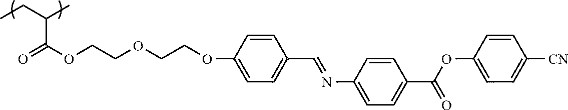

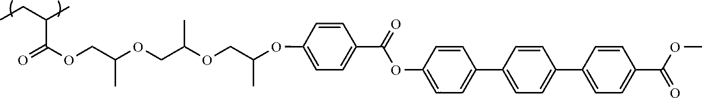

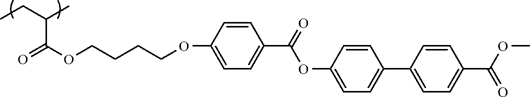

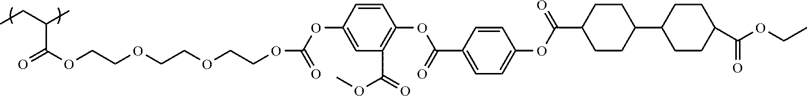

As a result of intensive examination on the composition (content ratio) and the electron-donating property and the electron-withdrawing property of the terminal groups of the repeating unit (21) and the repeating unit (22), the present inventors found that the alignment degree of the optically anisotropic layer is further increased by decreasing the content ratio of the repeating unit (21) in a case where the electron-withdrawing property of the electron-withdrawing group of the repeating unit (21) is high (that is, in a case where the σp value is large), and the alignment degree of the optically anisotropic layer is further increased by increasing the content ratio of the repeating unit (21) in a case where the electron-withdrawing property of the electron-withdrawing group of the repeating unit (21) is low (that is, in a case where the σp value is close to 0).

The details of the reason for this are not clear, but it is assumed as follows. That is, it is assumed that since the intermolecular interaction due to an appropriate dipole moment works in the polymer liquid crystal compound, the orientation in which the liquid crystals are aligned is more uniform, and as a result, the degree of order of the liquid crystals and the alignment degree of the optically anisotropic layer are considered to be high.

Specifically, the product of the σp value of the electron-withdrawing group (EWG in Formula (LCP-21)) in the repeating unit (21) and the content ratio (on a mass basis) of the repeating unit (21) in the polymer liquid crystal compound is preferably in a range of 0.020 to 0.150, more preferably in a range of 0.050 to 0.130, and particularly preferably in a range of 0.055 to 0.125. In a case where the product is in the above-described ranges, the alignment degree of the optically anisotropic layer is further increased.

The repeating unit (22) contains a mesogen group and a group present at the terminal of the mesogen group and having a σp value of 0 or less. In a case where the polymer liquid crystal compound has the repeating unit (22), the polymer liquid crystal compound and the dichroic substance can be uniformly aligned.

The mesogen group is a group showing the main skeleton of a liquid crystal molecule that contributes to liquid crystal formation, and the details thereof are as described in the section of MG in Formula (LCP-22) described below, and specific examples thereof are also the same as described below.

The above-described group is positioned at the terminal of the mesogen group and has a σp value of 0 or less. Examples of the above-described group (a group having a σp value of 0 or less) include a hydrogen atom having a σp value of 0 and a group (electron-donating group) having a σp value of less than 0 and represented by T22 in Formula (LCP-22). Among the above-described groups, specific examples of the group having a σp value of less than 0 (electron-donating group) are the same as those for T22 in Formula (LCP-22) described below.

The σp value of the above-described group is 0 or less, and from the viewpoint that the uniformity of alignment is more excellent, the σp value is preferably less than 0, more preferably -0.1 or less, and particularly preferably -0.2 or less. The lower limit of the σp value of the above-described group is preferably -0.9 or greater and more preferably -0.7 or greater.

The repeating unit (22) is not particularly limited as long as the repeating unit (22) contains, at a side chain thereof, a mesogen group and a group present at the terminal of the mesogen group and having a σp value of 0 or less, and from the viewpoint of further increasing the uniformity of alignment of liquid crystals, it is preferable that the repeating unit (22) is a repeating unit represented by Formula (PCP-22) which does not correspond to a repeating unit represented by Formula (LCP-21).

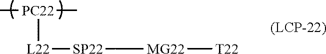

In Formula (LCP-22), PC22 represents the main chain of the repeating unit and more specifically the same structure as that for PC1 in Formula (1), L22 represents a single bond or a divalent linking group and more specifically the same structure as that for L1 in Formula (1), SP22 represents a spacer group and more specifically the same structure as that for SP1 in Formula (1), MG22 represents a mesogen structure and more specifically the same structure as the mesogen group MG in Formula (LC), and T22 represents an electron-donating group having a Hammett’s substituent constant σp value of less than 0.

T22 represents an electron-donating group having a σp value of less than 0. Examples of the electron-donating group having a σp value of less than 0 include a hydroxy group, an alkyl group having 1 to 10 carbon atoms, an alkoxy group having 1 to 10 carbon atoms, and an alkylamino group having 1 to 10 carbon atoms.

In a case where the number of atoms in the main chain of T22 is 20 or less, the alignment degree of the optically anisotropic layer is further improved. Here, “main chain” in T22 denotes the longest molecular chain bonded to MG22, and the number of hydrogen atoms is not included in the number of atoms in the main chain of T22. For example, the number of atoms in the main chain is 4 in a case where T22 represents an n-butyl group, and the number of atoms in the main chain is 3 in a case where T22 represents a sec-butyl group.

Hereinafter, examples of the repeating unit (22) will be described, but the repeating unit (22) is not limited to the following repeating units.

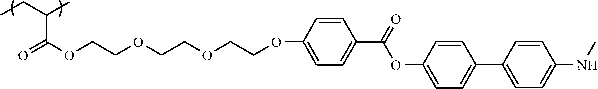

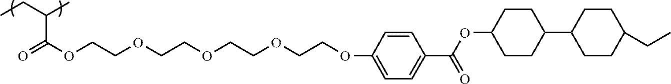

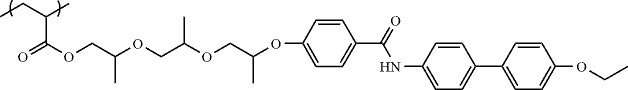

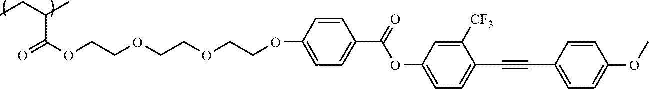

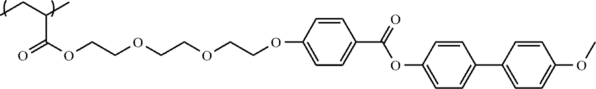

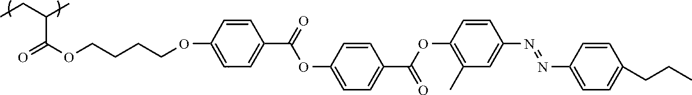

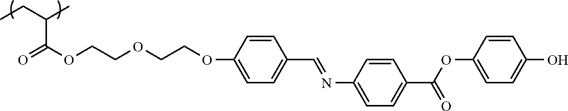

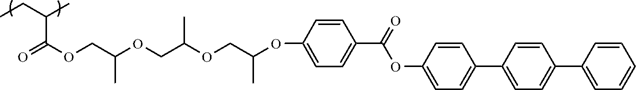

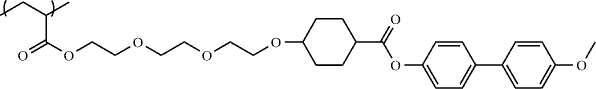

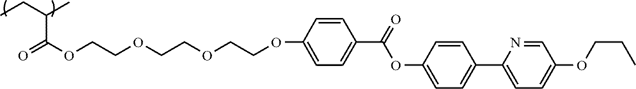

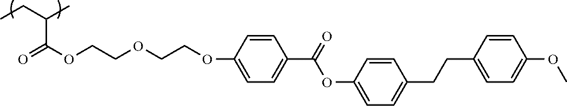

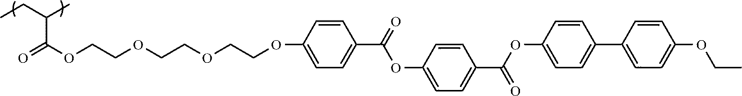

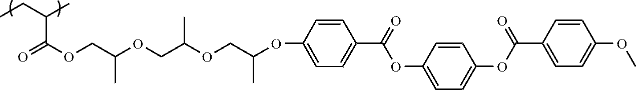

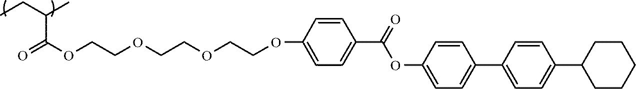

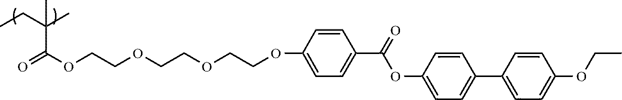

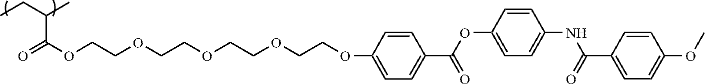

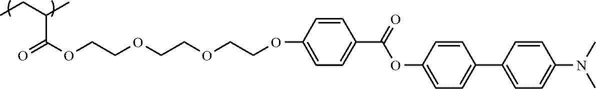

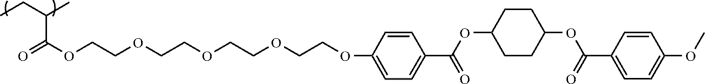

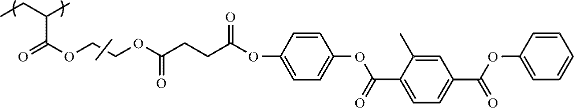

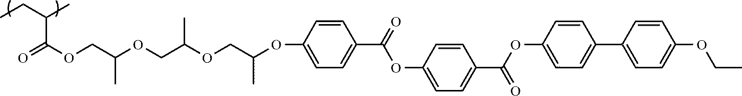

It is preferable that the structures of the repeating unit (21) and the repeating unit (22) have a part in common. It is assumed that the liquid crystals are uniformly aligned as the structures of repeating units are more similar to each other. In this manner, the alignment degree of the optically anisotropic layer is further increased.

Specifically, from the viewpoint of further increasing the alignment degree of the optically anisotropic layer, it is preferable to satisfy at least one of a condition that SP21A of Formula (LCP-21) has the same structure as that for SP22 of Formula (LCP-22), a condition that MG21 of Formula (LCP-21) has the same structure as that for MG22 of Formula (LCP-22), or a condition that L21 of Formula (LCP-21) has the same structure as that for L22 of Formula (LCP-22), more preferable to satisfy two or more of the conditions, and particularly preferable to satisfy all the conditions.

From the viewpoint that the uniformity of alignment is excellent, the content of the repeating unit (22) is preferably 50% by mass or greater, more preferably 55% by mass or greater, and particularly preferably 60% by mass or greater with respect to all the repeating units (100% by mass) of the polymer liquid crystal compound.

From the viewpoint of improving the alignment degree, the upper limit of the content of the repeating unit (22) is preferably 99% by mass or less and more preferably 97% by mass or less with respect to all the repeating units (100% by mass) of the polymer liquid crystal compound.

The polymer liquid crystal compound may have only one or two or more kinds of repeating units (22). In a case where the polymer liquid crystal compound has two or more kinds of repeating units (22), there is an advantage in that the solubility of the polymer liquid crystal compound in a solvent is improved and the liquid crystal phase transition temperature is easily adjusted. In a case where the polymer liquid crystal compound has two or more kinds of repeating units (22), it is preferable that the total amount thereof is in the above-described ranges.

### Repeating Unit (3)

From the viewpoint of improving the solubility in a general-purpose solvent, the polymer liquid crystal compound may have a repeating unit (3) that does not contain a mesogen. Particularly in order to improve the solubility while suppressing a decrease in the alignment degree, it is preferable that the polymer liquid crystal compound has a repeating unit having a molecular weight of 280 or less as the repeating unit (3) that does not contain a mesogen. As described above, the reason why the solubility is improved while a decrease in the alignment degree is suppressed by allowing the polymer liquid crystal compound to have a repeating unit having a molecular weight of 280 or less which does not contain a mesogen is assumed as follows.

That is, it is considered that in a case where the polymer liquid crystal compound has a repeating unit (3) that does not contain a mesogen in a molecular chain thereof, since a solvent is likely to enter the polymer liquid crystal compound, the solubility is improved, but the alignment degree is decreased in the case of the non-mesogenic repeating unit (3). However, it is assumed that since the molecular weight of the repeating unit is small, the alignment of the repeating unit (1), the repeating unit (21), or the repeating unit (22) containing a mesogen group is unlikely to be disturbed, and thus a decrease in the alignment degree can be suppressed.

It is preferable that the repeating unit (3) is a repeating unit having a molecular weight of 280 or less.

The molecular weight of the repeating unit (3) does not indicate the molecular weight of the monomer used to obtain the repeating unit (3), but indicates the molecular weight of the repeating unit (3) in a state of being incorporated into the polymer liquid crystal compound by polymerization of the monomer.

The molecular weight of the repeating unit (3) is 280 or less, preferably 180 or less, and more preferably 100 or less. The lower limit of the molecular weight of the repeating unit (3) is commonly 40 or greater and more preferably 50 or greater. In a case where the molecular weight of the repeating unit (3) is 280 or less, an optically anisotropic layer having excellent solubility of the polymer liquid crystal compound and a high alignment degree can be obtained.

Further, in a case where the molecular weight of the repeating unit (3) is greater than 280, the alignment of the liquid crystals in the portion of the repeating unit (1), the repeating unit (21), or the repeating unit (22) is disturbed, and thus the alignment degree is decreased. Further, since the solvent is unlikely to enter the polymer liquid crystal compound, the solubility of the polymer liquid crystal compound is decreased.

Specific examples of the repeating unit (3) include a repeating unit (hereinafter, also referred to as “repeating unit (3-1)”) that does not contain a crosslinkable group (for example, an ethylenically unsaturated group) and a repeating unit (hereinafter, also referred to as “repeating unit (3-2)”) that contains a crosslinkable group.

### Repeating Unit (3-1)

Specific examples of the monomer used for polymerization of the repeating unit (3-1) include acrylic acid [72.1], α-alkylacrylic acids (such as methacrylic acid [86.1] and itaconic acid [130.1]), esters and amides derived therefrom (such as N-i-propylacrylamide [113.2], N-n-butylacrylamide [127.2], N-t-butylacrylamide [127.2], N,N-dimethylacrylamide [99.1], N-methylmethacrylamide [99.1], acrylamide [71.1], methacrylamide [85.1], diacetoneacrylamide [169.2], acryloylmorpholine [141.2], N-methylol acrylamide [101.1], N-methylol methacrylamide [115.1], methyl acrylate [86.0], ethyl acrylate [100.1], hydroxyethyl acrylate [116.1], n-propyl acrylate [114.1], i-propyl acrylate [114.2], 2-hydroxypropyl acrylate [130.1], 2-methyl-2-nitropropyl acrylate [173.2], n-butyl acrylate [128.2], i-butyl acrylate [128.2], t-butyl acrylate [128.2], t-pentyl acrylate [142.2], 2-methoxyethyl acrylate [130.1], 2-ethoxyethyl acrylate [144.2], 2-ethoxyethoxyethyl acrylate [188.2], 2,2,2-trifluoroethyl acrylate [154.1], 2,2-dimethylbutyl acrylate [156.2], 3-methoxybutyl acrylate [158.2], ethyl carbitol acrylate [188.2], phenoxyethyl acrylate [192.2], n-pentyl acrylate [142.2], n-hexyl acrylate [156.2], cyclohexyl acrylate [154.2], cyclopentyl acrylate [140.2], benzyl acrylate [162.2], n-octyl acrylate [184.3], 2-ethylhexyl acrylate [184.3], 4-methyl-2-propylpentyl acrylate [198.3], methyl methacrylate [100.1], 2,2,2-trifluoroethyl methacrylate [168.1], hydroxyethyl methacrylate [130.1], 2-hydroxypropyl methacrylate [144.2], n-butyl methacrylate [142.2], i-butyl methacrylate [142.2], sec-butyl methacrylate [142.2], n-octyl methacrylate [198.3], 2-ethylhexyl methacrylate [198.3], 2-methoxyethyl methacrylate [144.2], 2-ethoxyethyl methacrylate [158.2], benzyl methacrylate [176.2], 2-norbornyl methyl methacrylate [194.3], 5-norbornen-2-ylmethyl methacrylate [194.3], and dimethylaminoethyl methacrylate [157.2]), vinyl esters (such as vinyl acetate [86.1]), esters derived from maleic acid or fumaric acid (such as dimethyl maleate [144.1] and diethyl fumarate [172.2]), maleimides (such as N-phenylmaleimide [173.2]), maleic acid [116.1], fumaric acid [116.1], p-styrenesulfonic acid [184.1], acrylonitrile [53.1], methacrylonitrile [67.1], dienes (such as butadiene [54.1], cyclopentadiene [66.1], and isoprene [68.1]), aromatic vinyl compounds (such as styrene [104.2], p-chlorostyrene [138.6], t-butylstyrene [160.3], and α-methylstyrene [118.2]), N-vinylpyrrolidone [111.1], N-vinyloxazolidone [113.1], N-vinyl succinimide [125.1], N-vinylformamide [71.1], N-vinyl-N-methylformamide [85.1], N-vinylacetamide [85.1], N-vinyl-N-methylacetamide [99.1], 1-vinylimidazole [94.1], 4-vinylpyridine [105.2], vinylsulfonic acid [108.1], sodium vinyl sulfonate [130.2], sodium allyl sulfonate [144.1], sodium methallyl sulfonate [158.2], vinylidene chloride [96.9], vinyl alkyl ethers (such as methyl vinyl ether [58.1]), ethylene [28.0], propylene [42.1], 1-butene [56.1], and isobutene [56.1]. Further, the numerical values in the parentheses indicate the molecular weights of the monomers.

The above-described monomers may be used alone or in combination of two or more kinds thereof.

Among the above-described monomers, acrylic acid, α-alkylacrylic acids, esters and amides derived therefrom, acrylonitrile, methacrylonitrile, and aromatic vinyl compounds are preferable.

As monomers other than the above-described monomers, the compounds described in Research Disclosure No. 1955 (July, 1980) can be used.

Hereinafter, specific examples of the repeating unit (3-1) and the molecular weights thereof will be described, but the present invention is not limited to these specific examples.

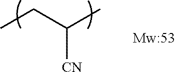

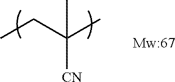

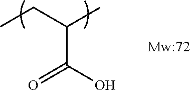

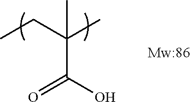

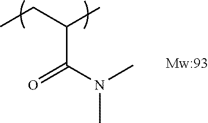

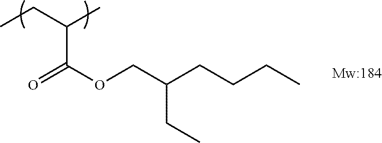

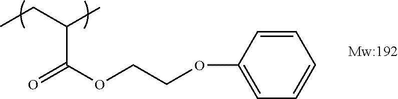

### Repeating Unit (3-2)

Specific examples of the crosslinkable group in the repeating unit (3-2) include the groups represented by Formulae (P-1) to (P-30). Among these, a vinyl group, a butadiene group, a (meth)acryl group, a (meth)acrylamide group, a vinyl acetate group, a fumaric acid ester group, a styryl group, a vinylpyrrolidone group, a maleic acid anhydride, a maleimide group, a vinyl ether group, an epoxy group, and an oxetanyl group are more preferable.

From the viewpoint of easily performing polymerization, it is preferable that the repeating unit (3-2) is a repeating unit represented by Formula (3).

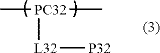

In Formula (3), PC32 represents the main chain of the repeating unit and more specifically the same structure as that for PC1 in Formula (1), L32 represents a single bond or a divalent linking group and more specifically the same structure as that for L1 in Formula (1), and P32 represents a crosslinkable group represented by any of Formulae (P-1) to (P-30).

Hereinafter, specific examples of the repeating unit (3-2) and the weight-average molecular weights (Mw) thereof will be described, but the present invention is not limited to these specific examples.

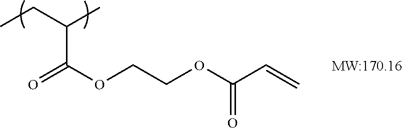

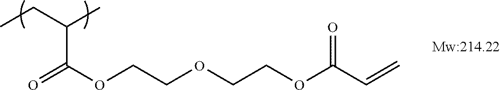

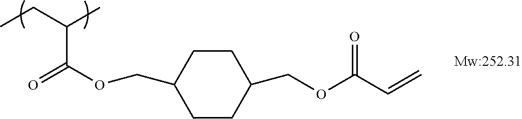

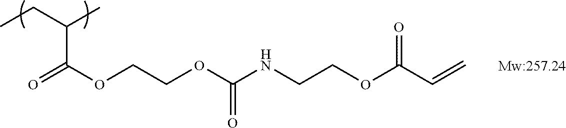

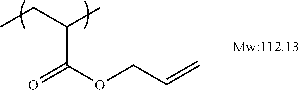

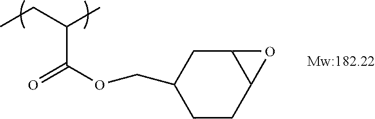

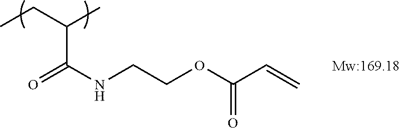

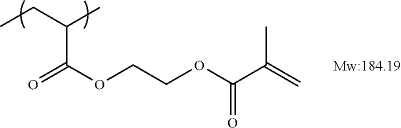

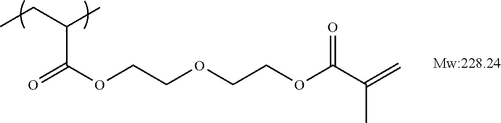

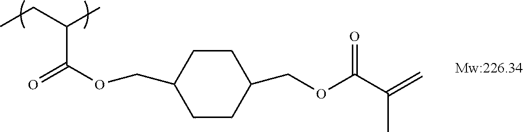

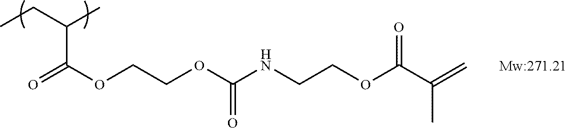

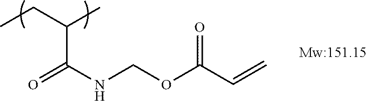

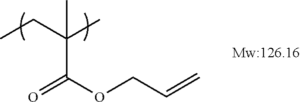

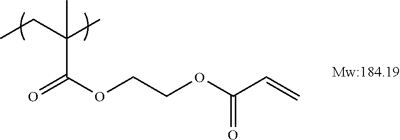

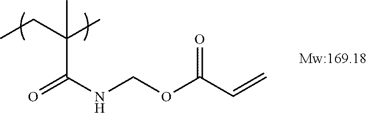

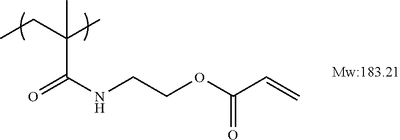

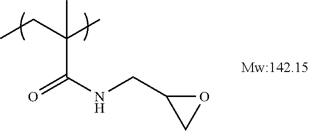

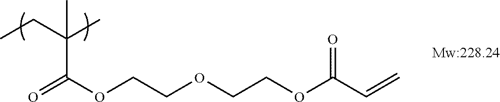

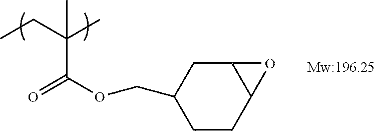

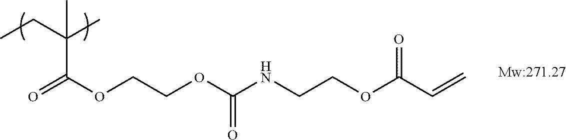

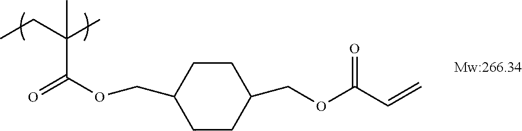

The content of the repeating unit (3) is less than 14% by mass, preferably 7% by mass or less, and more preferably 5% by mass or less with respect to all the repeating units (100% by mass) of the polymer liquid crystal compound. The lower limit of the content of the repeating unit (3) is preferably 2% by mass or greater and more preferably 3% by mass or greater with respect to all the repeating units (100% by mass) of the polymer liquid crystal compound. In a case where the content of the repeating unit (3) is less than 14% by mass, the alignment degree of the optically anisotropic layer is further improved. In a case where the content of the repeating unit (3) is 2% by mass or greater, the solubility of the polymer liquid crystal compound is further improved.

The polymer liquid crystal compound may have only one or two or more kinds of repeating units (3). In a case where the polymer liquid crystal compound has two or more kinds of repeating units (3), it is preferable that the total amount thereof is in the above-described ranges.

### Repeating Unit (4)

From the viewpoint of improving the adhesiveness and planar uniformity, the polymer liquid crystal compound may have a repeating unit (4) having a flexible structure with a long molecular chain (SP4 in Formula (4) described below). The reason for this is assumed as follows.

That is, in a case where the polymer liquid crystal compound has such a flexible structure having a long molecular chain, entanglement of the molecular chains constituting the polymer liquid crystal compound is likely to occur, and aggregation destruction of the optically anisotropic layer (specifically, destruction of the optically anisotropic layer itself) is suppressed. As a result, the adhesiveness between the optically anisotropic layer and the underlayer (for example, the base material or the alignment film) is assumed to be improved. Further, it is considered that a decrease in planar uniformity occurs due to the low compatibility between the dichroic substance and the polymer liquid crystal compound. That is, it is considered that in a case where the compatibility between the dichroic substance and the polymer liquid crystal compound is not sufficient, a planar defect (alignment defect) having the dichroic substance to be precipitated as a nucleus occurs. Meanwhile, it is assumed that in the case where the polymer liquid crystal compound has such a flexible structure having a long molecular chain, an optically anisotropic layer in which precipitation of the dichroic substance is suppressed and the planar uniformity is excellent is obtained. Here, the expression “planar uniformity is excellent” denotes that the alignment defect occurring in a case where the liquid crystal composition containing the polymer liquid crystal compound is repelled on the underlayer (for example, the base material or the alignment film) is less likely to occur.

The repeating unit (4) is a repeating unit represented by Formula (4).

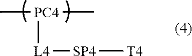

In Formula (4), PC4 represents the main chain of the repeating unit and more specifically the same structure as that for PC1 in Formula (1), L4 represents a single bond or a divalent linking group and more specifically the same structure as that for L1 in Formula (1) (preferably a single bond), SP4 represents an alkylene group having 10 or more atoms in the main chain, and T4 represents a terminal group and more specifically the same structure as that for T1 in Formula (1).

Specific examples and suitable aspects of PC4 are the same as those for PC1 in Formula (1), and thus description thereof will not be repeated.

From the viewpoint of further exhibiting the effects of the present invention, it is preferable that L4 represents a single bond.

In Formula (4), SP4 represents an alkylene group having 10 or more atoms in the main chain. Here, one or more —CH2—′s constituting the alkylene group represented by SP4 may be substituted with “SP—C″ described above and is particularly preferably substituted with at least one group selected from the group consisting of —O—, —S—, —N(R²¹)—, —C(═O)—, —C(═S)—, —C(R²²)═C(R²³)—, an alkynylene group, —Si(R²⁴)(R²⁵)—, —N═N—, —C(R²⁶)═N—N═C(R²⁷)—, —C(R²⁸)═N—, and —S(═O)₂—. In addition, R²¹ to R²⁸ each independently represent a hydrogen atom, a halogen atom, a cyano group, a nitro group, or a linear or branched alkyl group having 1 to 10 carbon atoms. Further, the hydrogen atoms contained in one or more —CH₂—′s constituting the alkylene group represented by SP4 may be substituted with “SP—H″ described above.

The number of atoms in the main chain of SP4 is 10 or greater, and from the viewpoint of obtaining an optically anisotropic layer in which at least one of the adhesiveness or the planar uniformity is more excellent, the number of atoms is preferably 15 or greater and more preferably 19 or greater. Further, from the viewpoint of obtaining an optically anisotropic layer with a more excellent alignment degree, the upper limit of the number of atoms in the main chain of SP2 is preferably 70 or less, more preferably 60 or less, and particularly preferably 50 or less.

Here, “main chain” in SP4 denotes a partial structure required for directly linking L4 and T4 to each other, and “number of atoms in the main chain” denotes the number of atoms constituting the partial structure. In other words, “main chain” in SP4 denotes a partial structure in which the number of atoms linking L4 and T4 to each other is the smallest. For example, the number of atoms in the main chain in a case where SP4 represents a 3,7-dimethyldecanyl group is 10, and the number of atoms in the main chain in a case where SP4 represents a 4,6-dimethyldodecanyl group is 12. Further, in Formula (4-1), the inside of the frame shown by the dotted quadrangle corresponds to SP4, and the number of atoms in the main chain of SP4 (corresponding to the total number of atoms circled by the dotted line) is 11.

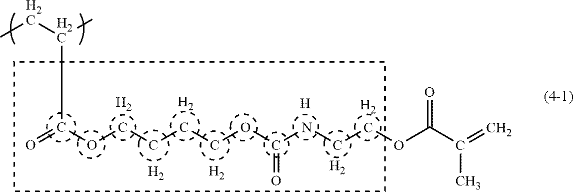

The alkylene group represented by SP4 may be linear or branched.

From the viewpoint of obtaining an optically anisotropic layer with a more excellent alignment degree, the number of carbon atoms of the alkylene group represented by SP4 is preferably in a range of 8 to 80, more preferably in a range of 15 to 80, still more preferably in a range of 25 to 70, and particularly preferably in a range of 25 to 60.

From the viewpoint of obtaining an optically anisotropic layer with more excellent adhesiveness and planar uniformity, it is preferable that one or more —CH₂—′s constituting the alkylene group represented by SP4 are substituted with “SP-C″ described above.

Further, in a case where a plurality of -CH2-′s constituting the alkylene group represented by SP4 are present, it is more preferable that only some of the plurality of —CH₂—′s are substituted with “SP-C″ described above from the viewpoint of obtaining an optically anisotropic layer with more excellent adhesiveness and planar uniformity.

Among examples of “SP-C″, at least one group selected from the group consisting of —O, —S—, —N(R²¹)—, —C(═O)—, —C(═S)—, —C(R²²)═C(R²³)—, an alkynylene group, —Si(R²⁴)(R²⁵)—, —N═N—, —C(R²⁶)═N—N═C(R²⁷)—, —C(R²⁸)═N—, and S(═O)₂— is preferable, and from the viewpoint of obtaining an optically anisotropic layer with more excellent adhesiveness and planar uniformity, at least one group selected from the group consisting of —O—, —N(R²¹)—, —C(═O)—, and —S(═O)₂— is more preferable, and at least one group selected from the group consisting of —O—, —N(R²¹)—, and —C(═O)— is particularly preferable.

Particularly, it is preferable that SP4 represents a group having at least one selected from the group consisting of an oxyalkylene structure in which one or more —CH₂—′s constituting an alkylene group are substituted with —O—, an ester structure in which one or more —CH₂—CH₂—′s constituting an alkylene group are substituted with —O— and C(═O)—, and a urethane bond in which one or more —CH₂—CH₂—CH₂—′s constituting an alkylene group are substituted with —O—, —C(═O)—, and NH—.

The hydrogen atoms contained in one or more —CH2—′s constituting the alkylene group represented by SP4 may be substituted with “SP-H″ described above. In this case, one or more hydrogen atoms contained in —CH₂— may be substituted with “SP-H″. That is, only one hydrogen atom contained in —CH₂— may be substituted with “SP—H″ or all (two) hydrogen atoms contained in —CH₂— may be substituted with “SP-H″.

Among the examples of SP-H″, at least one group selected from the group consisting of a halogen atom, a cyano group, a nitro group, a hydroxy group, a linear alkyl group having 1 to 10 carbon atoms, a branched alkyl group having 1 to 10 carbon atoms, and a halogenated alkyl group having 1 to 10 carbon atoms is preferable, and at least one group selected from the group consisting of a hydroxy group, a linear alkyl group having 1 to 10 carbon atoms, and a branched alkyl group having 1 to 10 carbon atoms is more preferable.

As described above, T4 represents the same terminal group as that for T1 and preferably a hydrogen atom, a methyl group, a hydroxy group, a carboxy group, a sulfonic acid group, a phosphoric acid group, a boronic acid group, an amino group, a cyano group, a nitro group, a phenyl group which may have a substituent, or -L-CL (L represents a single bond or a divalent linking group, specific examples of the divalent linking group are the same as those for LW and SPW described above, and CL represents a crosslinkable group, and examples thereof include a group represented by Q1 or Q2, among these, a crosslinkable group represented by any of Formulae (P-1) to (P-30) is preferable), and it is preferable that CL represents a vinyl group, a butadiene group, a (meth)acryl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group.

The epoxy group may be an epoxycycloalkyl group, and the number of carbon atoms of the cycloalkyl group moiety in the epoxycycloalkyl group is preferably in a range of 3 to 15, more preferably in a range of 5 to 12, and particularly preferably 6 (that is, in a case where the epoxycycloalkyl group is an epoxycyclohexyl group) from the viewpoint that the effects of the present invention are more excellent.

Examples of the substituent of the oxetanyl group include an alkyl group having 1 to 10 carbon atoms. Among the examples, an alkyl group having 1 to 5 carbon atoms is preferable from the viewpoint that the effects of the present invention are more excellent. The alkyl group as a substituent of the oxetanyl group may be linear or branched, but is preferably linear from the viewpoint that the effects of the present invention are more excellent.

Examples of the substituent of the phenyl group include a boronic acid group, a sulfonic acid group, a vinyl group and an amino group. Among these, from the viewpoint that the effects of the present invention are more excellent, a boronic acid group is preferable.

Specific examples of the repeating unit (4) include the following structures, but the present invention is not limited thereto. Further, in the following specific examples, n1 represents an integer of 2 or greater, and n2 represents an integer of 1 or greater.

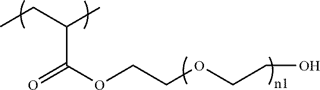

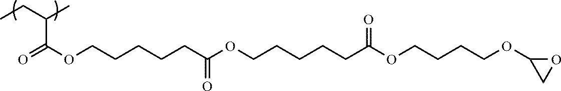

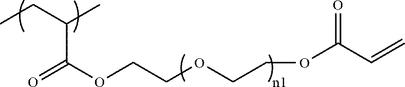

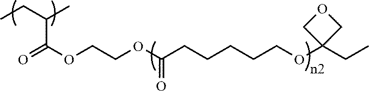

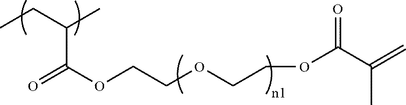

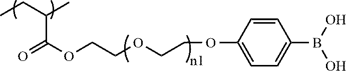

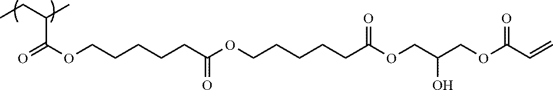

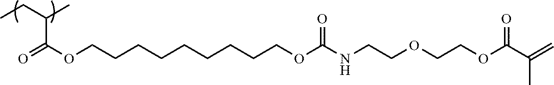

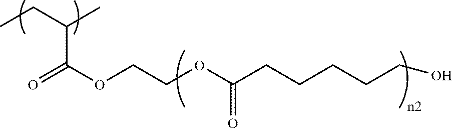

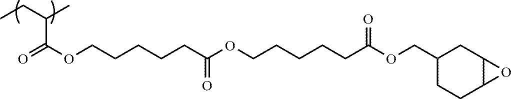

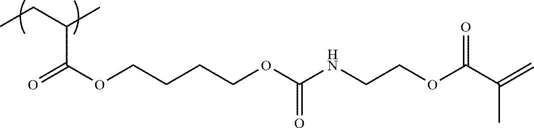

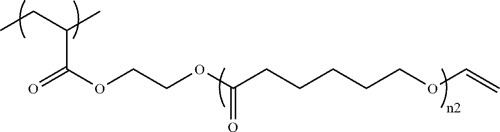

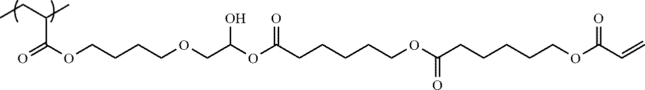

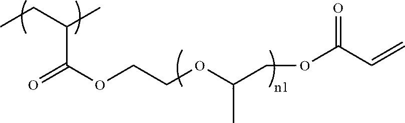

The content of the repeating unit (4) is preferably in a range of 2% to 20% by mass and more preferably in a range of 3% to 18% by mass with respect to all the repeating units (100% by mass) of the polymer liquid crystal compound. In a case where the content of the repeating unit (4) is 2% by mass or greater, an optically anisotropic layer having more excellent adhesiveness can be obtained. Further, in a case where the content of the repeating unit (4) is 20% by mass or less, an optically anisotropic layer having more excellent planar uniformity can be obtained.

The polymer liquid crystal compound may have only one or two or more kinds of repeating units (4). In a case where the polymer liquid crystal compound has two or more kinds of repeating units (4), the content of the repeating unit (4) denotes the total content of the repeating units (4).

### Repeating Unit (5)

From the viewpoint of the planar uniformity, the polymer liquid crystal compound may have a repeating unit (5) to be introduced by polymerizing a polyfunctional monomer. Particularly in order to improve the planar uniformity while suppressing a decrease in the alignment degree, it is preferable that the polymer liquid crystal compound has 10% by mass or less of the repeating unit (5) to be introduced by polymerizing a polyfunctional monomer. As described above, the reason why the planar uniformity can be improved while a decrease in the alignment degree is suppressed by allowing the polymer liquid crystal compound to have 10% by mass or less of the repeating unit (5) is assumed as follows.

The repeating unit (5) is a unit to be introduced to the polymer liquid crystal compound by polymerizing a polyfunctional monomer. Therefore, it is considered that the polymer liquid crystal compound contains a high-molecular-weight body in which a three-dimensional crosslinked structure is formed by the repeating unit (5). Here, since the content of the repeating unit (5) is small, the content of the high-molecular-weight body having the repeating unit (5) is considered to be small.

It is assumed that an optically anisotropic layer in which cissing of the liquid crystal composition is suppressed and the planar uniformity is excellent is obtained due to the presence of a small amount of the high-molecular-weight body with the three-dimensional crosslinked structure that has been formed as described above.

Further, it is assumed that the effect of suppressing a decrease in the alignment degree can be maintained because the content of the high-molecular-weight body is small.

It is preferable that the repeating unit (5) to be introduced by polymerizing a polyfunctional monomer is a repeating unit represented by Formula (5).

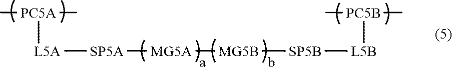

In Formula (5), PC5A and PC5B represent the main chain of the repeating unit and more specifically the same structure as that for PC1 in Formula (1), L5A and L5B represent a single bond or a divalent linking group and more specifically the same structure as that for L1 in Formula (1), SP5A and SP5B represent a spacer group and more specifically the same structure as that for SP1 in Formula (1), MG5A and MG5B represent a mesogen structure and more specifically the same structure as that for the mesogen group MG in Formula (LC), and a and b represent an integer of 0 or 1.

PC5A and PC5B may represent the same group or different groups, but it is preferable that PC5A and PC5B represent the same group from the viewpoint of further improving the alignment degree of the optically anisotropic layer.

L5A and L5B may represent a single bond, the same group, or different groups, but L5A and L5B represent preferably a single bond or the same group and more preferably the same group from the viewpoint of further improving the alignment degree of the optically anisotropic layer.

SP5A and SP5B may represent a single bond, the same group, or different groups, but SP5A and SP5B represent preferably a single bond or the same group and more preferably the same group from the viewpoint of further improving the alignment degree of the optically anisotropic layer.

Here, the same group in Formula (5) indicates that the chemical structures are the same as each other regardless of the orientation in which each group is bonded. For example, even in a case where SP5A represents *—CH₂—CH₂—O—** (* represents a bonding position with respect to L5A, and ** represents a bonding position with respect to MG5A) and SP5B represents *—O—CH₂—CH₂—** (* represents a bonding position with respect to MG5B, and ** represents a bonding position with respect to L5B), SP5A and SP5B represent the same group.

a and b each independently represent an integer of 0 or 1 and preferably 1 from the viewpoint of further improving the alignment degree of the optically anisotropic layer.

a and b may be the same as or different from each other, but from the viewpoint of further improving the alignment degree of the optically anisotropic layer, it is preferable that both a and b represent 1.

From the viewpoint of further improving the alignment degree of the optically anisotropic layer, the sum of a and b is preferably 1 or 2 (that is, the repeating unit represented by Formula (5) contains a mesogen group) and more preferably 2.

From the viewpoint of further improving the alignment degree of the optically anisotropic layer, it is preferable that the partial structure represented by —(MG5A)ₐ—(MG5B)_{b}—has a cyclic structure. In this case, from the viewpoint of further improving the alignment degree of the optically anisotropic layer, the number of cyclic structures in the partial structure represented by —(MG5A2)ₐ—(MG5B)_{b}— is preferably 2 or greater, more preferably in a range of 2 to 8, still more preferably in a range of 2 to 6, and particularly preferably in a range of 2 to 4.

From the viewpoint of further improving the alignment degree of the optically anisotropic layer, the mesogen groups represented by MG5A and MG5B each independently have preferably one or more cyclic structures, more preferably 2 to 4 cyclic structures, still more preferably 2 or 3 cyclic structures, and particularly preferably 2 cyclic structures.

Specific examples of the cyclic structure include an aromatic hydrocarbon group, a heterocyclic group, and an alicyclic group. Among these, an aromatic hydrocarbon group and an alicyclic group are preferable.

MG5A and MG5B may represent the same group or different groups, but from the viewpoint of further improving the alignment degree of the optically anisotropic layer, it is preferable that MG5A and MG5B represent the same group.

From the viewpoints of exhibiting the liquid crystallinity, adjusting the liquid crystal phase transition temperature, and the availability of raw materials and synthetic suitability and from the viewpoint that the effects of the present invention are more excellent, it is preferable that the mesogen group represented by MG5A and MG5B is the mesogen group MG in Formula (LC).

Particularly in the repeating unit (5), it is preferable that PC5A and PC5B represent the same group, both L5A and L5B represent a single bond or the same group, both SP5A and SP5B represent a single bond or the same group, and MG5A and MG5B represent the same group. In this manner, the alignment degree of the optically anisotropic layer is further improved.

The content of the repeating unit (5) is preferably 10% by mass or less, more preferably in a range of 0.001% to 5% by mass, and still more preferably in a range of 0.05% to 3% by mass with respect to the content (100% by mass) of all the repeating units of the polymer liquid crystal compound.

The polymer liquid crystal compound may have only one or two or more kinds of repeating units (5). In a case where the polymer liquid crystal compound has two or more kinds of repeating units (5), it is preferable that the total amount thereof is in the above-described ranges.

### Star-Shaped Polymer

The polymer liquid crystal compound may be a star-shaped polymer. The star-shaped polymer in the present invention indicates a polymer having three or more polymer chains extending from the nucleus and is specifically represented by Formula (6).

The star-shaped polymer represented by Formula (6) as the polymer liquid crystal compound can form an optically anisotropic layer having a high alignment degree while having high solubility (excellent solubility in a solvent).

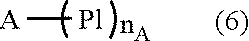

In Formula (6), n_{A} represents an integer of 3 or greater and preferably an integer of 4 or greater. The upper limit of n_{A} is not limited thereto, but is commonly 12 or less and preferably 6 or less.

A plurality of PI’s each independently represent a polymer chain having any of repeating units represented by Formulae (1), (21), (22), (3), (4), and (5). Here, at least one of the plurality of PI’s represents a polymer chain having a repeating unit represented by Formula (1).

A represents an atomic group that is the nucleus of the star-shaped polymer. Specific examples of A include structures obtained by removing hydrogen atoms from thiol groups of the polyfunctional thiol compound, described in paragraphs [0052] to [0058] of JP2011-074280A, paragraphs [0017] to [0021] of JP2012-189847A, paragraphs [0012] to [0024] of JP2013- 031986A, and paragraphs [0118] to [0142] of JP2014-104631A. In this case, A and PI are bonded to each other through a sulfide bond.

The number of thiol groups of the polyfunctional thiol compound from which A is derived is preferably 3 or greater and more preferably 4 or greater. The upper limit of the number of thiol groups of the polyfunctional thiol compound is commonly 12 or less and preferably 6 or less.

Specific examples of the polyfunctional thiol compound are shown below.

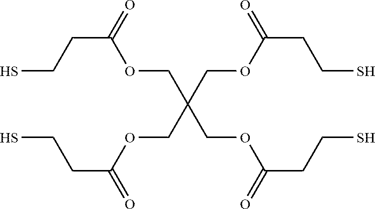 [SMILES: O=C(CCS)OCC(COC(=O)CCS)(COC(=O)CCS)COC(=O)CCS]

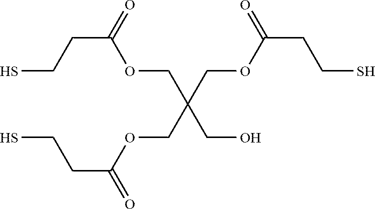 [SMILES: O=C(CCS)OCC(CO)(COC(=O)CCS)COC(=O)CCS]

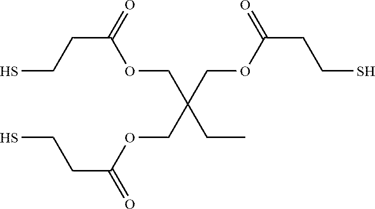 [SMILES: CCC(COC(=O)CCS)(COC(=O)CCS)COC(=O)CCS]

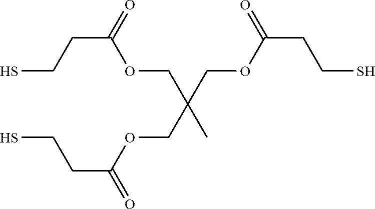 [SMILES: CC(COC(=O)CCS)(COC(=O)CCS)COC(=O)CCS]

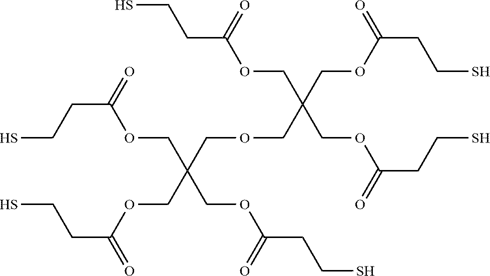 [SMILES: O=C(CCS)OCC(COCC(COC(=O)CCS)(COC(=O)CCS)COC(=O)CCS)(COC(=O)CCS)COC(=O)CCS]

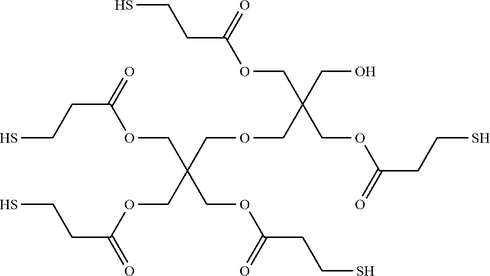 [SMILES: O=C(CCS)OCC(CO)(COCC(COC(=O)CCS)(COC(=O)CCS)COC(=O)CCS)COC(=O)CCS]

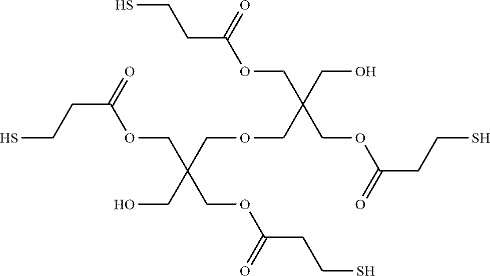 [SMILES: O=C(CCS)OCC(CO)(COCC(CO)(COC(=O)CCS)COC(=O)CCS)COC(=O)CCS]

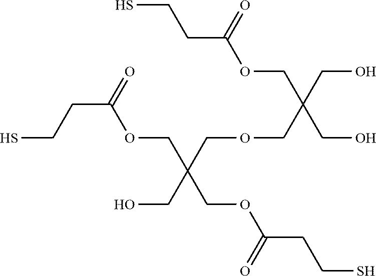 [SMILES: O=C(CCS)OCC(CO)(CO)COCC(CO)(COC(=O)CCS)COC(=O)CCS]

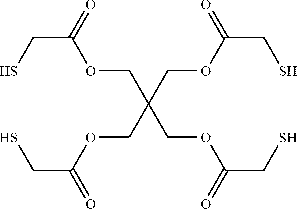 [SMILES: O=C(CS)OCC(COC(=O)CS)(COC(=O)CS)COC(=O)CS]

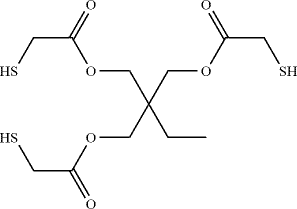 [SMILES: CCC(COC(=O)CS)(COC(=O)CS)COC(=O)CS]

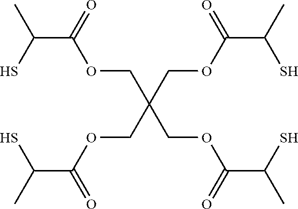 [SMILES: CC(S)C(=O)OCC(COC(=O)C(C)S)(COC(=O)C(C)S)COC(=O)C(C)S]

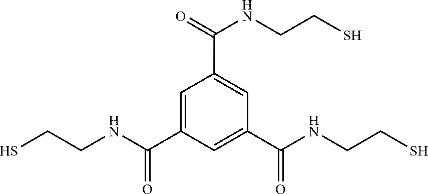 [SMILES: O=C(NCCS)c1cc(C(=O)NCCS)cc(C(=O)NCCS)c1]

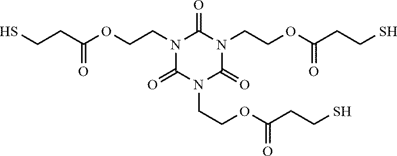 [SMILES: O=C(CCS)OCCn1c(=O)n(CCOC(=O)CCS)c(=O)n(CCOC(=O)CCS)c1=O]

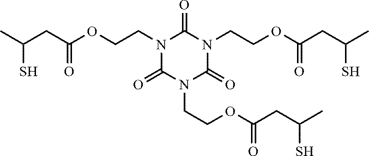 [SMILES: CC(S)CC(=O)OCCn1c(=O)n(CCOC(=O)CC(C)S)c(=O)n(CCOC(=O)CC(C)S)c1=O]

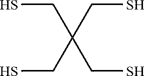

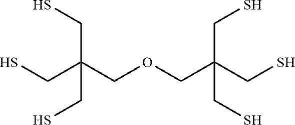 [SMILES: SCC(CS)(CS)COCC(CS)(CS)CS]

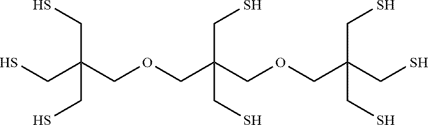 [SMILES: SCC(CS)(CS)COCC(CS)(CS)COCC(CS)(CS)CS]

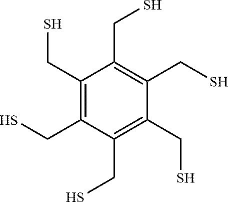 [SMILES: SCc1c(CS)c(CS)c(CS)c(CS)c1CS]

From the viewpoint of further improving the alignment degree, the polymer liquid crystal compound may be a thermotropic liquid crystal and a crystalline polymer.

### Thermotropic Liquid Crystal

A thermotropic liquid crystal is a liquid crystal that shows transition to a liquid crystal phase due to a change in temperature.

The specific compound is a thermotropic liquid crystal and may exhibit any of a nematic phase or a smectic phase, but it is preferable that the specific compound exhibits at least the nematic phase from the viewpoint that the alignment degree of the optically anisotropic layer is further increased, and haze is unlikely to be observed (haze is further enhanced).

The temperature range in which the nematic phase is exhibited is preferably in a range of room temperature (23° C.) to 450° C. from the viewpoint that the alignment degree of the optically anisotropic layer is further increased and haze is unlikely to be observed and more preferably in a range of 40° C. to 400° C. from the viewpoints of the handleability and the manufacturing suitability.

### Crystalline Polymer

A crystalline polymer is a polymer showing a transition to a crystal layer due to a change in temperature. The crystalline polymer may show a glass transition other than the transition to the crystal layer.

It is preferable that the crystalline polymer is a polymer liquid crystal compound that has a transition from a crystal phase to a liquid crystal phase in a case of being heated (glass transition may be present in the middle of the transition) from the viewpoint that the alignment degree of the optically anisotropic layer is further increased and haze is unlikely to be observed or a polymer liquid crystal compound that has a transition to a crystal phase in a case where the temperature is lowered after entering a liquid crystal state by being heated (glass transition may be present in the middle of the transition).

The presence or absence of crystallinity of the polymer liquid crystal compound is evaluated as follows.

Two optically anisotropic layers of an optical microscope (ECLIPSE E600 POL, manufactured by Nikon Corporation) are disposed to be orthogonal to each other, and a sample table is set between the two optically anisotropic layers. Further, a small amount of the polymer liquid crystal compound is placed on slide glass, and the slide glass is set on a hot stage placed on the sample table. While the state of the sample is observed, the temperature of the hot stage is increased to a temperature at which the polymer liquid crystal compound exhibits liquid crystallinity, and the polymer liquid crystal compound is allowed to enter a liquid crystal state. After the polymer liquid crystal compound enters the liquid crystal state, the behavior of the liquid crystal phase transition is observed while the temperature of the hot stage is gradually lowered, and the temperature of the liquid crystal phase transition is recorded. In a case where the polymer liquid crystal compound exhibits a plurality of liquid crystal phases (for example, a nematic phase and a smectic phase), all the transition temperatures are also recorded.

Next, approximately 5 mg of a sample of the polymer liquid crystal compound is put into an aluminum pan, and the pan is covered and set on a differential scanning calorimeter (DSC) (an empty aluminum pan is used as a reference). The polymer liquid crystal compound measured in the above-described manner is heated to a temperature at which the compound exhibits a liquid crystal phase, and the temperature is maintained for 1 minute. Thereafter, the calorific value is measured while the temperature is lowered at a rate of 10° C./min. An exothermic peak is confirmed from the obtained calorific value spectrum.

As a result, in a case where an exothermic peak is observed at a temperature other than the liquid crystal phase transition temperature, it can be said that the exothermic peak is a peak due to crystallization and the polymer liquid crystal compound has crystallinity.

Meanwhile, in a case where an exothermic peak is not observed at a temperature other than the liquid crystal phase transition temperature, it can be said that the polymer liquid crystal compound does not have crystallinity.

The method of obtaining a crystalline polymer is not particularly limited, but as a specific example, a method of using a polymer liquid crystal compound having the repeating unit (1) described above is preferable, and a method of using a suitable aspect among polymer liquid crystal compounds having the repeating unit (1) described above is more preferable.

### Crystallization Temperature

From the viewpoint that the alignment degree of the optically anisotropic layer is further increased and haze is unlikely to be observed, the crystallization temperature of the polymer liquid crystal compound is preferably -50° C. or higher and lower than 150° C., more preferably 120° C. or lower, still more preferably -20° C. or higher and lower than 120° C., and particularly preferably 95° C. or lower. The crystallization temperature of the polymer liquid crystal compound is preferably lower than 150° C. from the viewpoint of reducing haze.

Further, the crystallization temperature is a temperature of an exothermic peak due to crystallization in the above-described DSC.

### Molecular Weight

From the viewpoint that the effects of the present invention are more excellent, the weight-average molecular weight (Mw) of the polymer liquid crystal compound is preferably in a range of 1000 to 500000 and more preferably in a range of 2000 to 300000. In a case where the Mw of the polymer liquid crystal compound is in the above-described range, the polymer liquid crystal compound is easily handled.

In particular, from the viewpoint of suppressing cracking during the coating, the weight-average molecular weight (Mw) of the polymer liquid crystal compound is preferably 10000 or greater and more preferably in a range of 10000 to 300000.

In addition, from the viewpoint of the temperature latitude of the alignment degree, the weight-average molecular weight (Mw) of the polymer liquid crystal compound is preferably less than 10000 and more preferably 2000 or greater and less than 10000.

Here, the weight-average molecular weight and the number average molecular weight in the present invention are values measured by the gel permeation chromatography (GPC) method.
Solvent (eluent): N-methylpyrrolidone
Equipment name: TOSOH HLC-8220GPC
Column: Connect and use three of TOSOH TSKgel Super AWM-H (6 mm × 15 cm)
Column temperature: 25° C.
Sample concentration: 0.1% by mass
Flow rate: 0.35 mL/min
Calibration curve: TSK standard polystyrene (manufactured by TOSOH Corporation), calibration curves of 7 samples with Mw of 2800000 to 1050 (Mw/Mn = 1.03 to 1.06) are used.

The polymer liquid crystal compound may exhibit nematic or smectic liquid crystallinity, but it is preferable that the polymer liquid crystal compound exhibits at least the nematic liquid crystallinity.

The temperature at which the nematic phase is exhibited is preferably in a range of 0° C. to 450° C., and more preferably in a range of 30° C. to 400° C. from the viewpoints of handleability and manufacturing suitability.

### Content

From the viewpoint that the effects of the present invention are more excellent, the content of the rod-like liquid crystal compound is preferably in a range of 10% to 97% by mass, more preferably in a range of 40% to 95% by mass, and still more preferably in a range of 60% to 95% by mass with respect to the total solid content (100% by mass) of the liquid crystal composition.

In a case where the rod-like liquid crystal compound contains a polymer liquid crystal compound, the content of the polymer liquid crystal compound is preferably in a range of 10% to 99% by mass, more preferably in a range of 30% to 95% by mass, and still more preferably in a range of 40% to 90% by mass with respect to the total mass (100 parts by mass) of the rod-like liquid crystal compound.

In a case where the rod-like liquid crystal compound contains a low-molecular-weight liquid crystal compound, the content of the low-molecular-weight liquid crystal compound is preferably in a range of 1% to 90% by mass, more preferably in a range of 5% to 70% by mass, and still more preferably in a range of 10% to 60% by mass with respect to the total mass (100 parts by mass) of the rod-like liquid crystal compound.

In a case where the rod-like liquid crystal compound contains both a polymer liquid crystal compound and a low-molecular-weight liquid crystal compound, from the viewpoint that the effects of the present invention are more excellent, the mass ratio (low-molecular-weight liquid crystal compound/polymer liquid crystal compound) of the content of the low-molecular-weight liquid crystal compound to the content of the polymer liquid crystal compound is preferably in a range of 5/95 to 70/30 and more preferably in a range of 10/90 to 50/50.

Here, “solid content in the liquid crystal composition” denotes a component from which a solvent is removed, and specific examples of the solid content include the rod-like liquid crystal compound, and a dichroic substance, a polymerization initiator, an interface improver described below.

### Specific Interface Improver

The specific interface improver is a copolymer having a repeating unit B1 represented by Formula (N-1) and a repeating unit B2 having a fluorine atom. The specific interface improver is a polymer compound having a structure different from that of the rod-like liquid crystal compound described above and is preferably a compound that does not exhibit liquid crystallinity.

### Repeating Unit B1

The repeating unit B1 is a repeating unit represented by Formula (N-1). The repeating unit B1 has a structure different from that of the repeating unit B2 described below and preferably has no fluorine atom.

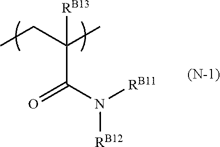

In Formula (N-1), R^{B11} and R^{B12} each independently represent a hydrogen atom or a substituent. Here, in a case where R^{B11} and R^{B12} represent a substituent, R^{B11} and R^{B12} may be linked to each other to form a ring.

The total molecular weight of R^{B11} and R^{B12} is preferably 200 or less, more preferably 100 or less, and still more preferably 70 or less. In a case where the total molecular weight thereof is 100 or less, the interaction between the repeating units B1 is further improved, and thus the compatibility between the specific interface improver and the liquid crystal molecules can be further decreased. In this manner, an optically anisotropic layer with less alignment defects and an excellent alignment degree can be obtained.

The lower limit of the total molecular weight of R^{B11} and R^{B12} is preferably 2 or greater.

From the viewpoint that the effects of the present invention are more excellent, as the substituent represented by R^{B11} and R^{B12}, an organic group is preferable, an organic group having 1 to 15 carbon atoms is more preferable, an organic group having 1 to 12 carbon atoms is still more preferable, and an organic group having 1 to 8 carbon atoms is particularly preferable.

Examples of the organic group include a linear, branched, or cyclic alkyl group, an aromatic hydrocarbon group, and a heterocyclic group.

The number of carbon atoms of the alkyl group is preferably in a range of 1 to 15, more preferably in a range of 1 to 12, and still more preferably in a range of 1 to 8.

The carbon atom of the alkyl group may be substituted with —O—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, an alkyl group having 1 to 4 carbon atoms, a cycloalkyl group, an aryl group, a cyano group, or a halogen atom), —C═C—, —N═N—, —S—, —C(S)—, —S(O)—, —SO₂—, —(O)S(O)O—, —O(O)S(O)O—, —SC(O)—, —C(O)S—, or a group obtained by combining two or more of these groups. Among the groups that the carbon atom of the alkyl group may be substituted with, from the viewpoint that the effects of the present invention are more excellent, —O—, —C(O)—, —N(Z)—, —OC(O)—, or —C(O)O— is preferable.

Further, the hydrogen atoms of the alkyl group may be substituted with a halogen atom, a cyano group, an aryl group, a nitro group, —OZ^{H}, —C(O)Z^{H}, —C(O)OZ^{H}, —OC(O)Z^{H}, —OC(O)OZ^{H}, —NZ^{H}Z^{H}′, —NZ^{H}C(O)Z^{H}′, —NZ^{H}C(O)OZ^{H}′, —C(O)NZ^{H}Z^{H}′, —OC(O)NZ^{H}Z^{H}′, — NZ^{H}C(O)NZ^{H}′OZ^{H}″, —SZ^{H}, —C(S)Z^{H}, —C(O)SZ^{H}, or —SC(O)Z^{H}. Z^{H}, Z^{H}′, and Z^{H}″ each independently represent a hydrogen atom, a halogen atom, an alkyl group having 1 to 10 carbon atoms, a cyano group, or a nitro group. Among the groups that the hydrogen atom of the alkyl group may be substituted with, from the viewpoint that the effects of the present invention are more excellent, —OH, —COOH, or an aryl group (preferably a phenyl group) is preferable.

The hydrogen atom of the aromatic hydrocarbon group and the hydrogen atom of the heterocyclic group may be substituted with a halogen atom, a cyano group, an alkyl group having 1 to 10 carbon atoms, a nitro group, —OZ^{H}, —C(O)Z^{H}, —C(O)OZ^{H}, —OC(O)Z^{H}, —OC(O)OZ^{H}, —NZ^{H}Z^{H}′, —NZ^{H}C(O)Z^{H}′, —NZ^{H}C(O)OZ^{H}′, —C(O)NZ^{H}Z^{H}′, —OC(O)NZ^{H}Z^{H}′, —NZ^{H}C(O)NZ^{H}′OZ^{H}″, —SZ^{H}, —C(S)Z^{H}, —C(O)SZ^{H}, —SC(O)Z^{H}, or —B(OH)₂. Z^{H}, Z^{H}′, and Z^{H}″ each independently represent a hydrogen atom, a halogen atom, an alkyl group having 1 to 10 carbon atoms, a cyano group, or a nitro group. Among the groups that the hydrogen atom of the aromatic hydrocarbon group and the hydrogen atom of the heterocyclic group may be substituted with, —OH and —B(OH)₂ are preferable from the viewpoint that the effects of the present invention are more excellent.

From the viewpoint that the effects of the present invention are more excellent, it is preferable that R^{B11} and R^{B12} each independently represent a hydrogen atom or an organic group having 1 to 15 carbon atoms. Suitable aspects of the organic group are as described above.

From the viewpoint that the effects of the present invention are more excellent, at least one of R^{B11} or R^{B12} represents preferably a substituent and more preferably an organic group having 1 to 15 carbon atoms.

The ring formed by R^{B11} and R^{B12} being linked to each other is a heterocyclic ring having a nitrogen atom in Formula (N-1) and may further have heteroatoms such as an oxygen atom, a sulfur atom, and a nitrogen atom therein.

From the viewpoint that the effects of the present invention are more excellent, the ring formed by R^{B11} and R^{B12} being linked to each other is preferably a 4- to 8-membered ring, more preferably a 5- to 7-membered ring, and still more preferably a 5- or 6-membered ring.

From the viewpoint that the effects of the present invention are more excellent, the number of carbon atoms constituting a ring formed by R^{B11} and R^{B12} being linked to each other is preferably in a range of 3 to 7 and more preferably in a range of 3 to 6.

The ring formed by R^{B11} and R^{B12} being linked to each other may or may not have aromaticity, but it is preferable that the ring does not have aromaticity from the viewpoint that the effects of the present invention are more excellent.

Specific examples of the ring formed by R^{B11} and R^{B12} being linked to each other include the following groups.

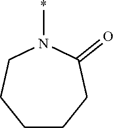 [SMILES: *N1CCCCCC1=O]

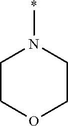 [SMILES: *N1CCOCC1]

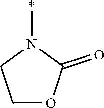 [SMILES: *N1CCOC1=O]

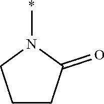 [SMILES: *N1CCCC1=O]

R^{B13} represents a hydrogen atom, an alkyl group having 1 to 5 carbon atoms, a halogen atom, or a cyano group. Among these, a hydrogen atom or an alkyl group having 1 to 5 carbon atoms is preferable, and a hydrogen atom is more preferable.

The number of carbon atoms of the alkyl group is in a range of 1 to 5, preferably in a range of 1 to 3, and more preferably 1. The alkyl group may have a linear, branched, or cyclic structure.

Specific examples of the repeating unit B1 are shown below, but the repeating unit B1 is not limited to the following structures.

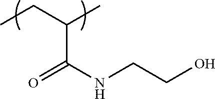

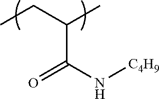

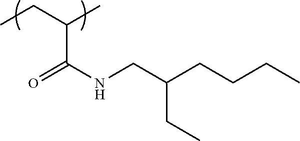

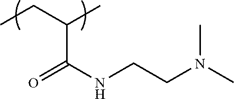

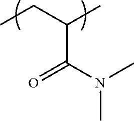

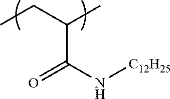

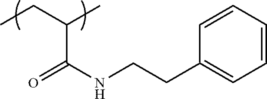

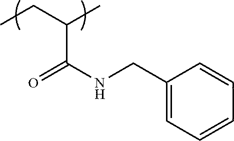

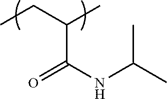

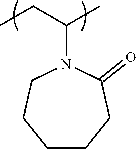

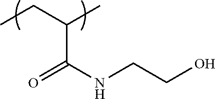

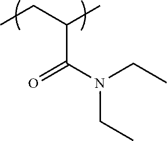

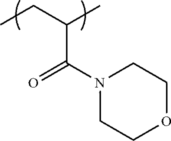

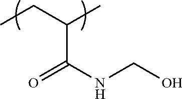

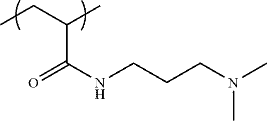

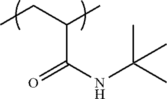

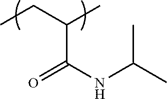

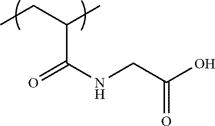

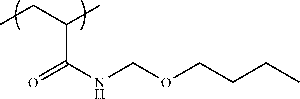

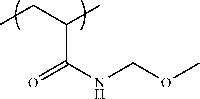

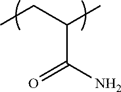

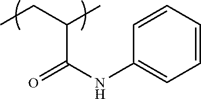

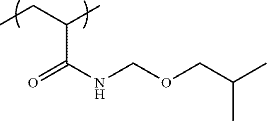

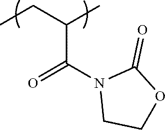

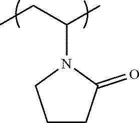

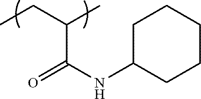

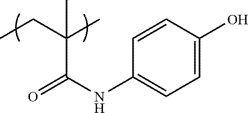

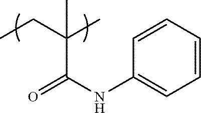

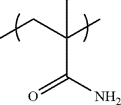

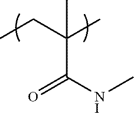

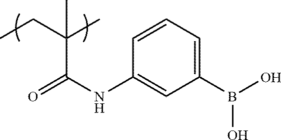

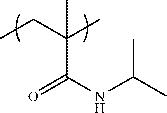

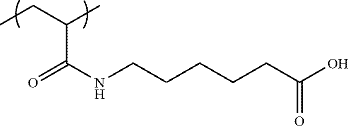

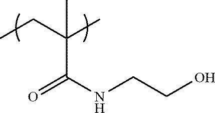

The content of the repeating unit B1 is preferably in a range of 3% to 75% by mass, more preferably in a range of 15% to 70% by mass, and still more preferably in a range of 20% to 65% by mass with respect to all repeating units (100% by mass) of the specific interface improver. In a case where the content of the repeating unit B1 is in the above-described ranges, the effects of the present invention are more excellent.

The specific interface improver may have only one or two or more kinds of the repeating units B1. In a case where the specific interface improver has two or more kinds of repeating units B1, the content of the repeating unit B1 denotes the total content of the repeating units B1.

### Repeating Unit B2

The repeating unit B2 is a repeating unit having a fluorine atom.

From the viewpoint that the effects of the present invention are more excellent, it is preferable that the repeating unit B2 includes at least one of a repeating unit represented by Formula (F-1) (hereinafter, also referred to as “repeating unit F-1”) or a repeating unit represented by Formula (F-2) (hereinafter, also referred to as “repeating unit F-2”).

The content of the repeating unit B2 is preferably in a range of 30% to 97% by mass, more preferably in a range of 35% to 90% by mass, and still more preferably in a range of 35% to 80% by mass with respect to all repeating units (100% by mass) of the specific interface improver. In a case where the content of the repeating unit B2 is in the above-described ranges, the effects of the present invention are more excellent.

The specific interface improver may have only one or two or more kinds of the repeating units B2. In a case where the specific interface improver has two or more kinds of repeating units B2, the content of the repeating unit B2 denotes the total content of the repeating units B2.

### Repeating Unit F-1

The repeating unit F-1 is a repeating unit represented by Formula (F-1).

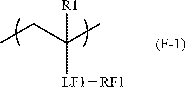

In Formula (F-1), LF1 represents a single bond or a divalent linking group, R1 represents a hydrogen atom, a fluorine atom, a chlorine atom, or an alkyl group having 1 to 20 carbon atoms, and RF1 represents a group containing at least one of groups (a) to (e), (a) a group represented by Formula (1), (2), or (3), (b) a perfluoropolyether group, (c) an alkyl group having 1 to 20 carbon atoms, which has a hydrogen bond between a proton-donating functional group and a proton-accepting functional group and in which at least one carbon atom has a fluorine atom as a substituent, (d) a group represented by Formula (1-d), and (e) a group represented by Formula (1-e).

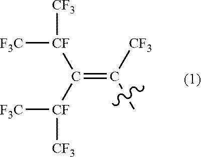

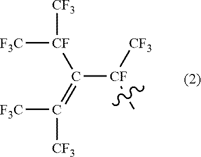

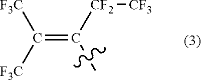

In Formula (F-1), R1 represents preferably a hydrogen atom, a fluorine atom, or an alkyl group having 1 to 4 carbon atoms and more preferably a hydrogen atom or a methyl group.

In Formula (F-1), LF1 represents a single bond or a divalent linking group, and more specific examples thereof include a group represented by —LW—SPW— in Formula (W1), an aromatic hydrocarbon group having 4 to 20 carbon atoms, a cyclic alkylene group having 4 to 20 carbon atoms, and a heterocyclic group having 1 to 20 carbon atoms, and it is preferable that LF1 represents a linear, branched, or cyclic alkylene group having 1 to 20 carbon atoms or an aromatic hydrocarbon group having 4 to 20 carbon atoms and that includes —O—, —C(O)—O—, —C(O)—NH—, and —O—C(O)—.

(a) Repeating unit containing group represented by Formula (1), (2), or (3)

In a case where RF1 of Formula (F-1) contains a group represented by Formula (1), (2), or (3), it is also preferable that Formula (F-1) represents a repeating unit represented by Formula (4). [

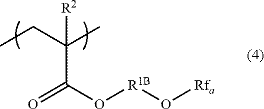

In Formula (4), Rfₐ represents a group represented by Formula (1), (2), or (3).

In Formula (4), R^{1B} represents a divalent group having 2 to 50 carbon atoms. The divalent group having 2 to 50 carbon atoms represented by R^{1B} may have a heteroatom and may be an aromatic group, a heteroaromatic group, a heterocyclic group, an aliphatic group, or an alicyclic group.

Specific examples of R^{1B} include the following groups.

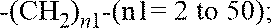

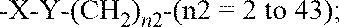

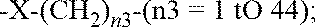

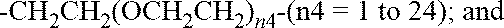

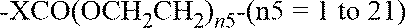

In the above-described formulae, X represents phenylene, biphenylene, or naphthylene which may have one to three substituents selected from the group consisting of an alkyl group having 1 to 3 carbon atoms (such as a methyl group, an ethyl group, or a propyl group), an alkoxy group having 1 to 4 carbon atoms (such as a methoxy group, an ethoxy group, a propoxy group, or a butoxy group), and a halogen atom (such as F, Cl, Br, or I). Y represents —O—CO—, —CO—O—, —CONH—, or —NHCO—.

X represents preferably 1,2-phenylene, 1,3-phenylene, or 1,4-phenylene and more preferably 1,4-phenylene.

Specific examples of a particularly preferable divalent group having 2 to 50 carbon atoms represented by R^{1B} include divalent groups having the following structures.

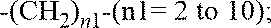

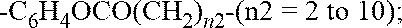

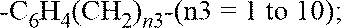

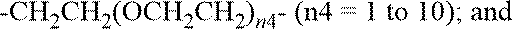

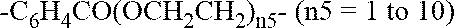

In Formula (4), R² represents a hydrogen atom or a methyl group.

(b) Repeating unit containing perfluoropolyether group

In Formula (F-1), it is also preferable that RF1 contains a perfluoropolyether group.

The perfluoropolyether group is a divalent group in which a plurality of fluorocarbon groups are bonded to each other via an ether bond. It is preferable that the perfluoropolyether group is a divalent group in which a plurality of perfluoroalkylene groups are bonded to each other via an ether bond.

The perfluoropolyether group may be a linear structure, a branched structure, or a cyclic structure, and is preferably a linear structure or a branched structure and more preferably a linear structure.

In a case where RF1 of Formula (F-1) has a repeating unit containing a perfluoropolyether group, it is preferable that Formula (F-1) represents a constitutional unit represented by Formula (I-b).

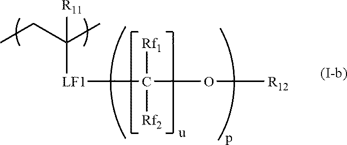

In Formula (I-b), LF1 represents the same group as in Formula (F-1). R₁₁ represents a hydrogen atom, a fluorine atom, a chlorine atom, or an alkyl group having 1 to 20 carbon atoms. Rf₁ and Rf₂ each independently represent a fluorine atom or a perfluoroalkyl group. In a case where a plurality of Rf₁′s are present, the plurality of Rf₁′s may be the same as or different from each other. In a case where a plurality of Rf₂′s are present, the plurality of Rf₂′s may be the same as or different from each other. u represents an integer of 1 or greater. p represents an integer of 1 or greater.

R₁₂ represents a hydrogen atom or a substituent, and the substituent is not particularly limited, and examples thereof include a fluorine atom, a perfluoroalkyl group (preferably having 1 to 10 carbon atoms), an alkyl group (preferably having 1 to 10 carbon atoms), and a hydroxyalkyl group (preferably having 1 to 10 carbon atoms).

In Formula (I-b), u represents an integer of 1 or greater, preferably 1 to 10, more preferably 1 to 6, and still more preferably 1 to 3.

In Formula (I-b), p represents an integer of 1 or greater, preferably represents 1 to 100, more preferably 1 to 80, and still more preferably 1 to 60.

Further, p number of [CRf₁Rf₂]uO’s may be the same as or different from each other.

• (c) Alkyl group having 1 to 20 carbon atoms, which has hydrogen bond between proton-donating functional group and proton-accepting functional group and in which at least one carbon atom has fluorine atom as substituent

In Formula (F-1), it is preferable that RF1 has an alkyl group having 1 to 20 carbon atoms, which has a hydrogen bond between a proton-donating functional group and a proton-accepting functional group and in which at least one carbon atom has a fluorine atom as a substituent (hereinafter, also referred to as “specific alkyl group c”).

In a case where RF1 in General Formula (F-1) represents the specific alkyl group c, it is preferable that the repeating unit represented by Formula (I) is a repeating unit represented by Formula (I-c1) or a repeating unit represented by Formula (I-c2).

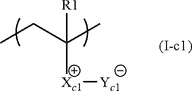

In General Formula (I-c1), R₁ has the same definition as that for R₁ in Formula (1), and it is preferable that R₁ represents a hydrogen atom or a methyl group.

In General Formula (I-c1), X_{C1}⁺ represents a group containing a proton-accepting functional group. Examples of the proton-accepting functional group include a quaternary ammonium cation and a pyridinium cation. Specific examples of X_{C1}⁺ include —C(O)—NH—L_{C1}—X_{C11}⁺, —C(O)—O—L_{C1}—X_{C11}⁺, and -X_{C12}⁺. L_{C1} represents an alkylene group having 1 to 5 carbon atoms. X_{C11}⁺ represents a quaternary ammonium cation. X_{C12}⁺ represents a pyridinium cation.

In General Formula (I-c1), Y_{C1}⁻ represents a proton-donating functional group or a group containing a fluoroalkyl group. Examples of the proton-donating functional group include —C(O)O⁻ and —S(O)₂O⁻. Specific examples of Y_{C1}⁻ include R_{C1}—C(O)O⁻ and R_{C1}—S(O)₂O⁻. R_{c1} represents a fluoroalkyl group having 2 to 15 carbon atoms, a group in which one or more carbon atoms of the fluoroalkyl group having 2 to 15 carbon atoms are substituted with at least one of —O— or C(O)—, or a phenyl group having these groups as substituents.

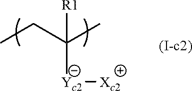

In General Formula (I-c2), R₁ has the same definition as that for R₁ in Formula (1), and it is preferable that R₁ represents a hydrogen atom or a methyl group.

In General Formula (I-c2), Y_{C2}⁻ represents a group containing a proton-donating functional group. Examples of the proton-donating functional group include —C(O)O⁻ and —S(O)₂O⁻. Specific examples of Y_{C2}⁻ include —C(O)—NH—L_{C2}—Y_{C21}⁻ and —C(O)—O—L_{C2}—Y_{C2}⁻. L_{C2} represents an alkylene group having 1 to 5 carbon atoms. Y_{C21}⁻ represents —C(O)O⁻ or S(O)₂O₋.

In General Formula (I-c2), X_{C2}⁺ represents a proton-accepting functional group (such as a quaternary ammonium cation or a pyridinium cation) or a group containing a fluoroalkyl group. Specific examples of X_{C2}⁺ include R_{C2}—X_{C21}⁺. R_{C2} represents a fluoroalkyl group having 2 to 15 carbon atoms, a group in which one or more carbon atoms of the fluoroalkyl group having 2 to 15 carbon atoms are substituted with at least one of —O— or C(O)—, or a phenyl group having these groups as substituents. X_{C21}⁺ represents a quaternary ammonium cation.

Examples of a method of producing a repeating unit in which RF1 in General Formula (F-1) represents the specific alkyl group c include a method of allowing a compound containing a proton-donating functional group described below to react with a repeating unit containing a proton-accepting functional group and a method of allowing a compound containing a proton-accepting functional group described below to react with a repeating unit containing a proton-donating functional group.

It is preferable that the compound containing a proton-donating functional group and the compound containing a proton-accepting functional group are compounds represented by any of Formulae (1-1) to (1~3).

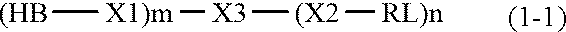

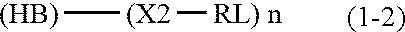

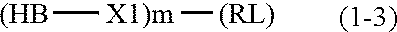

In Formulae (1-1) and (1-3), m represents an integer of 1 to 5. Further, in Formulae (1-1) and (1-2), n represents an integer of 1 to 5. Here, the sum of m and n is an integer of 2 to 6.

Further, in Formulae (1-1) to (1-3), HB represents the above-described functional group capable of hydrogen bonding (that is, a proton-donating functional group and a proton-accepting functional group), and in a case where m represents an integer of 2 to 5, a plurality of HB’s may be the same as or different from each other.

Examples of the proton-donating functional group include a carboxy group and a sulfonic acid group.

Examples of the proton-accepting functional group include a group having a nitrogen atom.

In Formulae (1-1) to (1-3), X1 and X2 each independently represent a single bond or a divalent linking group, a plurality of X1′s may be the same as or different from each other in a case where m represents an integer of 2 to 5, and a plurality of X2′s may be the same as or different from each other in a case where n represents an integer of 2 to 5. In Formula (1-2), a part of HB and X2 may form a ring. Further, in Formula (1-3), a part of RL and X1 may form a ring.

Examples of the divalent linking group represented by one aspect of X1 and X2 in Formulae (1-1) to (1-3) include at least one or more groups selected from the group consisting of a linear, branched, or cyclic alkylene group having 1 to 10 carbon atoms which may have a substituent, an arylene group having 6 to 12 carbon atoms which may have a substituent, an ether group (—O—), a carbonyl group (—C(═O)—), and an imino group (—NH—) which may have a substituent.

Here, examples of the substituent that the alkylene group, the arylene group, and the imino group may have include an alkyl group, an alkoxy group, a halogen atom, and a hydroxyl group. As the alkyl group, for example, a linear, branched, or cyclic alkyl group having 1 to 18 carbon atoms is preferable, an alkyl group having 1 to 8 carbon atoms (such as a methyl group, an ethyl group, a propyl group, an isopropyl group, an n-butyl group, an isobutyl group, a sec-butyl group, a t-butyl group, or a cyclohexyl group) is more preferable, an alkyl group having 1 to 4 carbon atoms is still more preferable, and a methyl group or an ethyl group is particularly preferable. As the alkoxy group, for example, an alkoxy group having 1 to 18 carbon atoms is preferable, an alkoxy group having 1 to 8 carbon atoms (such as a methoxy group, an ethoxy group, an n-butoxy group, or a methoxyethoxy group) is more preferable, an alkoxy group having 1 to 4 carbon atoms is still more preferable, and a methoxy group or an ethoxy group is particularly preferable. Examples of the halogen atom include a fluorine atom, a chlorine atom, a bromine atom, and an iodine atom. Among these, a fluorine atom and a chlorine atom are preferable.

In regard to the linear, branched, or cyclic alkylene group having 1 to 10 carbon atoms, specific examples of the linear alkylene group include a methylene group, an ethylene group, a propylene group, a butylene group, a pentylene group, a hexylene group, and a decylene group. Further, specific examples of the branched alkylene group include a dimethylmethylene group, a methylethylene group, a 2,2-dimethylpropylene group, and a 2-ethyl-2-methylpropylene group. Further, specific examples of the cyclic alkylene group include a cyclopropylene group, a cyclobutylene group, a cyclopentylene group, a cyclohexylene group, a cyclooctylene group, a cyclodecylene group, an adamantane-diyl group, a norbornane-diyl group, and an exo-tetrahydrodicyclopentadiene-diyl group.

Specific examples of the arylene group having 6 to 12 carbon atoms include a phenylene group, a xylylene group, a biphenylene group, a naphthylene group, and a 2,2′-methylenebisphenyl group. Among these, a phenylene group is preferable.

Further, in Formula (1-1), X3 represents a single bond or a divalent to hexavalent linking group. Here, examples of the divalent linking group represented by one aspect of X3 include those described as the divalent linking group represented by one aspect of X1 and X2 in Formulae (1-1) to (1-3). In addition, examples of the trivalent to hexavalent linking group represented by one aspect of X3 include structures obtained by removing three to six hydrogen atoms bonded to carbon atoms forming a ring in ring structures, for example, a cycloalkylene ring such as a cyclohexane ring or a cyclohexene ring, an aromatic hydrocarbon ring such as a benzene ring, a naphthalene ring, an anthracene ring, or a phenanthroline ring, and an aromatic heterocyclic ring such as a furan ring, a pyrrole ring, a thiophene ring, a pyridine ring, a thiazole ring, or a benzothiazole ring. Among these ring structures, a benzene ring (such as a benzene-1,2,4-yl group) is preferable.

In Formulae (1-1) to (1-3), RL represents a substituent having a fluorine atom or an alkyl group having 6 or more carbon atoms, and in a case where n represents an integer of 2 to 5, a plurality of RL’s may be the same as or different from each other. Here, examples of the monovalent substituent having a fluorine atom include an alkyl group having 1 to 20 carbon atoms or an alkenyl group having 2 to 20 carbon atoms in which at least one carbon atom has a fluorine atom as a substituent.

Among the compounds represented by any of Formulae (1-1) to (1-3), specific examples of the compound containing a proton-donating functional group include a compound represented by the following formulae.

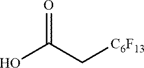

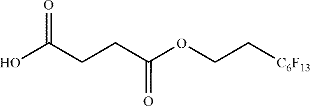

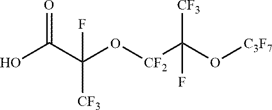

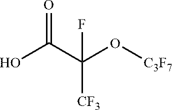

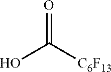

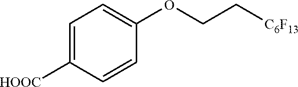

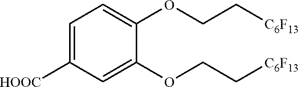

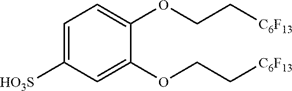

Among the compounds represented by any of Formulae (1-1) to (1-3), specific examples of the compound containing a proton-accepting functional group include compounds represented by the following formulae.

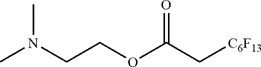

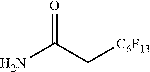

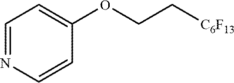

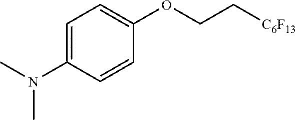

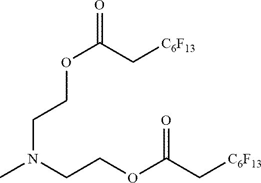

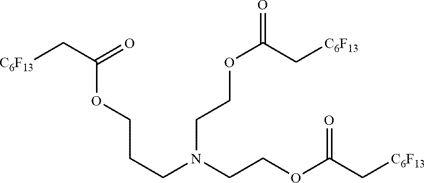

(d) Group represented by Formula (1-d)

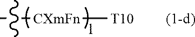

In Formula (1-d), X represents a hydrogen atom or a substituent (preferably, a group represented by “SP-H”), T10 represents a terminal group (preferably the same group as T1 described above), 1 represents an integer of 1 to 20, m represents an integer of 0 to 2, n represents an integer of 1 to 2, and m + n is 2.

In a case where 1 represents 2 or greater, a plurality of —(CXmFn)—′s may be the same as or different from each other.

X represents preferably a hydrogen atom, a halogen atom, an alkyl group having 1 to 10 carbon atoms, an alkoxy group having 1 to 10 carbon atoms, a cyano group, a nitro group, —OZ^{H}, —C(O)Z^{H}, —C(O)OZ^{H}, —OC(O)Z^{H}, —NZ^{H}Z^{H}′, —NZ^{H}C(O)Z^{H}′, —NZ^{H}C(O)OZ^{H}′, —C(O)NZ^{H}Z^{H}′, or —OC(O)NZ^{H}Z^{H}′ and more preferably a hydrogen atom, a fluorine atom, —Z^{H}, or —OZ^{H}. Z^{H} and Z^{H}′ each independently represent a hydrogen atom, a halogen atom, an alkyl group having 1 to 10 carbon atoms, an alkoxy group having 1 to 10 carbon atoms, a cyano group, or a nitro group, and the number of carbon atoms thereof is preferably in a range of 1 to 4.

T10 represents preferably a hydrogen atom, a halogen atom, an alkyl group having 1 to 10 carbon atoms, a cyano group, a nitro group, —OZ^{H}, —C(O)Z^{H}, —C(O)OZ^{H}, —OC(O)Z^{H}, or a crosslinkable group represented by any of Formulae (P-1) to (P-30) and more preferably a hydrogen atom, a fluorine atom, an alkyl group having 1 to 10 carbon atoms, a cyano group, a nitro group, —OZ^{H}, a vinyl group, a (meth)acryl group, a (meth)acrylamide group, a styryl group, a vinyl ether group, an epoxy group, or an oxetanyl group. Z^{H} represents a hydrogen atom, a halogen atom, an alkyl group having 1 to 10 carbon atoms, an alkoxy group having 1 to 10 carbon atoms, a cyano group, or a nitro group, and the number of carbon atoms is preferably in a range of 1 to 4.

· (e) Group represented by Formula (1-e)

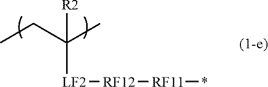

In Formula (1-e), R2 represents a hydrogen atom, a fluorine atom, a chlorine atom, or an alkyl group having 1 to 20 carbon atoms, LF2 represents a single bond or a divalent linking group, RF11 and RF12 each independently represent a perfluoropolyether group, and * represents a bonding position with respect to LF1 in Formula (F-1).

Suitable aspects of R2 and LF2 are respectively the same as those of R1 and LF1 of Formula (F-1).

Suitable aspects of RF11 and RF12 are the same as those of RF1 of Formula (F-1).

Specific examples of the monomer forming the repeating unit represented by Formula (F-1) include structures represented by Formulae (F1-1) to (F1-41), and the present invention is not limited thereto.

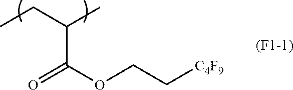

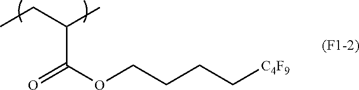

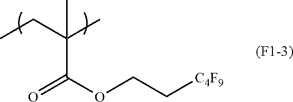

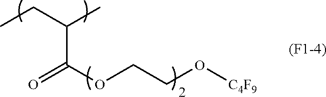

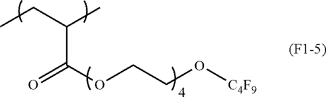

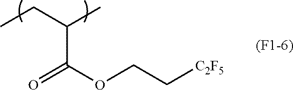

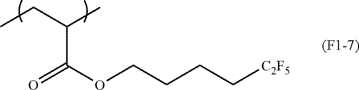

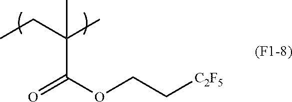

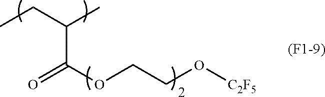

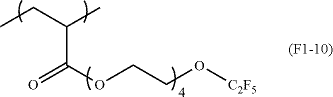

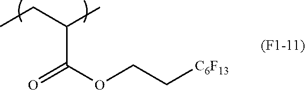

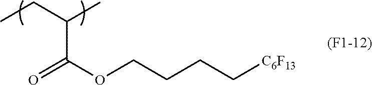

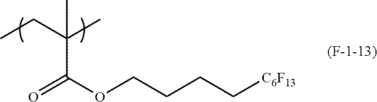

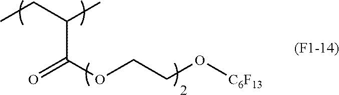

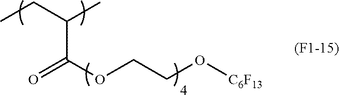

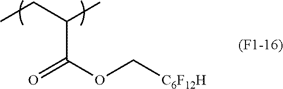

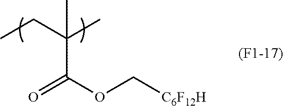

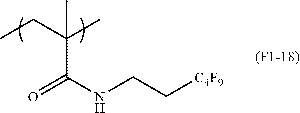

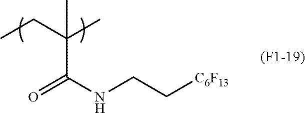

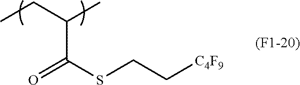

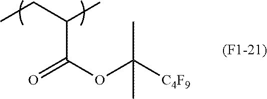

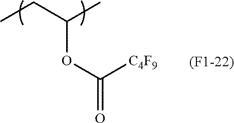

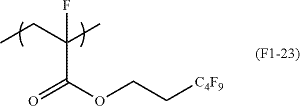

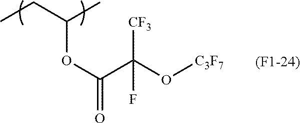

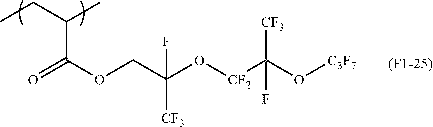

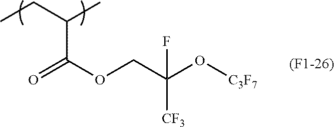

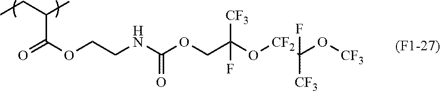

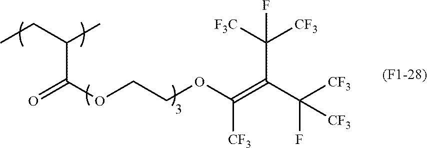

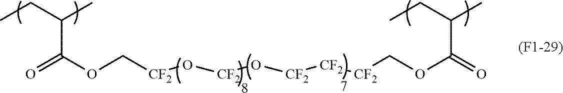

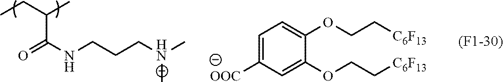

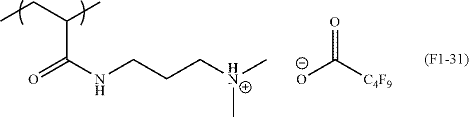

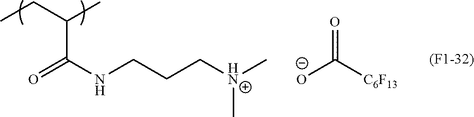

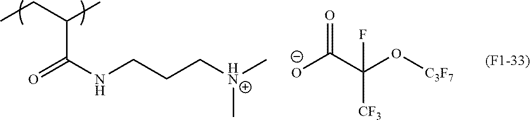

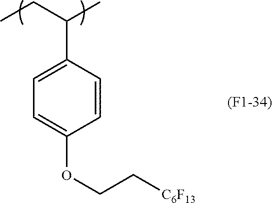

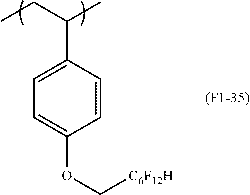

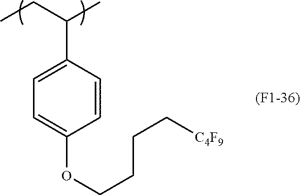

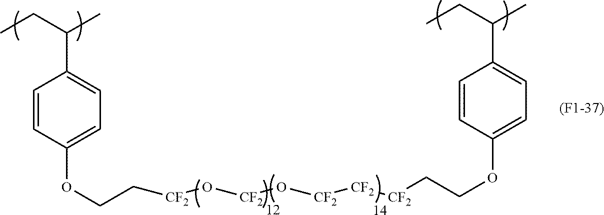

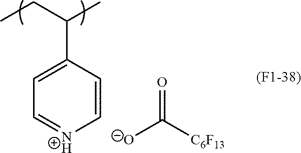

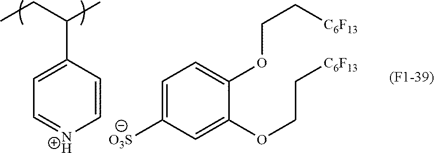

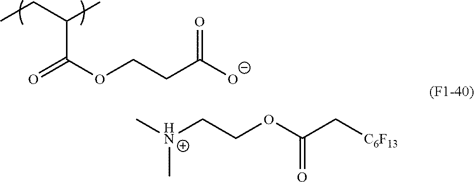

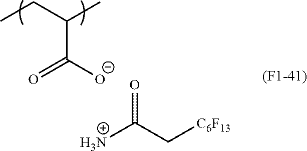

The content of the repeating unit F-1 is preferably in a range of 10% to 98% by mass, more preferably in a range of 15% to 90% by mass, and still more preferably in a range of 20% to 85% by mass with respect to all the repeating units (100% by mass) of the specific interface improver. In a case where the content of the repeating unit F-1 is in the above-described ranges, the effects of the present invention are more excellent.

The specific interface improver may have only one or two or more kinds of repeating units F-1. In a case where the specific interface improver has two or more kinds of repeating units F-1, the content of the repeating unit F-1 denotes the total content of the repeating units F-1.

### Repeating Unit F-2

The repeating unit F-2 is a repeating unit represented by Formula (F-2).

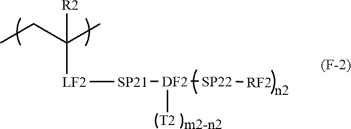

In Formula (F-2), R2 represents a hydrogen atom, a fluorine atom, a chlorine atom, or an alkyl group having 1 to 4 carbon atoms, and LF2 represents the same group as LF1 in Formula (F-1).

SP21 and SP22 each independently represent a spacer group, DF2 represents an (m2 + 1)-valent group, T2 represents a terminal group, RF2 represents a group having a fluorine atom, n2 represents an integer of 2 or greater, m2 represents an integer of 2 or greater, and m2 is greater than or equal to n2.

A plurality of -SP22-RF2′s may be the same as or different from each other. In a case where a plurality of T2′s are present, the plurality of T2′s may be the same as or different from each other.

In Formula (F-2), R2 represents a hydrogen atom, a fluorine atom, a chlorine atom, or an alkyl group having 1 to 4 carbon atoms and preferably a hydrogen atom or a methyl group.

In Formula (F-2), DF2 represents an (m2 + 1) -valent group, and specific examples thereof include a tertiary carbon atom (-C(H)<), a quaternary carbon atom (>C<), a nitrogen atom, a phosphoric acid ester group (P(═O)(—O—)₃), a branched alkylene group having 2 to 20 carbon atoms, an aromatic ring having 4 to 15 carbon atoms, an aliphatic ring having 4 to 15 carbon atoms, and a heterocyclic ring.

The carbon atom in the branched alkylene group, the aromatic ring, and the aliphatic ring may be substituted with “SP-C″ described above.

The hydrogen atom in the branched alkylene group, the aromatic ring, and the aliphatic ring may be substituted with “SP-H″ described above.

It is preferable that DF2 represents a carbon atom (such as a tertiary carbon atom or a quaternary carbon atom), a nitrogen atom, a benzene ring, a cyclohexane ring, or a cyclopentane ring.

SP21 and SP22 each independently represent a spacer group, and examples thereof include SPW in Formula (W1).

It is preferable that SP21 and SP22 represent a single bond or a linear, branched, or cyclic alkylene group having 1 to 10 carbon atoms. Here, the carbon atom of the alkylene group may be substituted with —O—, —S—, —N(Z)—, —C(Z)═C(Z′)—, —C(O)—, —C(S). -, —OC(O)—, —OC(S)—, —SC(O)—, —C(O)O—, —C(S)O—, —C(O)S—, —O—C(O)O—, —N(Z)C(O)—, or —C(O)N(Z)—, (Z and Z′ each independently represent a hydrogen atom, an alkyl group having 1 to 4 carbon atoms, a cycloalkyl group, an aryl group, a cyano group, or a halogen atom). Further, the hydrogen atom of the alkylene group may be substituted with a fluorine atom or a fluoroalkyl group.

T2 represents preferably a hydrogen atom, a halogen atom, —OH, —COOH, an alkyl group having 1 to 10 carbon atoms, a cyano group, a nitro group, —OZ^{H}, —C(O)Z^{H}, —C(O)OZ^{H}, —OC(O)Z^{H}, or a crosslinkable group represented by any of Formulae (P-1) to (P-30) and more preferably a hydrogen atom, a fluorine atom, —OH, —COOH, —Z^{H}, —OZ^{H}, a vinyl group, a (meth)acryl group, a (meth)acrylamide group, a styryl group, a vinyl ether group, an epoxy group, or an oxetanyl group. Z^{H} represents a hydrogen atom, a halogen atom, an alkyl group having 1 to 10 carbon atoms, an alkoxy group having 1 to 10 carbon atoms, a cyano group, or a nitro group, and the number of carbon atoms is preferably in a range of 1 to 4.

RF2 represents a group having a fluorine atom and preferably a fluorine atom, RF1 in Formula (F-1), or a group having a fluorine atom as T2.

In Formula (F-2), m2 represents preferably 2 to 8 and more preferably 2 to 6. n2 represents preferably 2 to 4 and more preferably 2 or 3.

The repeating unit represented by Formula (F-2) may be of a cleavage type in which RF2 is cleaved by an acid or a base and released from a polymer side chain. As a result, the coating properties of the upper layer are improved.

Examples of the repeating unit represented by Formula (F-2) include repeating units represented by Formulae (F2-1) to (F2-39), and the present invention is not limited thereto.

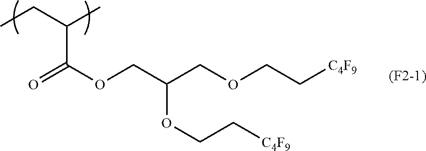

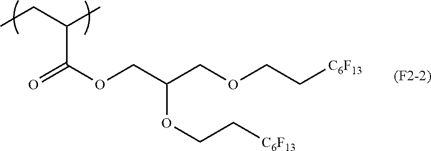

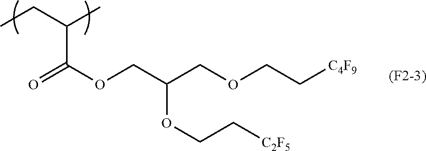

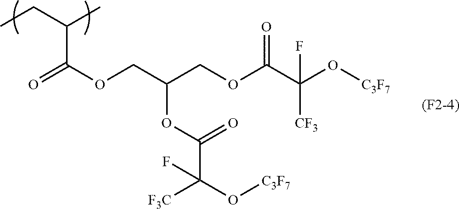

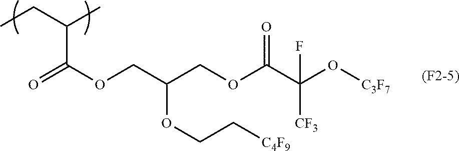

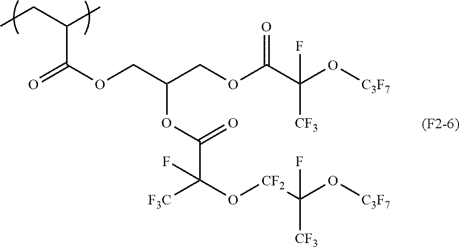

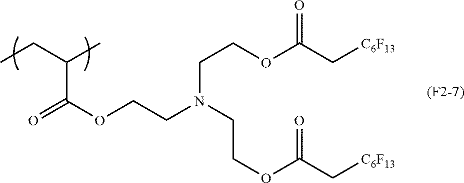

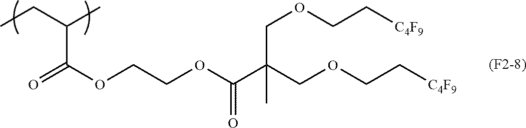

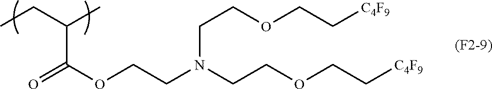

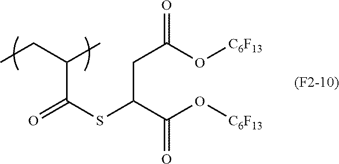

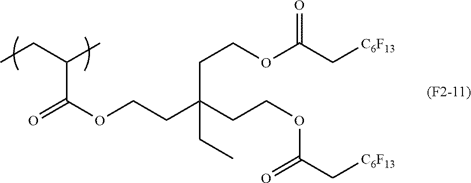

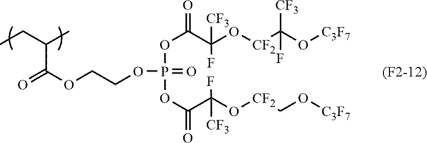

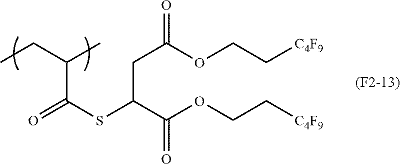

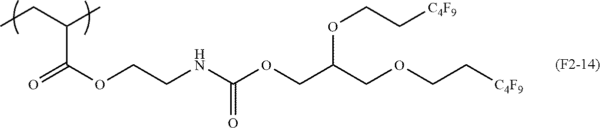

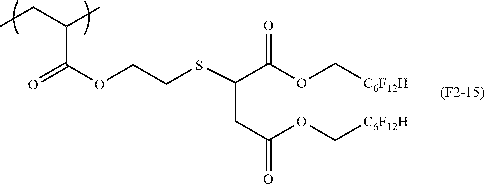

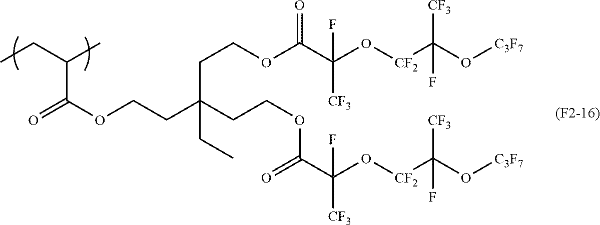

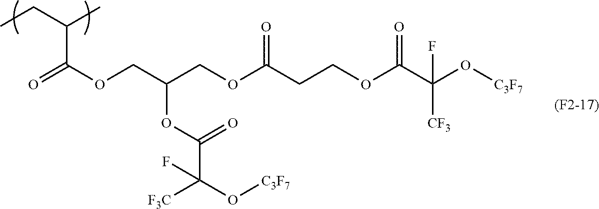

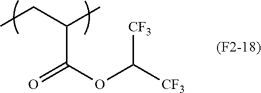

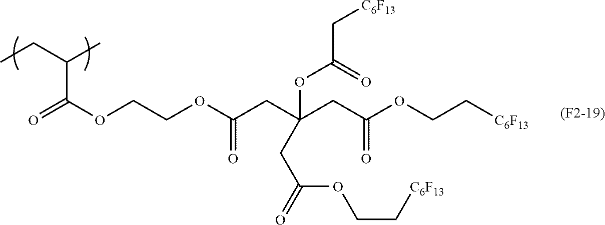

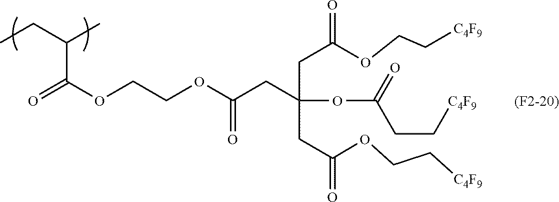

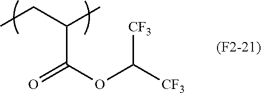

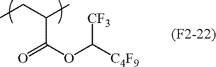

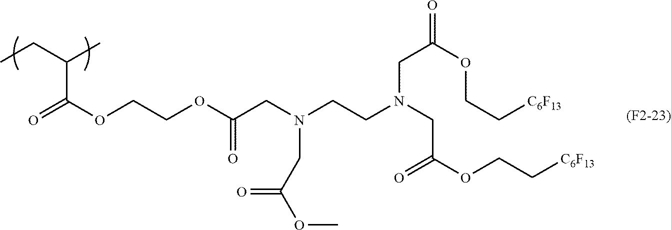

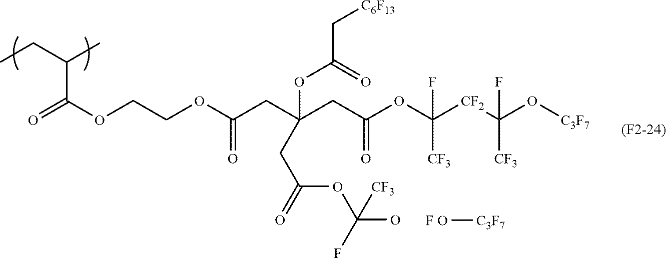

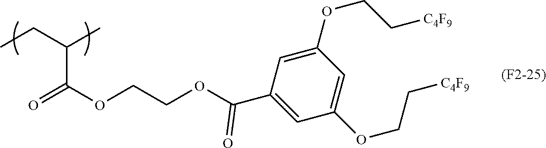

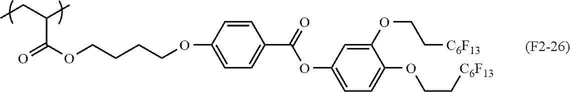

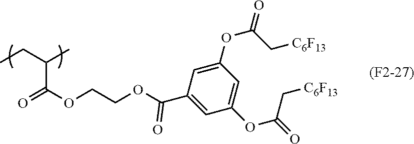

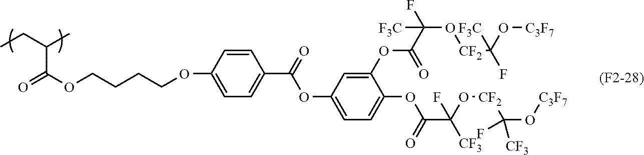

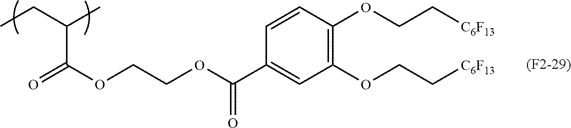

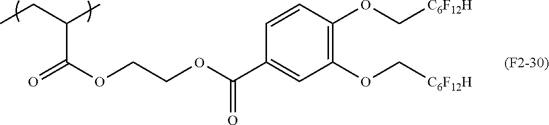

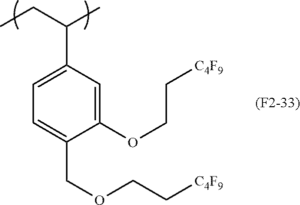

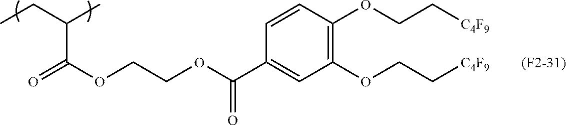

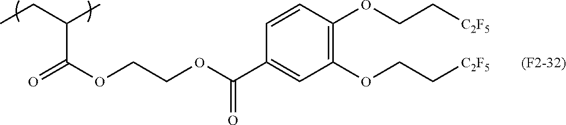

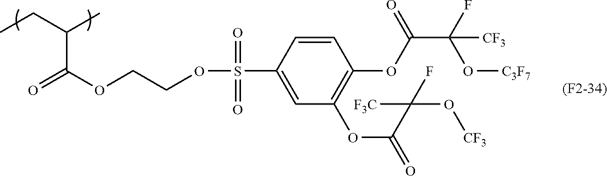

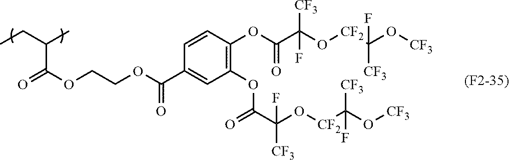

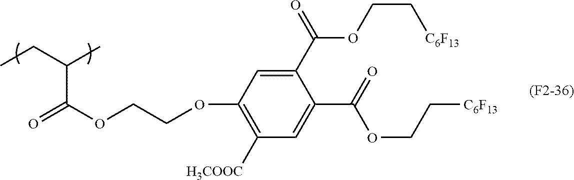

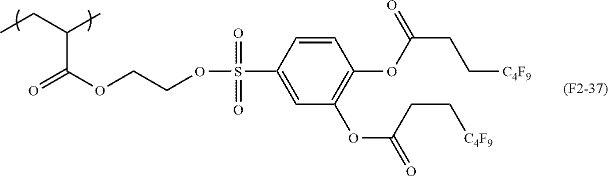

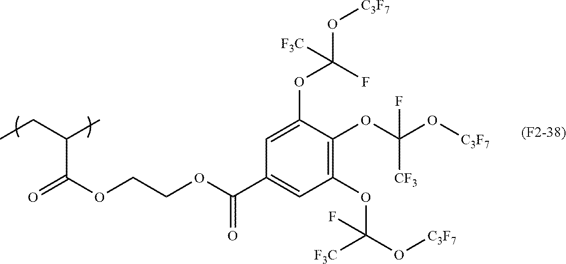

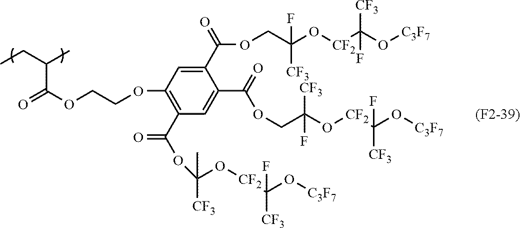

The content of the repeating unit F-2 is preferably in a range of 5% to 95% by mass, more preferably in a range of 7% to 90% by mass, and still more preferably in a range of 10% to 85% by mass with respect to all the repeating units (100% by mass) of the specific interface improver. In a case where the content of the repeating unit F-2 is in the above-described ranges, the effects of the present invention are more excellent.

The specific interface improver may have only one or two or more kinds of repeating units F-2. In a case where the specific interface improver has two or more kinds of repeating units F-2, the content of the repeating unit F-2 denotes the total content of the repeating units F-2.

The specific interface improver may be a polymer having a block structure, a graft structure, a branched structure, or a star structure. It is preferable that the specific interface improver has a block structure, a graft structure, a branched structure, or a star structure from the viewpoint that a group of fluorine atoms is present as an aggregate and the transferability of the polymer to a surface of a coating film is improved.

Further, in a copolymer having a random structure with a fluorine-substituted alkyl chain length of 1 to 4, the size of the aggregate of the group of fluorine atoms is small and the solubility in a general-purpose solvent is excellent, but the transferability to a surface of a coating film is degraded. Meanwhile, the transferability to a surface of a coating film is increased even in a case where the fluorine-substituted alkyl chain length is in a range of 1 to 4 due to the presence of a group of fluorine atoms in the form of an aggregate, the surface tension of the coating film is decreased by adding such a polymer to the composition, and thus the wettability (homogeneous coating properties) of the composition with respect to the base material during the application and the surface state of the surface of the coating film are enhanced, which is preferable.

It is preferable that the specific interface improver has a primary structure described below.

The primary structure is a graft structure, a branched structure, or a star structure in a case where one kind of repeating unit forming the specific interface improver is present, and the primary structure is a block structure, a graft structure, a branched structure, or a star structure in a case where two or more kinds of primary structures are present.

The specific interface improver may have one or two or more kinds of the primary structures.

First, the primary structure that the specific interface improver may have will be described with reference to the schematic diagrams, but the present invention is not limited to such primary structures. In the following description, a polymer (copolymer) consisting of one to four kinds of repeating units A to D will be described as an example in order to facilitate understanding, but, in the present invention, the number of kinds of repeating units is not limited to 1 to 4 as described below. Further, the repeating units A, B, C, and D in the drawings can be substituted with different structures (repeating units).

In the present invention, in each partial structure forming the specific interface improver (fluorine-containing polymer), “main chain direction” denotes the bonding direction of a repeating unit forming the partial structure.

Further, in the present invention, the concept of “consisting of repeating units” includes an aspect of a polymer consisting of a specific repeating unit and one or more other kinds of repeating units different from the specific repeating unit in addition to an aspect of a polymer consisting of only a specific repeating unit. The other kinds of repeating units are not particularly limited, and examples thereof include a repeating unit derived from a compound containing a polymerizable group and a repeating unit consisting of two or more kinds of constituent components described below, in order to introduce a graft chain.

### Block Structure

The block structure denotes a structure in which the main chain direction of partial structures consisting of a single kind of repeating unit is a single linear direction in a polymer chain. The block structure consists of two or more kinds of repeating units.

In the present invention, in a case where one repeating unit consists of two or more kinds of constituent components, the partial structure consisting of a single kind of repeating unit includes a partial structure in which repeating units having the same constituent component are bonded to each other and a partial structure which has repeating units in which at least one constituent component is different from other constituent components.

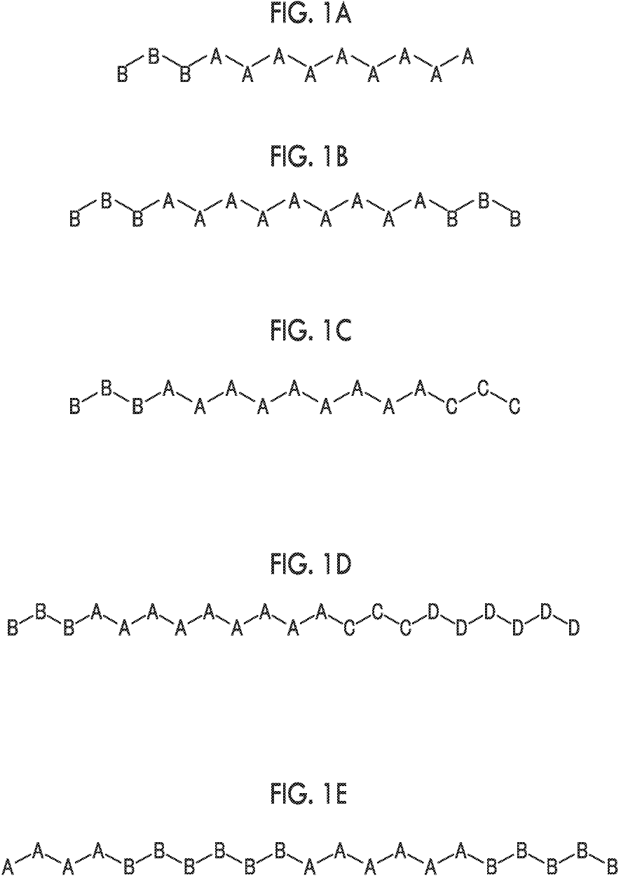

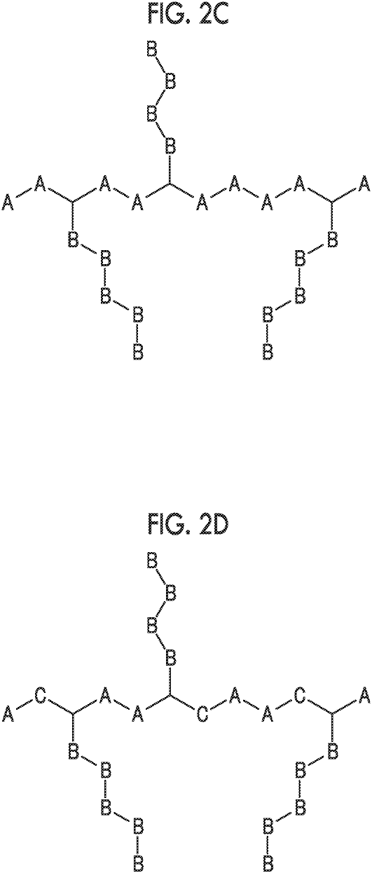

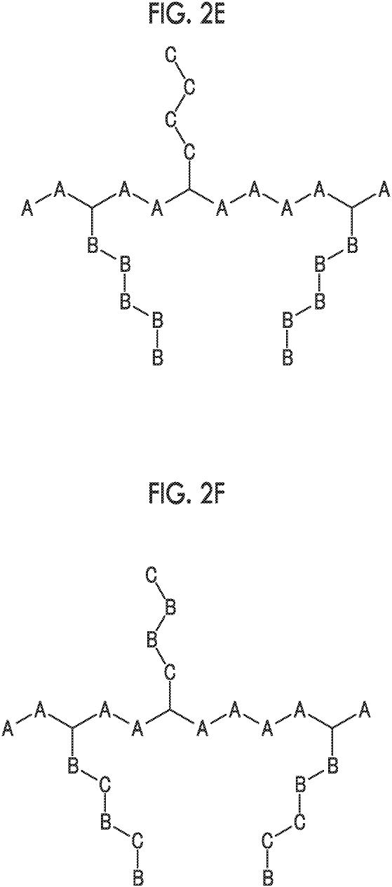

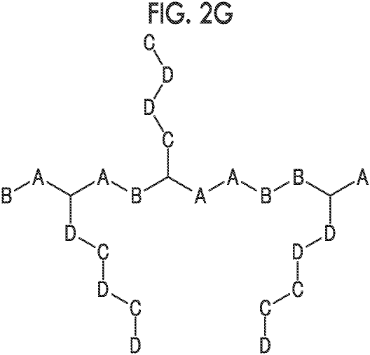

The block structure that the specific interface improver may have is not particularly limited as long as the block structure is as described above, and examples thereof include structures shown in FIGS. 1A to 1E (also collectively referred to as FIG. 1). In FIG. 1, A to D represent repeating units different from each other (the same applies to FIGS. 2 to 5).

The block structure shown in FIG. 1A is a block structure (A-B type) in which a partial structure consisting of the repeating unit A and a partial structure consisting of the repeating unit B are bonded in a single linear direction in a polymer chain. The block structure shown in FIG. 1B is a block structure (B-A-B type) in which partial structures consisting of the repeating unit B are bonded to both end portions of a partial structure consisting of the repeating unit A in a single linear direction in a polymer chain. The block structure shown in FIG. 1C is a block structure in which a partial structure consisting of the repeating unit B, a partial structure consisting of the repeating unit A, and a partial structure consisting of the repeating unit C as a third component are sequentially bonded in a single linear direction in a polymer chain. The block structure shown in FIG. 1D is a block structure in which a partial structure consisting of the repeating unit D as a fourth component is bonded to a partial structure consisting of the repeating unit C of the block structure shown in FIG. 1C in a single linear direction in a polymer chain. The block structure shown in FIG. 1E is a block structure in which a partial structure consisting of the repeating unit A and a partial structure consisting of the repeating unit B are alternately repeated (bonded) twice in a single linear direction in a polymer chain.

A polymer having the block structure can be obtained by a typical method of polymerizing a block copolymer. Examples thereof include a living radical polymerization method, a living cationic polymerization method, and a living anionic polymerization method. As an example of the living radical polymerization method, the living cationic polymerization method, or the living anionic polymerization method, “Controlled Radical Polymerization Guide (Aldrich)” (URL:http://www.sigmaaldrich.com/japan/materialscience/polymer-science/crp-guide.html), and “Polymer Synthesis (first volume)- Radical Polymerization/Cationic Polymerization/Anionic Polymerization” edited by Tsuyoshi Endo, Mitsuo Sawamoto et al., Kodansha, 2010, p. 60, pp. 105 to 108, pp. 249 to 259, and pp. 381 to 386 can be referred to.

The polymer having a block structure shown in FIG. 1B can also be synthesized, for example, by sequentially reacting monomers serving as respective repeating units to extend the repeating units starting from the terminal structure (repeating unit B) using the atomic transfer radical polymerization (ATRP) method in the living radical polymerization method as described below.

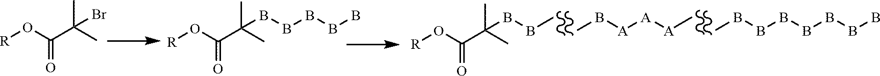

R represents a terminal group and has the same definition as that for a terminal group having a terminal structure described below.

In addition, the polymer having a block structure shown in FIG. 1B can be synthesized, for example, by using a bromo compound or the like as a chain transfer agent and using the chain transfer agent as a center point as described below to extend the repeating units on both sides thereof. In this case, as described below, a residue of the chain transfer agent is present between two partial structures consisting of the repeating unit A.

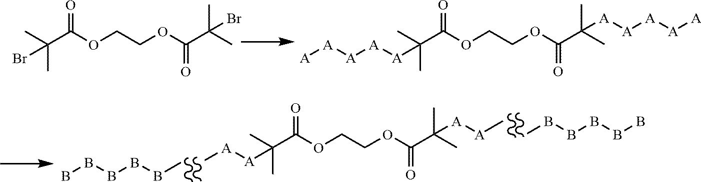

### Graft Structure

The graft structure denotes a structure that satisfies all the following conditions (G-1) to (G-3).

(G A structure in which one or more polymers PB^{G1} (also referred to as a branch polymer) consisting of one or two or more kinds of repeating units are bonded to another polymer PA^{G1} (also referred to as a stem polymer) consisting of one or two or more kinds of repeating units.

(G In a polymer chain, the main chain direction of the polymer PB^{G1} is different from the main chain direction of the polymer PA^{G1}.

(G A polymer PB^{G2} having a main chain direction different from the main chain direction of the polymer PB^{G1} is not bonded to the polymer PB^{G1}.

In the graft structure, the polymer PA^{G1} and the polymer PB^{G1} may be the same as or different from each other, and even in a case where a plurality of polymers PB^{G1}′s are present, the plurality of the polymers PB^{G1}′s may be the same as or different from each other. In addition, the bonding mode (structure) of the repeating unit that forms the polymer PA^{G1} and the polymer PB^{G1} is not particularly limited as long as the repeating unit is bonded in a single linear direction in each polymer, and the structure may be a block structure or a random structure.

Further, the number of polymers PB^{G1} bonded to the polymer PA^{G1} may be 1 or greater and is appropriately determined according to the characteristics and the like of the fluorine polymer. For example, the number thereof can be set to 1 or greater and 200 or less. The number thereof is preferably 100 or less and more preferably 50 or less.

The graft structure of the fluorine polymer of the present invention is not particularly limited as long as the graft structure is as described above, and examples thereof include the structures shown in FIGS. 2A to 2G (also collectively referred to as FIG. 2).

The graft structure shown in FIG. 2A is a graft structure in which three polymers PB^{G1} (branch polymers) consisting of the repeating unit A are bonded to the polymer PA^{G1} (stem polymer) consisting of the repeating unit A. The graft structure shown in FIG. 2B is a graft structure in which six polymers PB^{G1} (branch polymers) consisting of the repeating unit A are bonded to the polymer PA^{G1} (stem polymer) consisting of the repeating unit A. The graft structure shown in FIG. 2C is a graft structure in which three polymers PB^{G1} (branch polymers) consisting of the repeating unit B are bonded to the polymer PA^{G1} (stem polymer) consisting of the repeating unit A.

The graft structure shown in FIGS. 2D to 2G are graft structures further having a repeating unit C as a third component and a repeating unit D as a fourth component.

That is, the graft structure shown in FIG. 2D is a graft structure in which three polymers PB^{G1} (branch polymers) consisting of the repeating unit B are bonded to the polymer PA^{G1} (stem polymer) having a random structure consisting of the repeating unit A and the repeating unit C. The graft structure shown in FIG. 2E is a graft structure in which two polymers PB^{G1-B} consisting of the repeating unit B and one polymer PB^{G1-C} consisting of the repeating unit C are bonded to the polymer PA^{G1} (stem polymer) consisting of the repeating unit A. The graft structure shown in FIG. 2F is a graft structure in which three polymers PB^{G1-BC} having a block structure (including an alternating copolymer structure) consisting of the repeating unit B and the repeating unit C are bonded to the polymer PA^{G1} (stem polymer) consisting of the repeating unit A. The graft structure shown in FIG. 2G is a graft structure in which three polymers PB^{G1-CD} having a block structure (including an alternating copolymer structure) consisting of the repeating unit C and the repeating unit D are bonded to a polymer PA^{G1-AB} (stem polymer) having a random structure consisting of the repeating unit A and the repeating unit B.

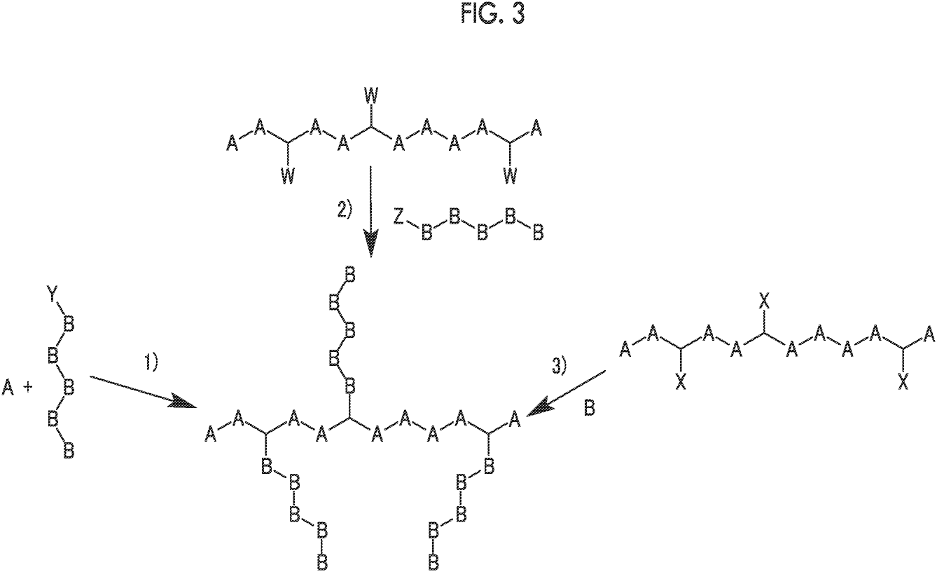

A polymer having the graft structure can be obtained by a typical method of polymerizing a graft copolymer. Examples of such a method include a grafting through method (synthesis method 1 shown in FIG. 3) of homopolymerizing a macromonomer (Y-B-B-B-B-B-B) containing a polymerizable functional group (Y) at a terminal or copolymerizing the macromonomer and a monomer (B) which is the same as the macromonomer or a monomer (A) which is different from the macromonomer, a grafting to method (synthesis method 2 shown in FIG. 3) of bonding a reactive group of a terminal functional polymer (Z-B-B-B-B-B) to another polymer chain, and a grafting from method (synthesis method 3 shown in FIG. 3) of reacting a polymer having a polymerization starting point (X) in a side chain with a monomer (B) to generate a polymer chain having the repeating unit B. For the details, as an example, “Polymer Synthesis (first volume)- Radical Polymerization/Cationic Polymerization/Anionic Polymerization” edited by Tsuyoshi Endo, Mitsuo Sawamoto et al., Kodansha, 2010, p. 60, pp. 108 to 110, and pp. 387 to 393 can be referred to.

In FIG. 3, X and Y represent a polymerization reactive group, and W and Z represent a reactive group. Here, the reactive group represented by Z denotes a group that forms a partial structure of a polymer by a reaction different from polymerization with respect to the reactive group W.

The macromonomer used for the grafting through method is not particularly limited as long as the macromonomer is typically used for synthesis of a graft polymer. As the macromonomer, a commercially available product may be used, or an appropriately synthesized product may be used. Examples of the method of synthesizing the macromonomer include a method described in JP1993-295015A (JP-H5-295015A) and a method of reacting a polymer of a chain transfer agent such as 3-mercapto-1-propanol or the like and a monomer with a compound containing an isocyanate group and a polymerizable group in the presence of a tin catalyst. Further, as a method of synthesizing a macromonomer, “Chemistry and Industry of macromonomers” written by Yuya Yamashita, IPC Publishing Department, 1989 can be referred to.

### Star Structure

The star structure (star type structure) denotes a structure that satisfies all the following conditions (S-1) to (S-3).

(S A polymer has one nucleus.

(S Three or more polymers PA^{S1} consisting of one or two or more kinds of repeating units are bonded to the nucleus.

(S A polymer PB^{S1} which has a main chain direction different from the main chain direction of the polymer PA^{S1} and consists of one or two or more kinds of repeating units is not bonded to the polymer PA^{S1}.

In the star structure, the number of the polymers PA^{S1} bonded to the nucleus may be 3 or greater and is appropriately determined according to the characteristics and the like of the fluorine polymer (specific interface improver). The number of polymers PA^{S1} is typically the same as the number of end portions described below. A plurality of polymers PA^{S1} that are present may be the same as or different from each other.

Further, “nucleus” denotes a multi-branched structure (group) to which the polymer PA^{S1} can be bonded and is a center point on which a large number (for example, 2 to 12) of polymers grow.

In the above-described star structure, the bonding mode (structure) of the repeating unit forming the polymer PA^{S1} is not particularly limited and may be a block structure or a random structure.

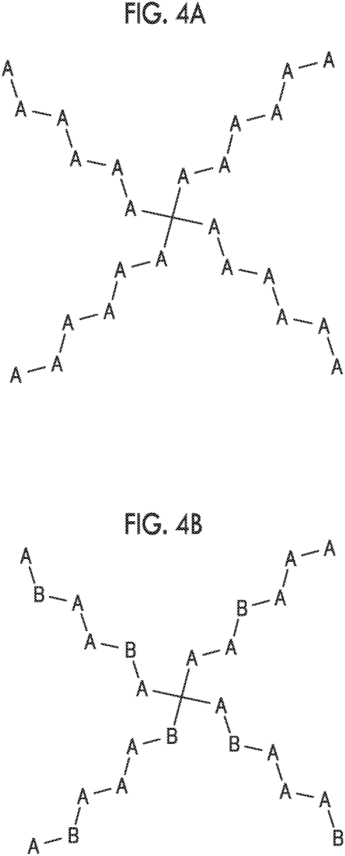

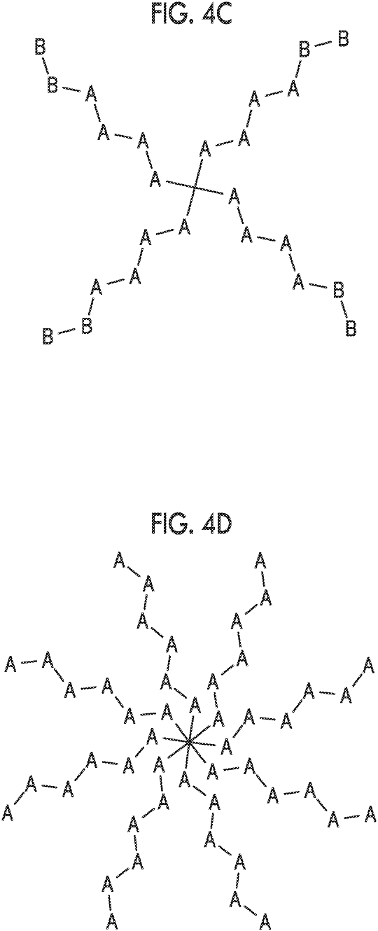

The star structure that the specific interface improver can have is not particularly limited as long as the star structure is as described above, and examples thereof include the structures shown in FIGS. 4A to 4D (also collectively referred to as FIG. 4).

The star structure shown in FIG. 4A is a structure in which four polymers PA^{S1} consisting of the repeating unit A are bonded to the nucleus. The star structure shown in FIG. 4B is a structure in which four polymers PA^{S1} having a random structure consisting of the repeating unit A and the repeating unit B are bonded to the nucleus. The star structure shown in FIG. 4C is a structure in which four polymer PA^{S1} having a block structure that has a partial structure consisting of the repeating unit A and a partial structure consisting of the repeating unit B in a block structure are bonded to the nucleus via the repeating unit A. The star structure shown in FIG. 4D is a structure in which eight polymers PA^{S1} consisting of the repeating unit A are bonded to the nucleus.

A polymer having the star structure can be obtained by a typical method of polymerizing a star copolymer. Examples thereof include a method of using a polyfunctional initiator, a method of using a polyfunctional terminating agent, and a method of using a linking reaction with a divinyl compound. Among these, a method of using a polyfunctional initiator is preferable.

In regard to the above-described polymerization method, “Polymer Synthesis (first volume)- Radical Polymerization/Cationic Polymerization/Anionic Polymerization” edited by Tsuyoshi Endo, Mitsuo Sawamoto et al., Kodansha, 2010, pp. 110 to 113 can be referred to.

Further, anionic polymerization can also be used for the synthesis of a polymer having a star structure, and “Polymer Synthesis (first volume)- Radical Polymerization/Cationic Polymerization/Anionic Polymerization” edited by Tsuyoshi Endo, Mitsuo Sawamoto et al., Kodansha, 2010, pp. 395 to 402 can be referred to.

A compound which has been typically used can be used as the nucleus forming the star structure without particular limitation. For example, examples of the compound serving as a nucleus include an organic compound (such as a polysubstituted aromatic ring, sugar, a calixarene, or a dendrimer), an inorganic compound (such as a cyclic siloxane or phosphoramide), or a polydentate metal complex having a metal at the center.

Examples of the above-described nucleus include the compounds described below. Further, “Polymer Synthesis (first volume)- Radical Polymerization/Cationic Polymerization/Anionic Polymerization” edited by Tsuyoshi Endo, Mitsuo Sawamoto et al., Kodansha, 2010, pp. 110 to 113 can be referred to.

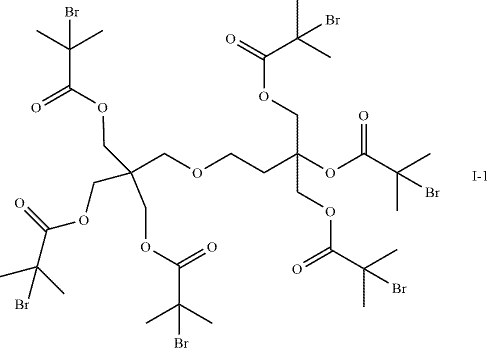 [SMILES: CC(C)(Br)C(=O)OCC(COCCC(COC(=O)C(C)(C)Br)(COC(=O)C(C)(C)Br)OC(=O)C(C)(C)Br)(COC(=O)C(C)(C)Br)COC(=O)C(C)(C)Br]

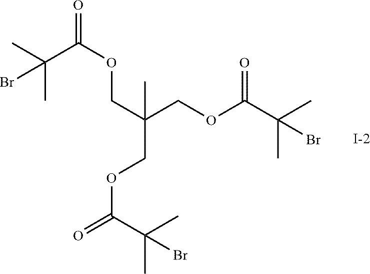 [SMILES: CC(COC(=O)C(C)(C)Br)(COC(=O)C(C)(C)Br)COC(=O)C(C)(C)Br]

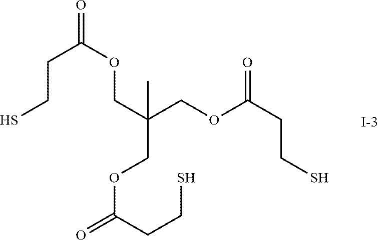 [SMILES: CC(COC(=O)CCS)(COC(=O)CCS)COC(=O)CCS]

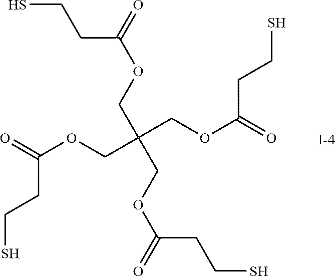 [SMILES: O=C(CCS)OCC(COC(=O)CCS)(COC(=O)CCS)COC(=O)CCS]

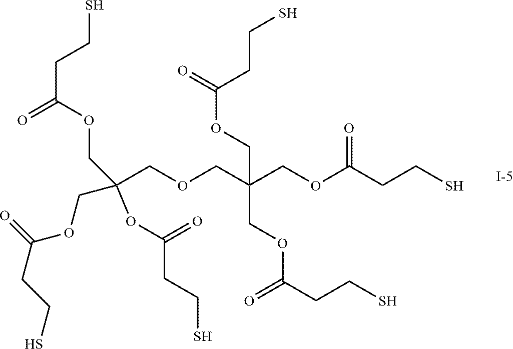 [SMILES: O=C(CCS)OCC(COCC(COC(=O)CCS)(COC(=O)CCS)OC(=O)CCS)(COC(=O)CCS)COC(=O)CCS]

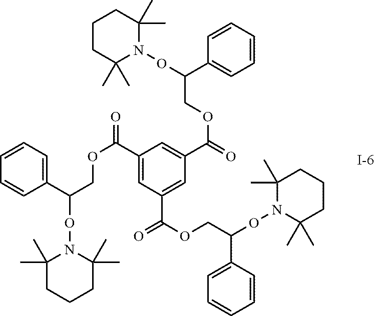 [SMILES: CC1(C)CCCC(C)(C)N1OC(COC(=O)c1cc(C(=O)OCC(ON2C(C)(C)CCCC2(C)C)c2ccccc2)cc(C(=O)OCC(ON2C(C)(C)CCCC2(C)C)c2ccccc2)c1)c1ccccc1]

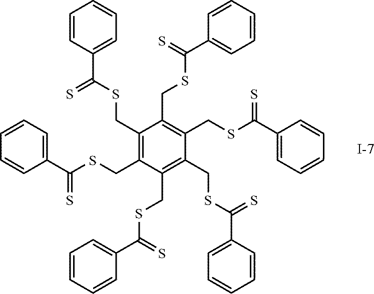 [SMILES: S=C(SCc1c(CSC(=S)c2ccccc2)c(CSC(=S)c2ccccc2)c(CSC(=S)c2ccccc2)c(CSC(=S)c2ccccc2)c1CSC(=S)c1ccccc1)c1ccccc1]

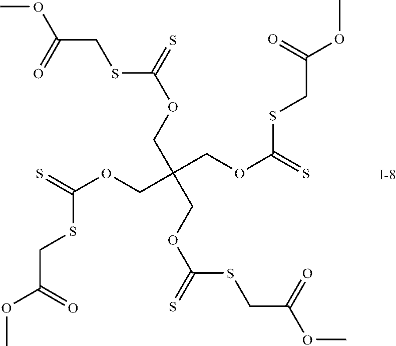

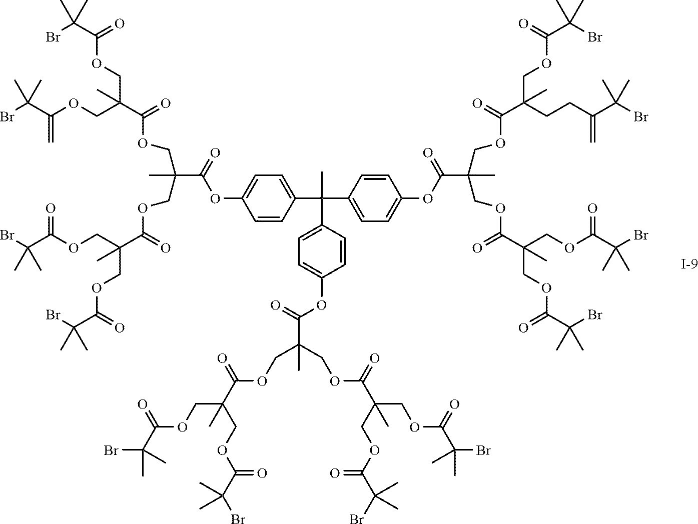 [SMILES: C=C(CCC(C)(COC(=O)C(C)(C)Br)C(=O)OCC(C)(COC(=O)C(C)(COC(=O)C(C)(C)Br)COC(=O)C(C)(C)Br)C(=O)Oc1ccc(C(C)(c2ccc(OC(=O)C(C)(COC(=O)C(C)(COC(=C)C(C)(C)Br)COC(=O)C(C)(C)Br)COC(=O)C(C)(COC(=O)C(C)(C)Br)COC(=O)C(C)(C)Br)cc2)c2ccc(OC(=O)C(C)(COC(=O)C(C)(COC(=O)C(C)(C)Br)COC(=O)C(C)(C)Br)COC(=O)C(C)(COC(=O)C(C)(C)Br)COC(=O)C(C)(C)Br)cc2)cc1)C(C)(C)Br]

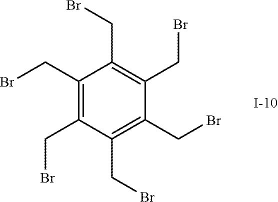 [SMILES: BrCc1c(CBr)c(CBr)c(CBr)c(CBr)c1CBr]

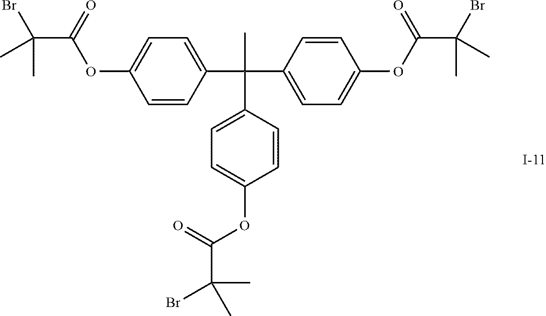 [SMILES: CC(C)(Br)C(=O)Oc1ccc(C(C)(c2ccc(OC(=O)C(C)(C)Br)cc2)c2ccc(OC(=O)C(C)(C)Br)cc2)cc1]

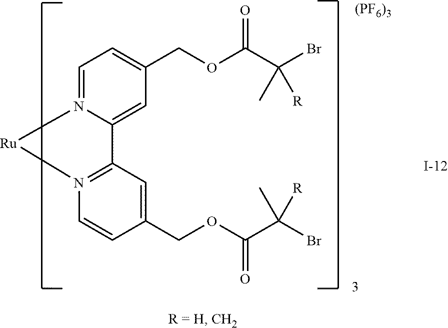

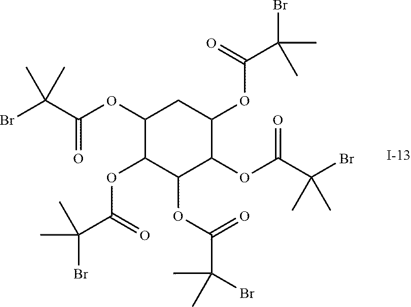 [SMILES: CC(C)(Br)C(=O)OC1CC(OC(=O)C(C)(C)Br)C(OC(=O)C(C)(C)Br)C(OC(=O)C(C)(C)Br)C1OC(=O)C(C)(C)Br]

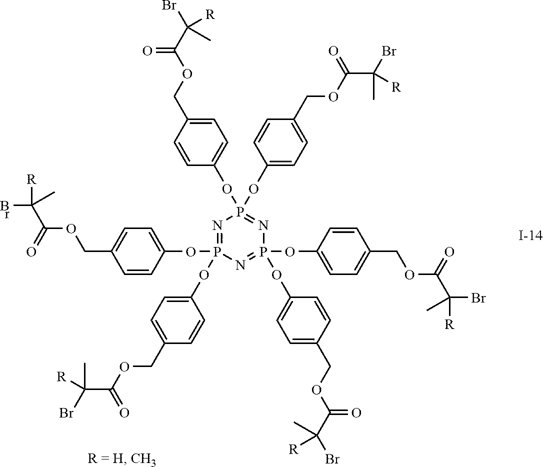

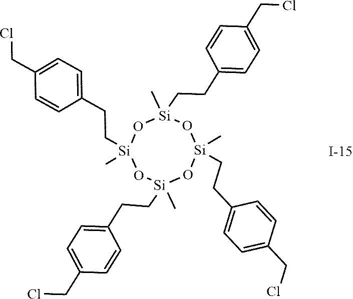 [SMILES: C[Si]1(CCc2ccc(CCl)cc2)O[Si](C)(CCc2ccc(CCl)cc2)O[Si](C)(CCc2ccc(CCl)cc2)O[Si](C)(CCc2ccc(CCl)cc2)O1]

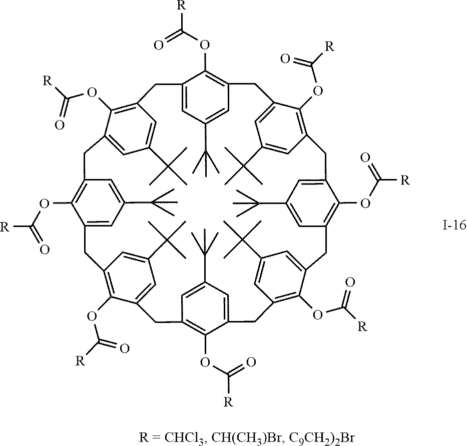

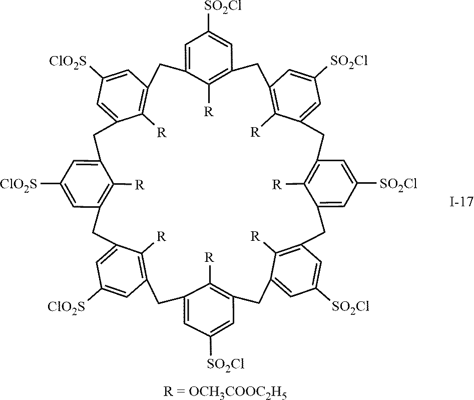

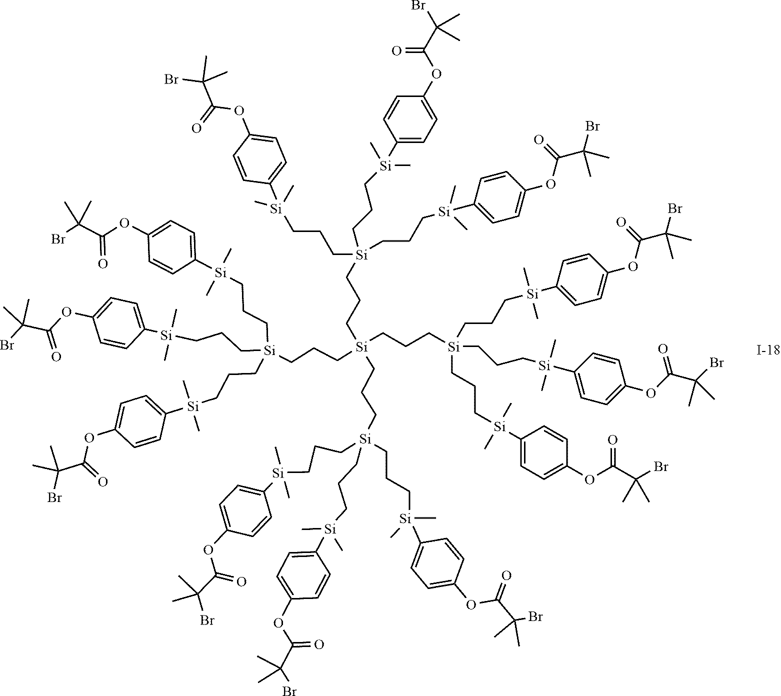

### Branched Structure

The branched structure denotes a structure that satisfies all the following conditions (B-1) to (B-3).

(B A polymer has one or more nuclei.

(B Two or more polymers PA^{B1} consisting of one or two or more kinds of repeating units are bonded to the nucleus.

(B A polymer PB^{B1} having a main chain direction different from the main chain direction of the polymer PA^{B1} and consisting of one or two or more kinds of repeating units (generations) is bonded to the polymer PA^{B1} (via a nucleus).

The above-described condition (B-3) can be satisfied a plurality of times. That is, another polymer PB^{B1} can be bonded to the polymer PB^{B1} bonded as described above in a direction specified in (B-3) (each generation is repeatedly polymerized) (dendritic multi-branched structure). In this case, the condition (B-3) may be satisfied the plurality of times, specifically, two or more times, and the number thereof is appropriately determined according to the characteristics or the like of the fluorine polymer. For example, the number thereof can be set to 2 to 7 times.

In the branched structure, the polymer PA^{B1} and the polymer PB^{B1} may be the same as or different from each other. Further, the bonding mode (structure) of the repeating unit that forms the polymer PA^{B1} and the polymer PB^{B1} is not particularly limited, and may be a random structure, a block structure, a graft structure, or a star structure. That is, examples of the branched structure include a dendritic multi-branched structure in which a polymer growing from a nucleus is repeatedly branched in a terminal direction and a structure obtained by combining a block structure, a graft structure, and/or a star structure. In the branched structure, the repeating unit can also be changed for each branch.

Further, the number of nuclei contained in the polymer may be one or greater, and is appropriately determined according to the characteristics or the like of the fluorine polymer. For example, the number thereof can be set to 1 or greater and 150 or less. In addition, the number of the polymers PA^{B1} bonded to the nucleus may be 2 or greater, and is appropriately determined according to the characteristics or the like of the fluorine polymer. For example, the number thereof can be set to 2 or greater and 20 or less. Further, the number of the polymers PB^{B1} bonded to the polymer PA^{B1} is appropriately determined according to the characteristics or the like of the fluorine polymer, and can be set to 1 or greater and 150 or less. In particular, the number of the polymers PB^{B1} bonded to one polymer PA^{B1} (nucleus) is preferably 2 or greater.

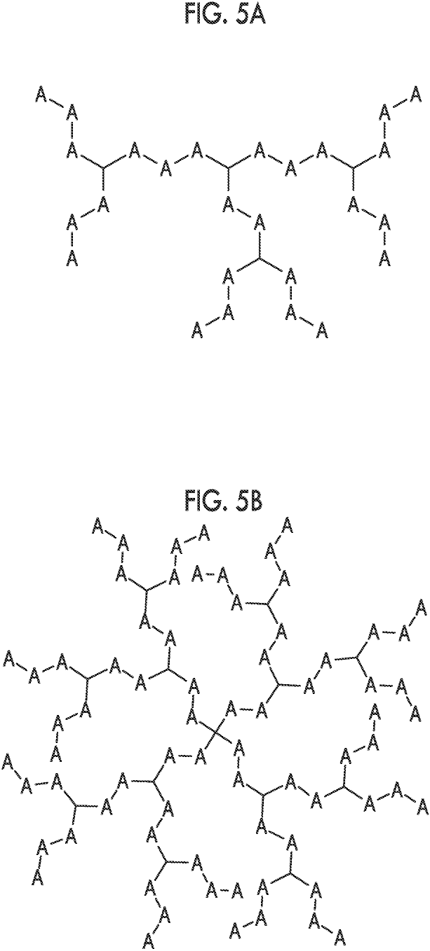

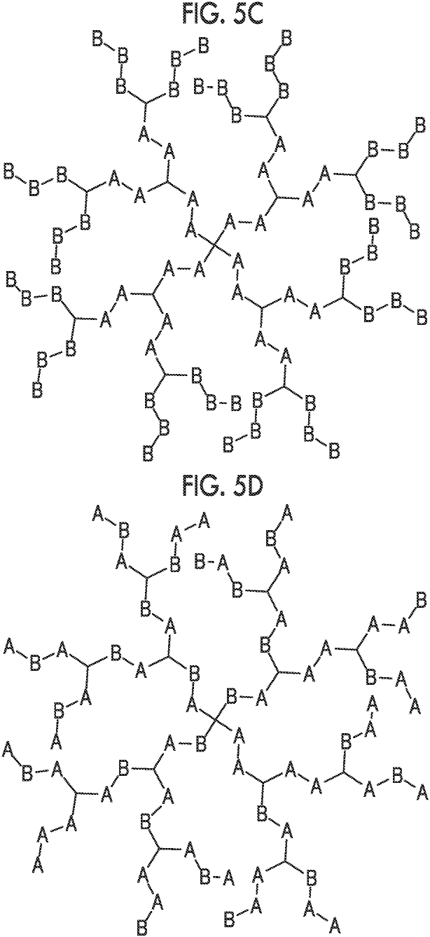

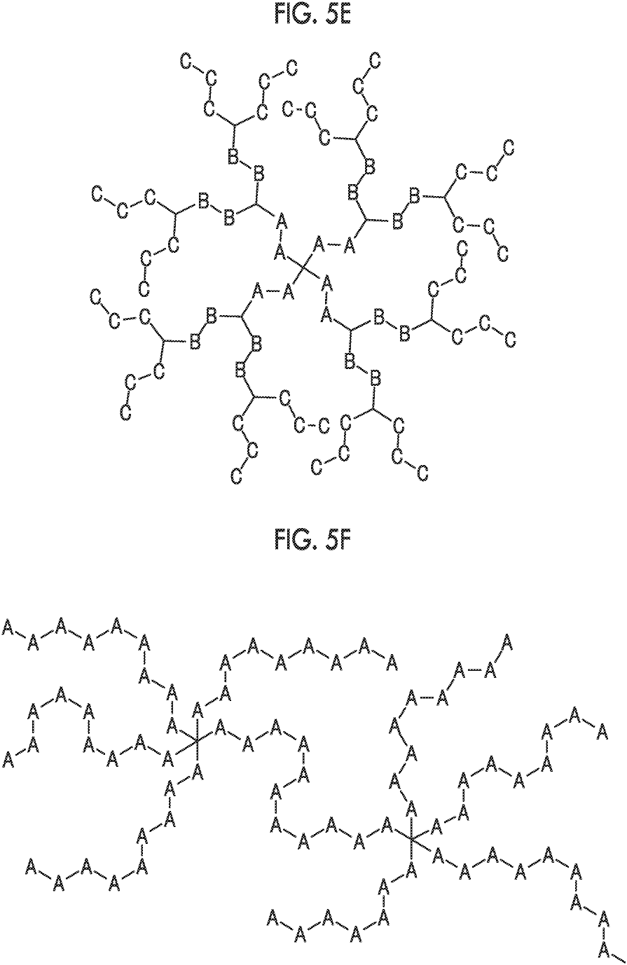

The branched structure that the specific interface improver can have is not particularly limited as long as the branched structure is as described above, and examples thereof include the structures shown in FIGS. 5A to 5E (also collectively referred to as FIG. 5).

The branched structure shown in FIGS. 5A and 5B has the polymer PB^{B1} further bonded to the polymer PA^{B1} bonded to the nucleus. That is, the branched structure is a dendritic multi-branched structure in which the repeating unit A is repeatedly branched from the nucleus in the terminal direction. The branched structure shown in FIG. 5C is the same structure as the dendritic multi-branched structure shown in FIG. 5B except that the branched structure has the repeating unit B branched from an end portion of the branched chain. The branched structure shown in FIG. 5D is the same structure as the dendritic multi-branched structure shown in FIG. 5B except that the branched structure has the repeating unit A and the repeating unit B branched in a random alignment. The branched structure shown in FIG. 5E is the same structure as the dendritic multi-branched structure shown in FIG. 5B except that the branched structure has the repeating unit B (second generation) branched from an end portion of the branched chain and the repeating unit C (third generation) branched as a third component from the middle thereof. The branched structure shown in FIG. 5F is a structure formed by bonding two star structures in which five polymers PA^{S1} consisting of the repeating unit A are bonded to the nucleus to each other such that one polymer PA^{S1} of each star structure is bonded to the other.

A polymer having the branched structure can be obtained by a typical polymerization method. Examples thereof include a divergent method and a convergent method. Among these, a convergent method is preferable. In regard to the above-described polymerization method, Macromolecules, 2005, 38 (21), pp. 8701 to 8711, Macromolecules, 2006, 39 (22), pp. 4361 to 4365, or “Polymer Synthesis (first volume)- Radical Polymerization/Cationic Polymerization/Anionic Polymerization” edited by Tsuyoshi Endo, Mitsuo Sawamoto et al., Kodansha, 2010, pp. 402 to 414 can be referred to.

The nucleus that can form the branched structure may be a polymer or a macromonomer having at least one structure selected from the group consisting of the block structure, the graft structure, and the star structure, in addition to the nucleus described in the above-described star structure.

In regard to the above-described nucleus, Macromolecules, 2005,38 (21), pp. 8701 to 8711, Macromolecules, 2006,39 (22), pp. 4361 to 4365, or “Polymer Synthesis (first volume)-Radical Polymerization/Cationic Polymerization/Anionic Polymerization” edited by Tsuyoshi Endo, Mitsuo Sawamoto et al., Kodansha, 2010, pp. 402 to 414 can be referred to.

In regard to the primary structure and the polymerization method described above, “Polymer Synthesis (first volume)- Radical Polymerization/Cationic Polymerization/Anionic Polymerization” edited by Tsuyoshi Endo, Mitsuo Sawamoto et al., Kodansha, 2010 can be referred to.

Each of the above-described primary structures can be identified as follows. That is, the mean square rotation radius <S²> of each of the graft structure, the star structure, and the branched structure is measured by static light scattering measurement and can be confirmed as the shape of the particles. In addition, the presence or absence of the block structure can be confirmed by nuclear magnetic resonance (NMR) measurement.

In regard to the identification of the above-described primary structure, “A laboratory guide to structure and property measurement of organic compounds polymers for young chemists”, Kodansha, 2006 can be referred to.

From the viewpoints of the solubility, the aligning properties, and the alignment defects, the specific interface improver has preferably a block structure, a graft structure, a branched structure, or a star structure consisting of two or more kinds of repeating units and preferably a graft structure or a branched structure consisting of two or more kinds of repeating units.

The repeating unit forming the specific interface improver is not particularly limited as long as one or two or more kinds of repeating units are present. In a case of the block structure, the graft structure, the branched structure, or the star structure consisting of two or more kinds of repeating units, the number of kinds of the repeating units is preferably in a range of 2 to 10, more preferably in a range of 2 to 5, and still more preferably 2 or 3. The above-described units can be used as the repeating units.

The specific interface improver has preferably 2 to 250 end portions, more preferably 2 to 100 end portions, still more preferably 2 to 80 end portions, and particularly preferably 2 to 50 end portions per molecule. The end portion of the specific interface improver denotes the maximum number of terminals that the specific interface improver having a certain molecular weight can have.

The number of end portions of the specific interface improver can be acquired by the following calculation method.

In a case where the specific interface improver has a graft structure, the number of end portions can be acquired by using the number average molecular weight (Mn).

For example, in a case where a copolymer having a graft structure (Mn = 100,000) is synthesized by copolymerization of the monomer A and the macromonomer AA-1 (Mn = 5,000), “(number of end portions) = 100,000/5,000 + 2 = 22 (pieces)” can be calculated by “(number of end portions) = (number average molecular weight of copolymer)/(number average molecular weight of macromonomer) + (number of terminals of stem)”.

Here, the number average molecular weights of the copolymer and the macromonomer can be measured by a method described below or the like.

In a case where the specific interface improver has a star structure or a branched structure, the number of end portions is determined by the nucleus.

In a case of the star structure, the number of end portions is acquired by “(number of end portions) = (maximum number of branches of compound used for nucleus)”.

Further, in a case of the branched structure, the number of end portions is calculated by multiplying the number of branches of the nucleus by the maximum number of branches of the nucleus used for each branch point. That is, the number of end portions can be calculated by “(number of end portions) = maximum number of branches of nucleus x (maximum number of branches of nucleus used for branch point 1) x (maximum number of branches of nucleus used for branch point 2) x ... x (maximum number of branches of nucleus used for branch point n).

Here, n represents the number of branch points (having the same definition as that for the number of generations-1).

In a case of the block structure, the number of end portions is 2.

Further, the number of end portions of the specific interface improver per molecule can be calculated by identifying the repeating unit and/or the element serving as a polymerization starting point based on elemental analysis, analysis results of electron spectroscopy for chemical analysis (ESCA), and nuclear magnetic resonance (NMR) measurement. Examples of the element serving as the polymerization starting point include a S atom, a halogen atom (such as Cl or Br), a Si atom, a N atom, and an O atom. Further, examples of the functional group contained in the repeating unit include —SO₂— and —SO—.

### Content

From the viewpoint that the effects of the present invention are more excellent, the content of the specific interface improver is preferably in a range of 0.01% to 10.0% by mass, more preferably in a range of 0.05% to 6.0% by mass, and still more preferably in a range of 0.1% to 4.0% by mass with respect to the total solid content (100% by mass) of the liquid crystal composition.

### Molecular Weight

From the viewpoint that the effects of the present invention are more excellent, the weight-average molecular weight (Mw) of the specific interface improver is preferably in a range of 2000 to 500000, more preferably in a range of 3000 to 300000, and still more preferably in a range of 4000 to 100000.

Here, the weight-average molecular weight and the number average molecular weight in the present invention are values measured by the gel permeation chromatography (GPC) method.
Solvent (eluent): tetrahydrofuran
Equipment name: TOSOH HLC-8220GPC
Column: Connect and use three of TOSOH TSKgel Super HZM-H (4.6 mm x 15 cm)
Column temperature: 25° C.
Sample concentration: 0.1% by mass
Flow rate: 0.35 ml/min
Calibration curve: TSK standard polystyrene (manufactured by TOSOH Corporation), calibration curves of 7 samples with Mw of 2800000 to 1050 (Mw/Mn = 1.03 to 1.06) are used.

### Dichroic Substance

The liquid crystal composition according to the embodiment of the present invention may further contain a dichroic substance.

In the present invention, the dichroic substance denotes a coloring agent having different absorbances depending on the direction. The dichroic substance may or may not exhibit liquid crystallinity.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011- 213610A, paragraphs [0074] to [0246] of JP2011-237513A, paragraphs [0005] to [0051] of JP2016-006502A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, and paragraphs [0014] to [0034] of WO2018/164252A.

In the present invention, two or more kinds of dichroic substances may be used in combination. For example, from the viewpoint of making the color of the optically anisotropic layer to be formed closer to black, it is preferable that at least one dichroic substance having a maximum absorption wavelength in a wavelength range of 370 to 550 nm and at least one dichroic substance having a maximum absorption wavelength in a wavelength range of 500 to 700 nm are used in combination.

In a case where the liquid crystal composition according to the embodiment of the present invention contains a dichroic substance, from the viewpoint that the effects of the present invention are more excellent, the content of the dichroic substance is preferably in a range of 1% to 70% by mass, more preferably in a range of 2% to 60% by mass, and still more preferably in a range of 3% to 50% by mass with respect to the total solid content (100% by mass) of the liquid crystal composition.

### Solvent

From the viewpoint of workability and the like, it is preferable that the liquid crystal composition according to the embodiment of the present invention contains a solvent.

Examples of the solvent include organic solvents such as ketones (such as acetone, 2-butanone, methyl isobutyl ketone, cyclopentanone, and cyclohexanone), ethers (such as dioxane, tetrahydrofuran, tetrahydropyran, dioxolane, tetrahydrofurfuryl alcohol, and cyclopentyl methyl ether), aliphatic hydrocarbons (such as hexane), alicyclic hydrocarbons (such as cyclohexane), aromatic hydrocarbons (such as benzene, toluene, xylene, and trimethylbenzene), halogenated carbons (such as dichloromethane, trichloromethane (chloroform), dichloroethane, dichlorobenzene, and chlorotoluene), esters (such as methyl acetate, ethyl acetate, butyl acetate, and diethyl carbonate), alcohols (such as ethanol, isopropanol, butanol, and cyclohexanol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine), and water.

These solvents may be used alone or in combination of two or more kinds thereof.

Among these solvents, from the viewpoint of further increasing the alignment degree of the optically anisotropic layer to be formed and further improving the heat resistance, it is preferable to use an organic solvent and more preferable to use halogenated carbons, ethers, or ketones.

In a case where the liquid crystal composition contains a solvent, from the viewpoint of further increasing the alignment degree of the optically anisotropic layer to be formed and further improving the heat resistance, the content of the solvent is preferably in a range of 70% to 99.5% by mass, more preferably in a range of 75% to 99% by mass, and particularly preferably in a range of 80% to 98% by mass with respect to the total mass (100% by mass) of the liquid crystal composition.

### Other Interface Improvers

The liquid crystal composition according to the embodiment of the present invention may contain other interface improvers (hereinafter, also referred to as “other interface improvers”) in addition to the above-described specific interface improver.

As the other interface improvers, interface improvers that allow liquid crystal compounds to be horizontally aligned are preferable, and compounds (horizontal alignment agents) described in paragraphs [0253] to [0293] of JP2011-237513A can be used. Further, fluorine (meth)acrylate-based polymers described in paragraphs [0018] to [0043] of JP2007- 272185A can also be used. Further, examples of the other interface improvers include the compounds described in paragraphs [0079] to [0102] of JP2007-069471A, the polymerizable liquid crystal compounds represented by Formula (4) which are described in JP2013-047204A (particularly the compounds described in paragraphs [0020] to [0032]), the polymerizable liquid crystal compounds represented by Formula (4) which are described in JP2012-211306A (particularly the compounds described in paragraphs [0022] to [0029]), the liquid crystal alignment accelerators represented by Formula (4) which are described in JP2002-129162A (particularly the compounds described in paragraphs [0076] to [0078] and paragraphs [0082] to [0084]), and the compounds represented by Formulae (4), (II) and (III) which are described in JP2005-099248A (particularly the compounds described in paragraphs [0092] to [0096]).

### Polymerization Initiator

The liquid crystal composition according to the embodiment of the present invention may contain a polymerization initiator. The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (US2367661A and US2367670A), acyloin ether (US2448828A), α-hydrocarbon-substituted aromatic acyloin compounds (US2722512A), polynuclear quinone compounds (US3046127A and US2951758A), a combination of a triarylimidazole dimer and a p-aminophenyl ketone (US3549367A), acridine and phenazine compounds (JP1985-105667A(JP-S60-105667A) and US4239850A), oxadiazole compounds (US4212970A), o-acyloxime compounds (paragraph [0065] of JP2016-27384A), and acylphosphine oxide compounds (JP1988-40799B (JP-S63-40799B), JP1993-29234B (JP-H05-29234B), JP1998-95788A (JP-H10-95788A), and JP1998-29997A (JP-H10-29997A)).

Commercially available products can also be used as such a photopolymerization initiator, and examples thereof include IRGACURE 184, IRGACURE 907, IRGACURE 369, IRGACURE 651, IRGACURE 819, IRGACURE OXE-01, and IRGACURE OXE-02 (all manufactured by BASF SE).

In a case where the liquid crystal composition contains a polymerization initiator, from the viewpoint of further increasing the alignment degree of the optically anisotropic layer to be formed and further improving the heat resistance, the content of the polymerization initiator is preferably in a range of 0.01% to 30% by mass and more preferably in a range of 0.1% to 15% by mass with respect to the total solid content (100% by mass) of the liquid crystal composition.

### Polymerizable Boronic Acid Compound

From the viewpoint of improving the adhesiveness, the liquid crystal composition according to the embodiment of the present invention may contain a boronic acid compound containing a polymerizable group (hereinafter, also referred to as “polymerizable boronic acid compound”).

The polymerizable boronic acid compound is a compound containing a polymerizable group and at least one of a boronic acid group or a boronic acid ester group, as described below. It is assumed that the adhesiveness between the optically anisotropic layer and other members is improved due to the interaction of these groups (the polymerizable group, the boronic acid group, and the boronic acid ester group) of the polymerizable boronic acid compound with other members.

Further, the polymerizable boronic acid compound is widely used as a vertical alignment agent that vertically aligns a liquid crystal compound. However, the reason for this is not clear, but in the present invention, it is considered that the polymerizable boronic acid compound does not sufficiently function as a vertical alignment agent and thus does not inhibit horizontal alignment of the liquid crystal compound. In this manner, an effect of improving the adhesiveness is expected while a high alignment degree is maintained.

The polymerizable boronic acid compound is a compound containing a polymerizable group and at least one of a boronic acid group or a boronic acid ester group. In the optically anisotropic layer, the polymerizable boronic acid compound may be polymerized.

As the polymerizable group, an acryloyl group, a methacryloyl group, an epoxy group, an oxetanyl group, or a styryl group is preferable, and an acryloyl group or a methacryloyl group is more preferable from the viewpoint that the adhesiveness is more excellent.

The polymerizable boronic acid compound may contain one or two or more polymerizable groups, but it is preferable that the polymerizable boronic acid compound contains one polymerizable group from the viewpoint that at least one of the adhesiveness or the alignment degree is more excellent.

The boronic acid group is a group represented by —B(OH)₂.

Examples of the boronic acid ester group include a group represented by —B(—OR^{B12})(—OR^{B13}) in Formula (B-1).

The polymerizable boronic acid compound may contain one or two or more of at least one of the boronic acid group or the boronic acid ester group, and it is preferable that the polymerizable boronic acid compound contains one of at least one of the boronic acid group or the boronic acid ester group from the viewpoint that at least one of the adhesiveness or the alignment degree is more excellent.

It is preferable that the polymerizable boronic acid compound has an aromatic ring from the viewpoint that the alignment degree is more excellent.

Examples of the aromatic ring include an aromatic hydrocarbon group and an aromatic heterocyclic group. Among these, an aromatic hydrocarbon group is preferable from the viewpoint that at least one of the adhesiveness or the alignment degree is more excellent.

The number of carbon atoms of the aromatic hydrocarbon group is not particularly limited, but is preferably in a range of 4 to 20 and more preferably in a range of 6 to 12. Examples of the aromatic hydrocarbon group include a benzene ring group.

The number of carbon atoms of the aromatic heterocyclic group is not particularly limited, but is preferably in a range of 3 to 10 and more preferably in a range of 3 to 5. Examples of atoms other than the carbon atom constituting the aromatic heterocyclic group include an oxygen atom, a nitrogen atom, and a sulfur atom.

The substituent of the aromatic hydrocarbon group and the aromatic heterocyclic group may be substituted.

In a case where the polymerizable boronic acid compound has an aromatic ring, the number of aromatic rings may be one or two or more, but is preferably 1 from the viewpoint that the alignment degree is more excellent.

From the viewpoint that at least one of the adhesiveness or the alignment degree is more excellent, a compound represented by Formula (B-1) is preferable as the polymerizable boronic acid compound.

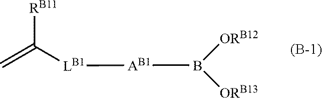

In Formula (B-1), R^{B11} represents a hydrogen atom or a methyl group.

L^{B1} represents a single bond, a divalent aliphatic hydrocarbon group, or a divalent group (hereinafter, also referred to as “divalent linking group B1”) in which one or more —CH₂—′s constituting a divalent aliphatic hydrocarbon group is substituted with at least one group selected from the group consisting of —O—, —C(═O)—, and —N(R^{B14})— (hereinafter, also referred to as “specific group B1”). Among these, the divalent linking group B1 is preferable from the viewpoint that the alignment degree and the adhesiveness are more excellent.

R^{B14} represents a hydrogen atom or an alkyl group and preferably a hydrogen atom. The number of carbon atoms of the alkyl group is not particularly limited, but is preferably in a range of 1 to 3 and particularly preferably 1.

The divalent aliphatic hydrocarbon group may be saturated or unsaturated, but is preferably saturated. The divalent aliphatic hydrocarbon group may be linear, branched, or cyclic, but is preferably linear or branched. From the viewpoint that the alignment degree and the adhesiveness are more excellent, an alkylene group is preferable as the divalent aliphatic hydrocarbon group. The number of carbon atoms of the divalent aliphatic hydrocarbon group is preferably in a range of 1 to 10 and particularly preferably in a range of 1 to 5.

In the divalent linking group B1, only one —CH₂— constituting the divalent aliphatic hydrocarbon group may be substituted with the specific group B1, and two or more —CH₂—′s may be substituted with the specific group B1.

Suitable aspects of the divalent linking group B1 include —C(═O)—O—alkylene group-, —C(═O) —O—alkylene group—N(R^{B14})—C(═O)—O—, —C(═O)—O—alkylene group—O—, —C(═O)—N(R^{B14})—, -alkylene group—N(R^{B14})—C(═O)—O—, and -alkylene group—O—.

A^{B1} represents an arylene group which may have a substituent or a heteroarylene group which may have a substituent. Among these, from the viewpoint that at least one of the adhesiveness or the alignment degree is more excellent, an arylene group which may have a substituent is preferable, and an arylene group (that is, an arylene group which does not have a substituent) is particularly preferable.

The number of carbon atoms of the arylene group is not particularly limited, but is preferably in a range of 4 to 20 and more preferably in a range of 6 to 12. Examples of the arylene group include a phenylene group.

The number of carbon atoms of the heteroarylene group is not particularly limited, but is preferably in a range of 3 to 10 and more preferably in a range of 3 to 5. Examples of the heteroatom of the heteroaryl group include an oxygen atom, a nitrogen atom, and a sulfur atom.

R^{B12} and R^{B13} each independently represent a hydrogen atom, an alkyl group which may have a substituent, an aryl group which may have a substituent, or a heteroaryl group which may have a substituent. Among these, from the viewpoint that at least one of the adhesiveness or the alignment degree is more excellent, a hydrogen atom or an alkyl group which may have a substituent is preferable, and a hydrogen atom is more preferable.

The number of carbon atoms of the alkyl group is not particularly limited, but is preferably in a range of 1 to 10 and more preferably in a range of 1 to 5. Examples of the alkyl group include a methyl group, an ethyl group, and a propyl group.

The number of carbon atoms of the aryl group is not particularly limited, but is preferably in a range of 4 to 20 and more preferably in a range of 6 to 12. Examples of the aryl group include a phenyl group.

The number of carbon atoms of the heteroaryl group is not particularly limited, but is preferably in a range of 3 to 10 and more preferably in a range of 3 to 5. Examples of the heteroatom of the heteroaryl group include an oxygen atom, a nitrogen atom, and a sulfur atom.

R^{B12} and R^{B13} may be bonded to each other to form a ring. Examples of the ring to be formed include an aliphatic hydrocarbon ring having a boron atom.

From the viewpoint that at least one of the adhesiveness or the alignment degree is more excellent, a compound represented by Formula (B-2) is preferable as the compound represented by Formula (B-1).

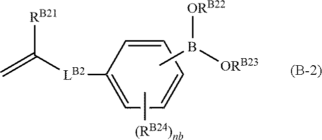

In Formula (B-2), R^{B21} represents a hydrogen atom or a methyl group.

L^{B2} represents a single bond, a divalent aliphatic hydrocarbon group, or a divalent group (hereinafter, also referred to as “divalent linking group B2”) in which one or more —CH₂—′s constituting a divalent aliphatic hydrocarbon group is substituted with at least one group selected from the group consisting of —O—, —C(═O)—, and —N(R^{B25})— (hereinafter, also referred to as “specific group B2”). Among these, the divalent linking group B2 is preferable from the viewpoint that the alignment degree and the adhesiveness are more excellent.

R^{B25} represents a hydrogen atom or an alkyl group and preferably a hydrogen atom. The number of carbon atoms of the alkyl group is not particularly limited, but is preferably in a range of 1 to 3 and particularly preferably 1.

The divalent aliphatic hydrocarbon group, the divalent linking group B2, and the specific group B2 in L^{B2} each have the same definition as that for the divalent aliphatic hydrocarbon group, the divalent linking group B1, and the specific group B1 in L^{B1} of Formula (B-1), and thus the description thereof will not be repeated.

R^{B22} and R^{B23} each independently represent a hydrogen atom, an alkyl group which may have a substituent, an aryl group which may have a substituent, or a heteroaryl group which may have a substituent. Among these, from the viewpoint that at least one of the adhesiveness or the alignment degree is more excellent, a hydrogen atom or an alkyl group which may have a substituent is preferable, and a hydrogen atom is more preferable.

Each group as R^{B22} has the same definition as that for each group as R^{B12} of Formula (B-1), and thus the description thereof will not be repeated.

Each group as R^{B23} has the same definition as that for each group as R^{B13} of Formula (B-1), and thus the description thereof will not be repeated.

R^{B22} and R^{B23} may be bonded to each other to form a ring. Examples of the ring to be formed include an aliphatic hydrocarbon ring having a boron atom.

R^{B24} represents a monovalent substituent. Specific examples of the monovalent substituent are as described below. As the monovalent substituent, an alkyl group, a halogen atom, an alkoxy group, or an aryl group is preferable.

nb represents an integer of 0 to 4. Among these, from the viewpoint that at least one of the adhesiveness or the alignment degree is more excellent, nb represents preferably 0 or 1 and more preferably 0.

In a case where nb represents 2 or greater, a plurality of R^{B24}′s may be the same as or different from each other.

The position of a group represented by —B(OR^{B22})(OR^{B23}) in the compound represented by Formula (B-2) is not particularly limited, but it is preferable that the group is positioned at the meta position or the para position with respect to the bonding position of L^{B2} from the viewpoint that at least one of the adhesiveness or the alignment degree is more excellent.

Specific examples of the polymerizable boronic acid compound are shown below, but the present invention is not limited thereto.

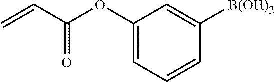

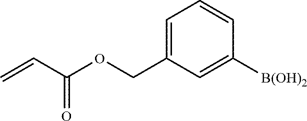

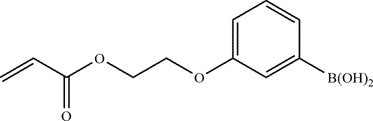 [SMILES: C=CC(=O)OCCOc1cccc(B(O)O)c1]

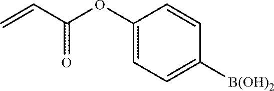

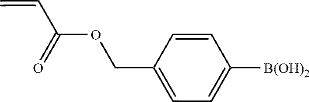

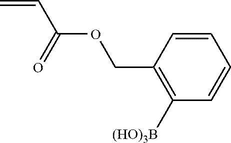

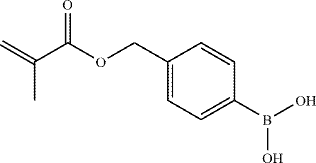 [SMILES: C=C(C)C(=O)OCc1ccc(B(O)O)cc1]

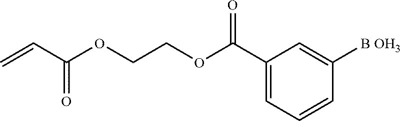

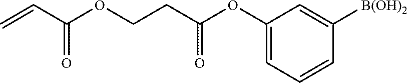 [SMILES: C=CC(=O)OCCC(=O)Oc1cccc(B(O)O)c1]

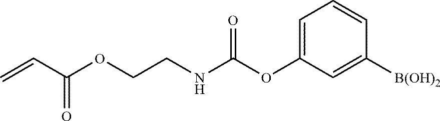 [SMILES: C=CC(=O)OCCNC(=O)Oc1cccc(B(O)O)c1]

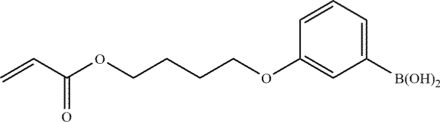 [SMILES: C=CC(=O)OCCCCOc1cccc(B(O)O)c1]

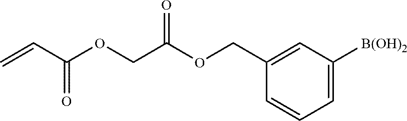 [SMILES: C=CC(=O)OCC(=O)OCc1cccc(B(O)O)c1]

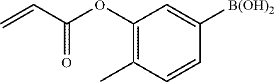

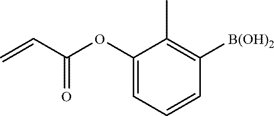

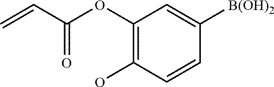

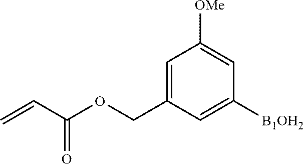

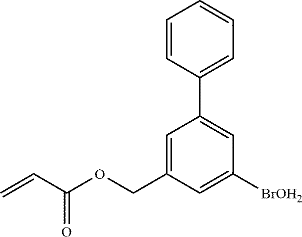

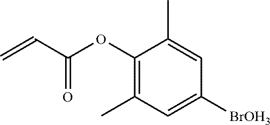

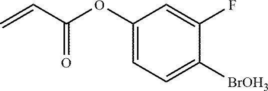

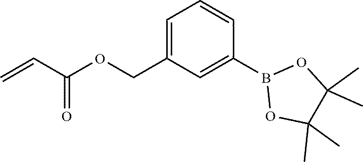 [SMILES: C=CC(=O)OCc1cccc(B2OC(C)(C)C(C)(C)O2)c1]

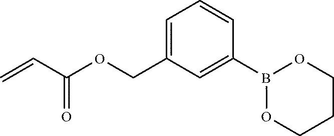 [SMILES: C=CC(=O)OCc1cccc(B2OCCCO2)c1]

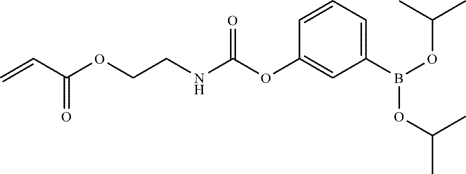 [SMILES: C=CC(=O)OCCNC(=O)Oc1cccc(B(OC(C)C)OC(C)C)c1]

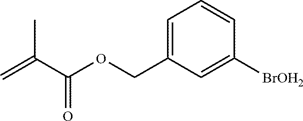

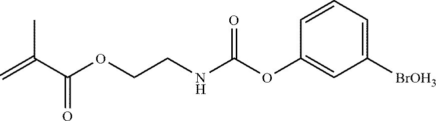

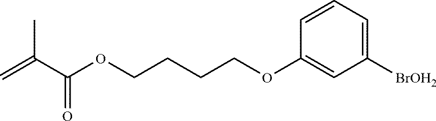

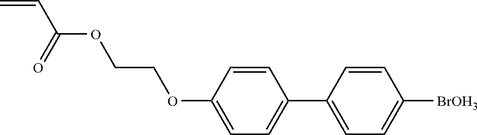

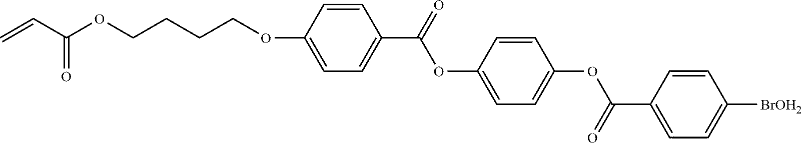

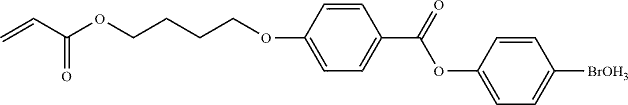

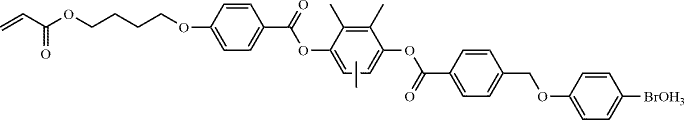

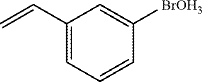

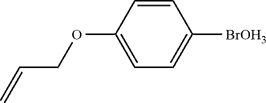

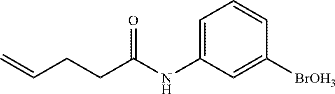

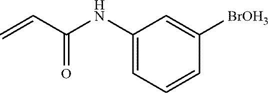

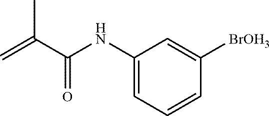

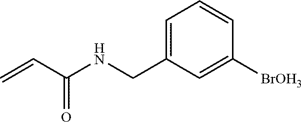

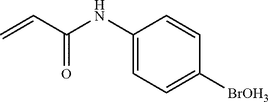

The content of the polymerizable boronic acid compound is preferably in a range of 0.1% to 10% by mass, more preferably in a range of 0.2% to 8% by mass, and particularly preferably in a range of 0.3% to 6% by mass with respect to the total solid content mass of the liquid crystal composition. In a case where the content of the polymerizable boronic acid compound is greater than or equal to the lower limit, the adhesiveness of the optically anisotropic layer is more excellent. In a case where the content of the polymerizable boronic acid compound is less than or equal to the upper limit, the alignment degree of the optically anisotropic layer is more excellent.

The polymerizable boronic acid compound may be used alone or in combination of two or more kinds thereof. In a case where the liquid crystal composition contains two or more kinds of the polymerizable boronic acid compounds, it is preferable that the total amount of the polymerizable boronic acid compounds is in the above-described ranges.

It is preferable that the content of the polymerizable boronic acid compound in the optically anisotropic layer with respect to the total mass of the optically anisotropic layer is the same as the content of the polymerizable boronic acid compound with respect to the total solid content mass of the above-described liquid crystal composition.

### Optically Anisotropic Layer

The optically anisotropic layer according to the embodiment of the present invention is an optically anisotropic layer (optically anisotropic film) formed of the liquid crystal composition according to the embodiment of the present invention described above.

Examples of a method of producing the optically anisotropic layer according to the embodiment of the present invention include a method of sequentially performing a step of coating a base material with the liquid crystal composition to form a coating film (hereinafter, also referred to as “coating film forming step”) and a step of horizontally aligning the rod-like liquid crystal compound contained in the coating film (hereinafter, also referred to as an “aligning step”).

Hereinafter, each step of the production method of preparing the optically anisotropic layer according to the embodiment of the present invention will be described.

### Coating Film Forming Step

The coating film forming step is a step of coating a base material with the liquid crystal composition to form a coating film.

The base material is easily coated with the liquid crystal composition by using the liquid crystal composition containing the above-described solvent or using a liquid such as a melt obtained by heating the liquid crystal composition.

Examples of the method of coating the base material with the liquid crystal composition include known methods such as a roll coating method, a gravure printing method, a spin coating method, a wire bar coating method, an extrusion coating method, a direct gravure coating method, a reverse gravure coating method, a die coating method, a spraying method, and an ink jet method.

In the present aspect, an example in which the base material is coated with the liquid crystal composition has been described, but the present invention is not limited thereto, and for example, the alignment film provided on the base material may be coated with the liquid crystal composition. The details of the base material and the alignment film will be described below.

### Aligning Step

The aligning step is a step of horizontally aligning the rod-like liquid crystal compound contained in the coating film. In this manner, an optically anisotropic layer is obtained. Further, in a case where the coating film contains a dichroic substance, the dichroic substance is also aligned in the same manner as the rod-like liquid crystal compound.

The aligning step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the dichroic substance that can be contained in the liquid crystal composition may be aligned by performing the above-described coating film forming step or drying treatment. For example, in an aspect in which the liquid crystal composition is prepared as a coating solution containing a solvent, a coating film having optical anisotropy (that is, an optically anisotropic layer) is obtained by drying the coating film and removing the solvent from the coating film.

It is preferable that the aligning step includes a heat treatment. In this manner, since the rod-like liquid crystal compound contained in the coating film can be aligned, the coating film after being subj ected to the heat treatment can be suitably used as the optically anisotropic layer.

From the viewpoint of the manufacturing suitability, the heat treatment is performed at a temperature of preferably 10° C. to 250° C. and more preferably 25° C. to 190° C. Further, the heating time is preferably in a range of 1 to 300 seconds and more preferably in a range of 1 to 60 seconds.

The aligning step may include a cooling treatment performed after the heat treatment. The cooling treatment is a treatment of cooling the coating film after being heated to room temperature (20° C. to 25° C.). In this manner, the alignment of the rod-like liquid crystal compound contained in the coating film can be fixed. The cooling means is not particularly limited and can be performed according to a known method.

The optically anisotropic layer can be obtained by performing the above-described steps.

In the present aspect, examples of the method of aligning the rod-like liquid crystal compound contained in the coating film include a drying treatment and a heat treatment, but the method is not limited thereto, and the rod-like liquid crystal compound can be aligned by a known alignment treatment.

### Other Steps

The method of producing the optically anisotropic layer may include a step of curing the optically anisotropic layer after the aligning step (hereinafter, also referred to as a “curing step”).

The curing step is performed by, for example, heating the layer and/or irradiating (exposing) the layer with light. Between these, it is preferable that the curing step is performed by irradiating the layer with light.

Various light sources such as infrared rays, visible light, and ultraviolet rays can be used as the light source for curing, but ultraviolet rays are preferable. In addition, ultraviolet rays may be applied while the layer is heated during curing, or ultraviolet rays may be applied through a filter that transmits only a specific wavelength.

Further, the exposure may be performed under a nitrogen atmosphere. In a case where the curing of the optically anisotropic layer proceeds by radical polymerization, since the inhibition of polymerization by oxygen is reduced, it is preferable that exposure is performed in a nitrogen atmosphere.

The film thickness of the optically anisotropic layer is preferably in a range of 0.1 to 5.0 µm and more preferably in a range of 0.3 to 1.5 µm. Although it depends on the concentration of the rod-like liquid crystal compound in the liquid crystal composition, an optically anisotropic layer having an excellent absorbance is obtained in a case where the film thickness of the optically anisotropic layer is 0.1 µm or greater, and an optically anisotropic layer having an excellent transmittance is obtained in a case where the film thickness thereof is 5.0 µm or less.

### Laminate

A laminate according to the embodiment of the present invention includes a base material and the optically anisotropic layer according to the embodiment of the present invention which is provided on the base material. The rod-like liquid crystal compound contained in the optically anisotropic layer is fixed in a state of being aligned in the horizontal direction. Here, the horizontal direction denotes a direction orthogonal to the thickness direction of the laminate.

Further, the laminate according to the embodiment of the present invention may include a λ/4 plate on the optically anisotropic layer or may include a barrier layer on the optically anisotropic layer. Further, the laminate according to the embodiment of the present invention may include both a λ/4 plate and a barrier layer, and in this case, it is preferable that the laminate includes the barrier layer between the optically anisotropic layer and the λ/4 plate.

Further, the laminate according to the embodiment of the present invention may include an alignment film between the base material and the optically anisotropic layer.

Hereinafter, each layer constituting the laminate of the present invention will be described.

### Base Material

The base material can be selected depending on the applications of the optically anisotropic layer, and examples thereof include glass and a polymer film. The light transmittance of the base material is preferably 80% or greater.

In a case where a polymer film is used as the base material, it is preferable to use an optically isotropic polymer film. As specific examples and preferred aspects of the polymer, the description in paragraph [0013] of JP2002-22942A can be applied. Further, even in a case of a polymer easily exhibiting the birefringence such as polycarbonate and polysulfone which has been known in the related art, a polymer with the exhibiting property which has been decreased by modifying the molecules described in WO2000/26705A can be used.

### Optically Anisotropic Layer

The optically anisotropic layer is as described above, and thus the description thereof will not be repeated.

### λ/4 Plate

“λ/4 plate” is a plate having a λ/4 function, specifically, a plate having a function of converting linearly polarized light having a specific wavelength into circularly polarized light (or converting circularly polarized light into linearly polarized light).

For example, specific examples of an aspect in which a λ/4 plate has a single-layer structure include a stretched polymer film and a phase difference film in which an optically anisotropic layer having a λ/4 function is provided on a support. Further, specific examples of an aspect in which a λ/4 plate has a multilayer structure include a broadband λ/4 plate obtained by laminating a λ/4 plate and a λ/2 plate.

The λ/4 plate and the optically anisotropic layer may be provided by coming into contact with each other, or another layer may be provided between the λ/4 plate and the optically anisotropic layer. Examples of such a layer include a pressure sensitive adhesive layer or an adhesive layer for ensuring the adhesiveness, and a barrier layer.

### Barrier Layer

In a case where the laminate according to the embodiment of the present invention includes a barrier layer, it is preferable that the barrier layer is provided between the optically anisotropic layer and the λ/4 plate. Further, in a case where the laminate includes a layer other than the barrier layer (for example, a pressure sensitive adhesive layer or an adhesive layer) between the optically anisotropic layer and the λ/4 plate, the barrier layer can be provided, for example, between the optically anisotropic layer and the layer other than the optically anisotropic layer.

The barrier layer is also referred to as a gas blocking layer (oxygen blocking layer) and has a function of protecting the optically anisotropic layer from gas such as oxygen in the atmosphere, the moisture, or the compound contained in an adjacent layer.

In regard to the barrier layer, the description in paragraphs [0014] to [0054] of JP2014- 159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A can be referred to.

### Alignment Film

The laminate according to the embodiment of the present invention may include an alignment film between the base material and the optically anisotropic layer.

The alignment film may be any layer as long as the rod-like liquid crystal compound contained in the liquid crystal composition according to the embodiment of the present invention can be in a desired alignment state on the alignment film.

An alignment film can be provided by means such as a rubbing treatment performed on a film surface of an organic compound (preferably a polymer), oblique vapor deposition of an inorganic compound, formation of a layer having microgrooves, or accumulation of an organic compound (such as ω-tricosanoic acid, dioctadecylmethylammonium chloride, or methyl stearylate) according to a Langmuir-Blodgett method (LB film). Further, an alignment film in which an alignment function is generated by application of an electric field, application of a magnetic field, or irradiation with light is also known. Among these, in the present invention, an alignment film formed by performing a rubbing treatment is preferable from the viewpoint of easily controlling the pretilt angle of the alignment film, and a photo-alignment film formed by irradiation with light is also preferable from the viewpoint of the uniformity of alignment.

The alignment film may function as the barrier layer described above.

### Rubbing Treatment Alignment Film

A polymer material used for the alignment film formed by performing a rubbing treatment is described in multiple documents, and a plurality of commercially available products can be used. In the present invention, polyvinyl alcohol or polyimide and derivatives thereof are preferably used. The alignment film can refer to the description on page 43, line 24 to page 49, line 8 of WO2001/88574A1. The thickness of the alignment film is preferably in a range of 0.01 to 10 µm and more preferably in a range of 0.01 to 1 µm.

### Photo-Alignment Film

A photo-alignment material used for an alignment film formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadiimide compounds having a photo-alignment unit described in JP2002-265541A and JP2002-317013A, photocrosslinkable silane derivatives described in JP4205195B and JP4205198B, and photocrosslinkable polyimides, polyamides, or esters described in JP2003-520878A, JP2004-529220A, and JP4162850B. Among these, azo compounds, photocrosslinkable polyimides, polyamides, or esters are more preferable.

The photo-alignment film formed of the above-described material is irradiated with linearly polarized light or non-polarized light to produce a photo-alignment film.

In the present specification, the “irradiation with linearly polarized light” and the “irradiation with non-polarized light” are operations for causing a photoreaction in the photo-alignment material. The wavelength of the light to be used varies depending on the photo-alignment material to be used and is not particularly limited as long as the wavelength is required for the photoreaction. The peak wavelength of light to be used for irradiation with light is preferably in a range of 200 nm to 700 nm, and ultraviolet light having a peak wavelength of 400 nm or less is more preferable.

Examples of the light source used for irradiation with light include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As means for obtaining linearly polarized light, a method of using a polarizing plate (for example, an iodine polarizing plate, a dichroic coloring agent polarizing plate, or a wire grid polarizing plate), a method of using a prism-based element (for example, a Glan-Thompson prism) or a reflective type polarizer for which a Brewster’s angle is used, or a method of using light emitted from a laser light source having polarized light can be employed. In addition, only light having a required wavelength may be selectively applied using a filter, a wavelength conversion element, or the like.

In a case where light to be applied is linearly polarized light, a method of applying light vertically or obliquely to the upper surface with respect to the alignment film or the surface of the alignment film from the rear surface is employed. The incidence angle of light varies depending on the photo-alignment material, but is preferably in a range of 0° to 90° (vertical) and more preferably in a range of 40° to 90°.

In a case where light to be applied is non-polarized light, the alignment film is irradiated with non-polarized light obliquely. The incidence angle is preferably in a range of 10° to 80°, more preferably in a range of 20° to 60°, and still more preferably in a range of 30° to 50°.

The irradiation time is preferably in a range of 1 minute to 60 minutes and more preferably in a range of 1 minute to 10 minutes.

In a case where patterning is required, a method of performing irradiation with light using a photomask as many times as necessary for pattern preparation or a method of writing a pattern by laser light scanning can be employed.

### Applications

The laminate according to the embodiment of the present invention can be used as a polarizer (polarizing plate), for example, as a linearly polarizing plate or a circularly polarizing plate.

In a case where the laminate according to the embodiment of the present invention does not include the λ/4 plate, the laminate can be used as a linearly polarizing plate.

Meanwhile, in a case where the laminate of the present invention includes the λ/4 plate, the laminate can be used as a circularly polarizing plate.

### Image Display Device

An image display device according to the embodiment of the present invention includes the above-described optically anisotropic layer or the above-described laminate.

The display element used in the image display device according to the embodiment of the present invention is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable, and a liquid crystal cell is more preferable. That is, in the image display device according to the embodiment of the present invention, a liquid crystal display device formed of a liquid crystal cell as a display element or an organic EL display device formed of an organic EL display panel as a display element is preferable, and a liquid crystal display device is more preferable.

### Liquid Crystal Display Device

As a liquid crystal display device which is an example of the image display device according to the embodiment of the present invention, an aspect of a liquid crystal display device including the above-described optically anisotropic layer and a liquid crystal cell is preferably exemplified. A liquid crystal display device including the above-described laminate (here, the laminate does not include a λ/4 plate) and a liquid crystal cell is more suitable.

In the present invention, between the optically anisotropic layers (laminate) provided on both sides of the liquid crystal cell, it is preferable that the optically anisotropic layer (laminate) according to the embodiment of the present invention is used as a front-side polarizer and more preferable that the optically anisotropic layer (laminate) according to the embodiment of the present invention is used as a front-side polarizer and a rear-side polarizer.

Hereinafter, the liquid crystal cell constituting the liquid crystal display device will be described in detail.

### Liquid Crystal Cell

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystal molecules are substantially horizontally aligned at the time of no voltage application and further twisted aligned at 60° to 120°. The liquid crystal cell in a TN mode is most likely used as a color thin film transistor (TFT) liquid crystal display device and is described in multiple documents.

In the liquid crystal cell in a VA mode, rod-like liquid crystal molecules are substantially vertically aligned at the time of no voltage application. The concept of the liquid crystal cell in a VA mode includes (1) a liquid crystal cell in a VA mode in a narrow sense where rod-like liquid crystal molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of tech. Papers (proceedings) 28 (1997) 845) in which the VA mode is formed to have multi-domain in order to expand the viewing angle, (3) a liquid crystal cell in a mode (n-ASM mode) in which rod-like liquid crystal molecules are substantially vertically aligned at the time of no voltage application and twistedly multi-domain aligned at the time of voltage application (described in proceedings of Japanese Liquid Crystal Conference, pp. 58 and 59 (1998)), and (4) a liquid crystal cell in a SURVIVAL mode (presented at LCD International 98). Further, the liquid crystal cell may be of any of a patterned vertical alignment (PVA) type, a photo-alignment (optical alignment) type, or a polymer-sustained alignment (PSA) type. Details of these modes are described in JP2006-215326A and JP2008-538819A.

In the liquid crystal cell in an IPS mode, rod-like liquid crystal molecules are aligned substantially parallel to the substrate, and the liquid crystal molecules respond planarly through application of an electric field parallel to the substrate surface. In the IPS mode, black display is carried out in a state where no electric field is applied, and absorption axes of a pair of upper and lower polarizing plates are orthogonal to each other. A method of reducing leakage light during black display in an oblique direction and improve the viewing angle using an optical compensation sheet is disclosed in JP1998-54982A (JP-H10-54982A), JP1999-202323A (JP- H11-202323A), JP1997-292522A (JP-H9-292522A), JP1999-133408A (JP-H11-133408A), JP1999-305217A (JP-H11-305217A), and JP1998-307291A (JP-H10-307291A).

### Organic EL Display Device

As an organic EL display device which is an example of the image display device according to the embodiment of the present invention, an aspect of an image display device including an optically anisotropic layer, a λ/4 plate, and an organic EL display panel in this order from the viewing side is suitably exemplified.

An aspect of an image display device including the above-described laminate including a λ/4 plate and an organic EL display panel in this order from the viewing side is more suitably exemplified. In this case, the laminate is formed such that a base material, an alignment film provided as necessary, an optically anisotropic layer, a barrier layer provided as necessary, and a λ/4 plate are disposed in this order from the viewing side.

Further, the organic EL display panel is a display panel formed of an organic EL element having an organic light emitting layer (organic electroluminescence layer) sandwiched between electrodes (between a cathode and an anode). The configuration of the organic EL display panel is not particularly limited, and a known configuration is employed.

### EXAMPLES

Hereinafter, the present invention will be described in more detail with reference to examples. Materials, used amounts, ratios, treatment contents, treatment procedures, and the like described in the following examples can be appropriately changed without departing from the spirit of the present invention. Therefore, the scope of the present invention should not be limitatively interpreted by the following examples.

### Synthesis Example 1

An interface improver B1 was synthesized by the following procedures.

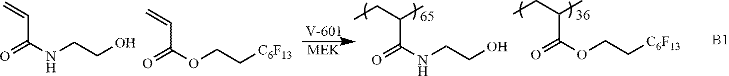

A reaction container was charged with 7.1 g of methyl ethyl ketone (MEK) and heated until the internal temperature reached 80° C. in a nitrogen stream. A mixed solution of 13.0 g of N-(2-hydroxyethyl) acrylamide (manufactured by Tokyo Chemical Industry Co., Ltd.), 7.0 g of CHEMINOX FAAC-6 (manufactured by Unimatec Co., Ltd., 2-(perfluorohexyl)ethyl acrylate), 0.60 g of dimethyl 2,2′-azobis(2-methylpropionate) (trade name, “V-601”, manufactured by FUJIFILM Wako Pure Chemical Corporation), and 22.6 g of methyl ethyl ketone was added dropwise to the reaction container for a polymerization reaction at 80° C. for 3 hours. After the completion of the dropwise addition, a methyl ethyl ketone (1.0 g) solution of 0.10 g of dimethyl 2,2′-azobis(2-methylpropionate) was added thereto, and the solution was stirred at 80° C. for 5 hours, thereby obtaining a methyl ethyl ketone solution of the interface improver B1.

As a result of analysis of the obtained interface improver B1 by gel permeation chromatography (GPC), the weight-average molecular weight (Mw) thereof was 22000 (in terms of polystyrene).

### Synthesis Examples 2 to 10

The interface improvers B2 to B10 (see the formulae shown below) were synthesized with reference to the method of synthesizing the interface improver B1.

### Synthesis Example 11

An interface improver B11 was synthesized by the following procedures.

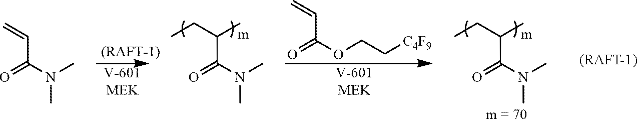

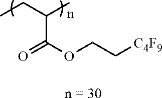

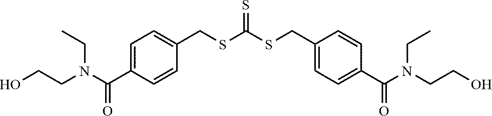 [SMILES: CCN(CCO)C(=O)c1ccc(CSC(=S)SCc2ccc(C(=O)N(CC)CCO)cc2)cc1]

The reaction container was heated until the internal temperature reached 80° C. in a nitrogen stream. A mixed solution of 14.0 g of N,N-dimethylacrylamide (manufactured by Tokyo Chemical Industry Co., Ltd.), 198 mg of a reversible addition/fragmentation chain transfer (RAFT) agent (RAFT-1), and 26 g of methyl ethyl ketone was added thereto, and the solution was heated at 80° C. to carry out a reaction for 6 hours (first step reaction).

After disappearance of the polymerizable group of N,N-dimethylacrylamide was confirmed by ¹H-NMR spectrum measurement, a mixed solution of 6.0 g of CHEMINOX FAAC-4 (manufactured by Unimatec Co., Ltd., 2-(perfluorobutyl)ethyl acrylate), 0.09 g of dimethyl 2,2′-azobis(2-methylpropionate) (trade name, “V-601”, manufactured by FUJIFILM Wako Pure Chemical Corporation), and 4 g of methyl ethyl ketone was added to the reaction container, and the solution was stirred at 80° C. for 20 hours for a polymerization reaction (second step reaction).

The disappearance of the polymerizable group of FAAC-4 was confirmed by ¹H-NMR spectrum measurement, and a methyl ethyl ketone solution of the interface improver (B1) was obtained.

As a result of analysis of the obtained interface improver B11 by gel permeation chromatography (GPC), the weight-average molecular weight (Mw) thereof was 12000 (in terms of polystyrene).

The structures of the interface improvers B1 to B11 are shown below. Further, the numerical values next to the parentheses of each repeating unit denote the content (% by mass) of each repeating unit with respect to all the repeating units of each polymer.

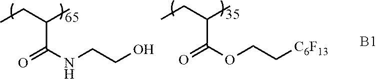

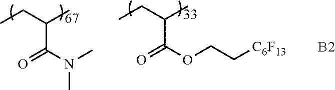

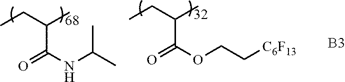

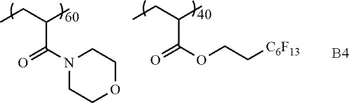

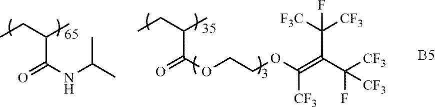

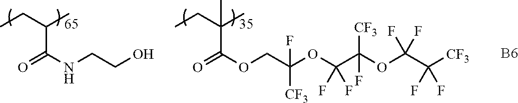

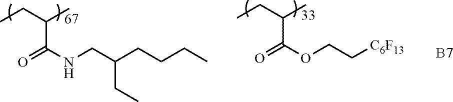

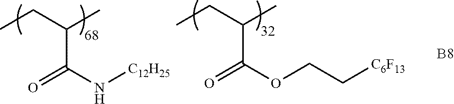

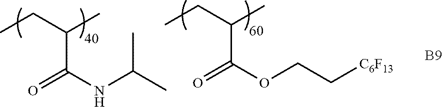

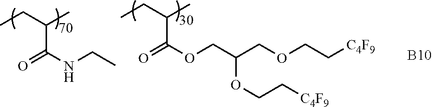

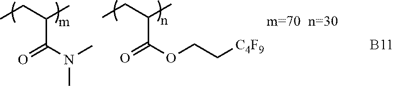

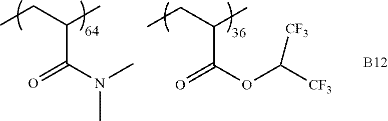

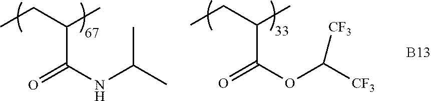

### Example 1-1

### Preparation of Cellulose Acylate Film 1

### Preparation of Core Layer Cellulose Acylate Dope

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution degree of 2.88: | 100 parts by mass |
| Polyester compound B described in example of JP2015-227955A: | 12 parts by mass |
| Compound F shown below: | 2 parts by mass |
| Methylene chloride (first solvent): | 430 parts by mass |
| Methanol (second solvent): | 64 parts by mass |

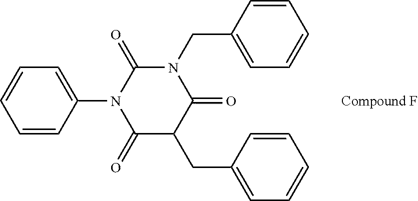 [SMILES: O=C1C(Cc2ccccc2)C(=O)N(c2ccccc2)C(=O)N1Cc1ccccc1]

### Preparation of Outer Layer Cellulose Acylate Dope

10 parts by mass of the following matting agent solution was added to 90 parts by mass of the above-described core layer cellulose acylate dope, thereby preparing a cellulose acetate solution used as an outer layer cellulose acylate dope.

Matting agent solution

| | |
|---|---|
| Silica particles with average particle size of 20 nm (AEROSIL R972, manufactured by Nippon Aerosil Co., Ltd.): | 2 parts by mass |
| Methylene chloride (first solvent): | 76 parts by mass |
| Methanol (second solvent): | 11 parts by mass |
| Core layer cellulose acylate dope described above: | 1 part by mass |

### Preparation of Cellulose Acylate Film 1

The core layer cellulose acylate dope and the outer layer cellulose acylate dope were filtered through filter paper having an average pore size of 34 µm and a sintered metal filter having an average pore size of 10 µm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 µm, and the optical film was used as a cellulose acylate film 1 (support 1). The in-plane retardation of the obtained cellulose acylate film 1 was 0 nm.

### Preparation of Photo-Alignment Layer PA1

The cellulose acylate film 1 was continuously coated with a coating solution PA1 for forming an alignment layer described below with a wire bar. The support on which a coating film was formed was dried with warm air at 140° C. for 120 seconds, and the coating film was irradiated with polarized ultraviolet rays (10 mJ/cm², using an ultra-high pressure mercury lamp) to form a photo-alignment layer PA1, thereby obtaining a TAC film provided with a photo-alignment layer.

The film thickness thereof was 0.5 µm.

(Coating solution PA1 for forming alignment layer)

| | |
|---|---|
| Polymer PA1 shown below: | 100.00 parts by mass |
| Acid generator PAG-1 shown below: | 8.00 parts by mass |
| Acid generator CPI-110TF shown below: | 0.005 parts by mass |
| Xylene: | 1220.00 parts by mass |
| Methyl isobutyl ketone: | 122.00 parts by mass |

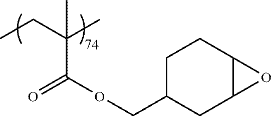

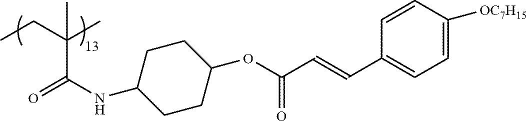

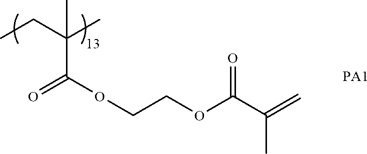

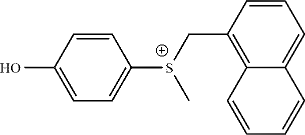 [SMILES: C[S+](Cc1cccc2ccccc12)c1ccc(O)cc1]

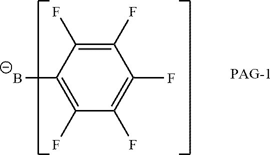

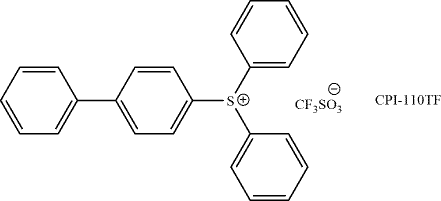

### Preparation of Optically Anisotropic Layer 1-1

The obtained photo-alignment layer PA1 was continuously coated with the following liquid crystal composition 1-1 using a #20 wire bar, thereby forming a coating layer.

Next, the coating layer was heated at 140° C. for 30 seconds and cooled to room temperature (23° C.). Next, the coating layer was heated at 90° C. for 60 seconds and cooled to room temperature again.

Thereafter, an optically anisotropic layer 1-1 was prepared on the photo-alignment layer PA1 by irradiation with light (center wavelength of 365 nm) of a light emitting diode (LED) lamp for 2 seconds under an irradiation condition of an illuminance of 200 mW/cm². The film thickness of the optically anisotropic layer 1-1 was 1.7 µm.

In this manner, a laminate 1-1 in which an optically anisotropic layer 1-1 was formed on the photo-alignment layer PA1 of the TAC film with the photo-alignment layer was obtained.

Composition of liquid crystal composition 1-1

| | |
|---|---|
| Polymer liquid crystal compound P1 shown below: | 2.730 parts by mass |
| Low-molecular-weight liquid crystal compound L1 shown below: | 0.933 parts by mass |
| Dichroic substance Y1 shown below: | 0.422 parts by mass |
| Dichroic substance M1 shown below: | 0.149 parts by mass |
| Dichroic substance C1 shown below: | 0.571 parts by mass |
| Polymerization initiator I1 (IRGACURE OXE-02, manufactured by BASF SE): | 0.124 parts by mass |
| Interface improver B1 shown below: | 0.012 parts by mass |
| Cyclopentanone: | 85.500 parts by mass |
| Tetrahydrofuran: | 9.500 parts by mass |

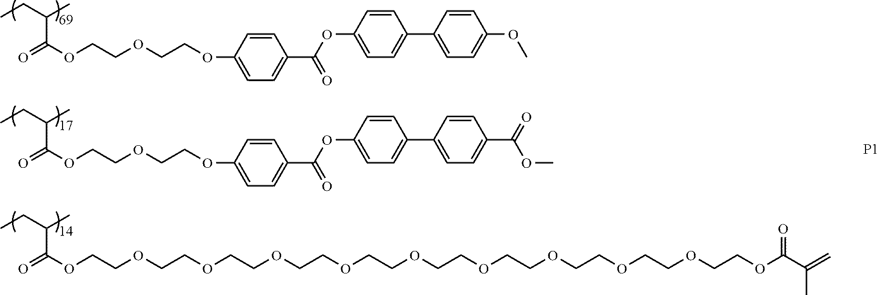

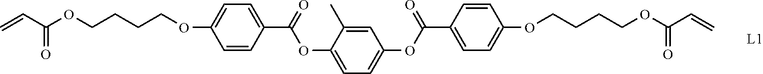 [SMILES: C=CC(=O)OCCCCOc1ccc(C(=O)Oc2ccc(OC(=O)c3ccc(OCCCCOC(=O)C=C)cc3)c(C)c2)cc1]

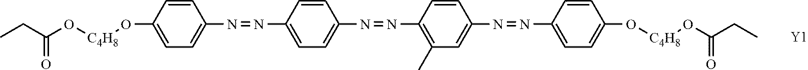

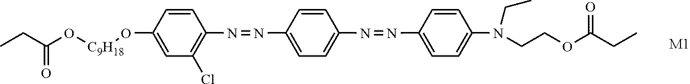

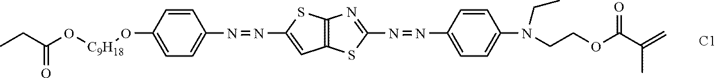

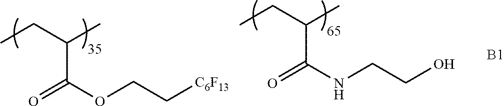

Further, both the polymer liquid crystal compound P1 and the low-molecular-weight liquid crystal compound L1 are rod-like liquid crystal compounds.

### Evaluation Test

### Alignment Defect

The laminate 1-1 of Example 1-1 was set on a sample table in a state in which a linear polarizer was inserted on a light source side of an optical microscope (product name, “ECLIPSE E600 POL”, manufactured by Nikon Corporation). Five sites were randomly selected from the sample and observed with a microscope and an objective lens at a magnification of 20 times. The average value of the number of alignment defects at the five measured sites was calculated, and the alignment defects were evaluated. The evaluation results are listed in Table 1.
A: The number of alignment defects was less than 5.
B: The number of alignment defects was 5 or greater and less than 20.
C: The number of alignment defects was 20 or greater and less than 50.
D: The number of alignment defects was 50 or greater.

### Alignment Degree

The laminate 1-1 of Example 1-1 was set on a sample table in a state in which a linear polarizer was inserted on a light source side of an optical microscope (product name, “ECLIPSE E600 POL”, manufactured by Nikon Corporation), the absorbance of the optically anisotropic layer 1-1 in a wavelength range of 380 nm to 780 nm was measured at a pitch of 1 nm using a multi-channel spectrometer (product name, “QE65000”, manufactured by Ocean Optics, Inc.), and the alignment degree in a wavelength range of 400 nm to 700 nm was calculated according to the following equation. Based on the obtained alignment degree, the alignment degree was evaluated according to the following evaluation standards. The evaluation results are listed in Table 1.

$$\text{Alignment degree:} \text{} \text{S=} \left(\left(\text{Az0/Ay0}\right) \text{-1}\right) \text{/} \left(\left(\text{Az0/Ay0}\right) \text{+2}\right)$$

In the equation described above, “Az0” represents the absorbance of the optically anisotropic layer with respect to the polarized light in the absorption axis direction, and “Ay0” represents the absorbance of the optically anisotropic layer with respect to the polarized light in the transmittance axis direction.
A: 0.96 or greater
B: 0.93 or greater and less than 0.96
C: 0.90 or greater and less than 0.93
D: less than 0.90

### Examples 1-2 to 1-15 and Comparative Examples 1-1 to 1-3

Each laminate of Examples 1-2 and 1-3, 1-5, 1-10, 1-12, 1-13, and 1-15 and Comparative Example 1-3 was obtained in the same manner as in Example 1-1 except that the alignment layer PA2 obtained by using the coating solution for forming an alignment film containing the following polymer PA2 was used in place of the polymer PA1 in the coating solution for forming an alignment layer and the composition of the liquid crystal composition 1-1 was changed to the composition listed in Table 1.

In addition, each laminate of Examples 1-4, 1-6 to 1-9, 1-11, and 1-14 and Comparative Examples 1-1 and 1-2 was obtained in the same manner as in Example 1-1 except that the composition of the liquid crystal composition 1-1 was changed to the composition listed in Table 1.

The alignment defects and the alignment degree were evaluated in the same manners as in Example 1-1 using each of the obtained laminates. The evaluation results are listed in Table 1.

Components other than the components described above among the components indicated by symbols in Table 1 are shown below. Further, the numerical values next to the parentheses of each repeating unit denote the content (% by mass) of each repeating unit with respect to all the repeating units of each polymer.

Further, the polymer liquid crystal compounds P2 to P5 and the low-molecular-weight liquid crystal compounds L2 to L6 are all rod-like liquid crystal compounds.

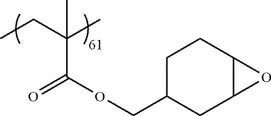

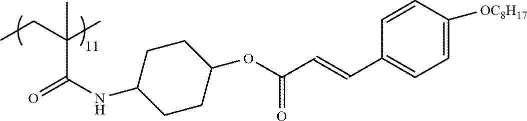

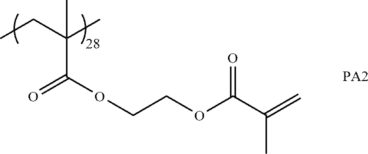

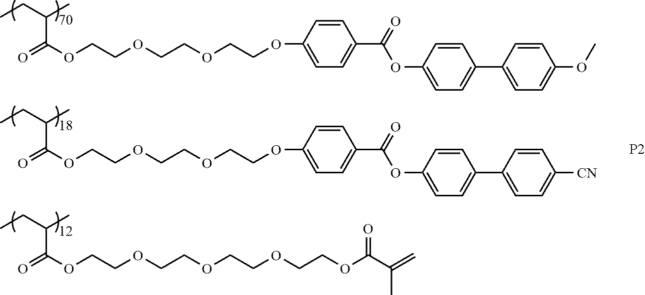

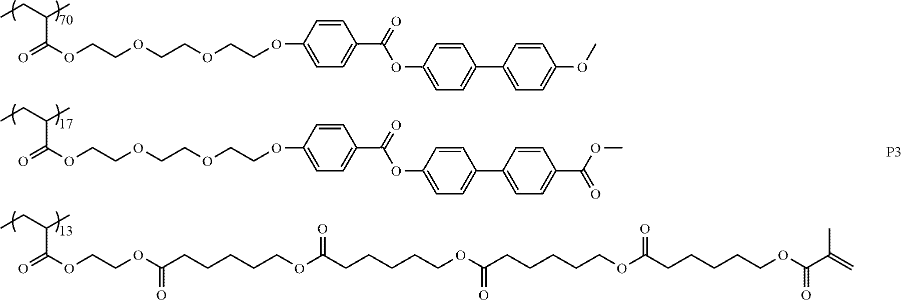

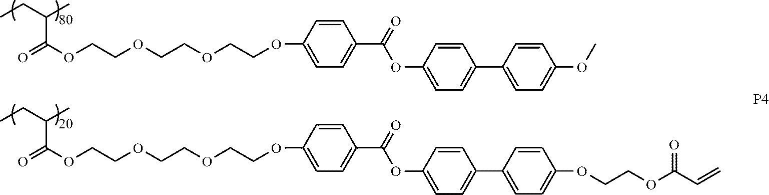

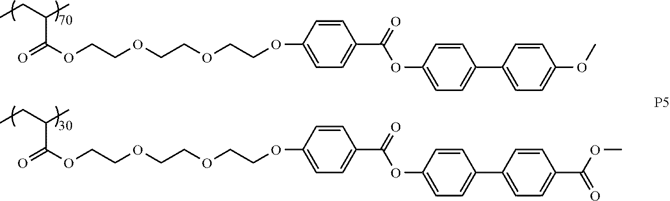

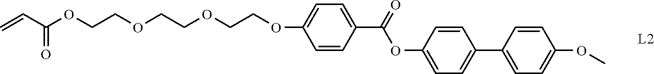 [SMILES: C=CC(=O)OCCOCCOCCOc1ccc(C(=O)Oc2ccc(-c3ccc(OC)cc3)cc2)cc1]

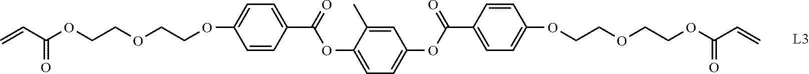 [SMILES: C=CC(=O)OCCOCCOc1ccc(C(=O)Oc2ccc(OC(=O)c3ccc(OCCOCCOC(=O)C=C)cc3)c(C)c2)cc1]

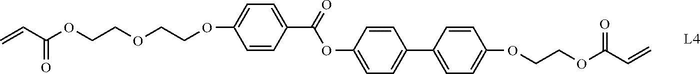 [SMILES: C=CC(=O)OCCOCCOc1ccc(C(=O)Oc2ccc(-c3ccc(OCCOC(=O)C=C)cc3)cc2)cc1]

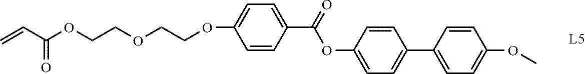 [SMILES: C=CC(=O)OCCOCCOc1ccc(C(=O)Oc2ccc(-c3ccc(OC)cc3)cc2)cc1]

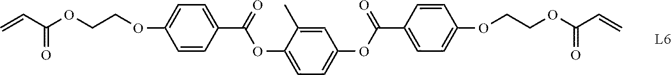 [SMILES: C=CC(=O)OCCOc1ccc(C(=O)Oc2ccc(OC(=O)c3ccc(OCCOC(=O)C=C)cc3)c(C)c2)cc1]

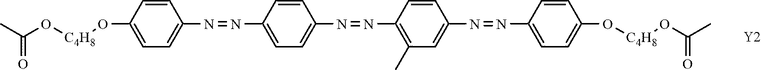

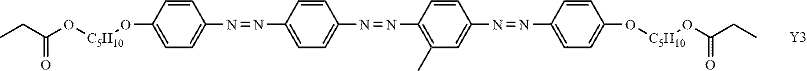

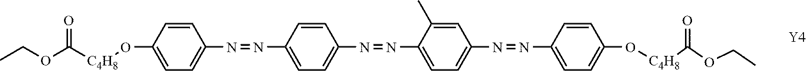

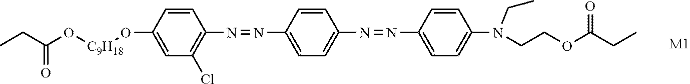

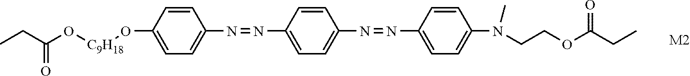

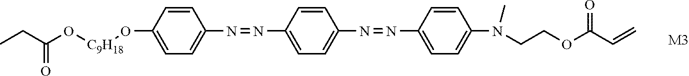

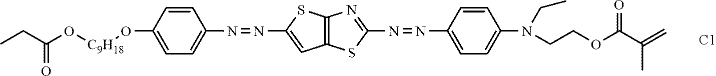

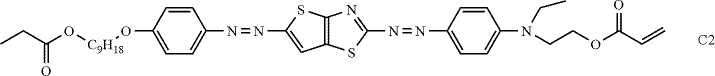

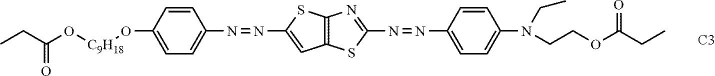

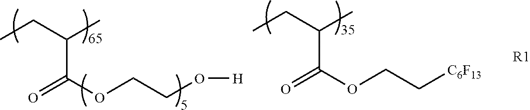

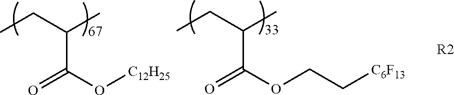

R3 (MEGAFACE F562, manufactured by DIC Corporation, fluorine-based interface improver having no repeating unit B1 represented by Formula (N-1))

TABLE 1

| | Photo-alignment layer | Polymer liquid crystal compound | | Low-molecular-weight liquid crystal compound | | Dichroic substance | | Dichroic substance | | Dichroic substance | | Interface improver | | | Polymerization initiator | | Tetrahydrofuran | Cyclopentanone | Alignment defects | Alignment degree |
|---|---|---|---|---|---|---|---|---|---|---|---|---|---|---|---|---|---|---|---|---|
| | | | | | | | | | | | | Type | Parts by mass | Total molecular weight of terminal groups | | | | | | |
| | | Type | Parts by mass | Type | Parts by mass | Type | Parts by mass | Type | Parts by mass | Type | Parts by mass | | | | Type | Parts by mass | Parts by mass | Parts by mass | | |
| Example 1-1 | PA1 | P1 | 2.684 | L1 | 1.013 | Y1 | 0.430 | M1 | 0.152 | C1 | 0.582 | B1 | 0.013 | 46.0 | I1 | 0.127 | 9.500 | 85.500 | A | B |
| Example 1-2 | PA2 | P1 | 2.546 | L2 | 1.098 | Y4 | 0.459 | M2 | 0.140 | C2 | 0.594 | B2 | 0.012 | 30.1 | I1 | 0.150 | 9.500 | 85.500 | A | A |
| Example 1-3 | PA2 | P3 | 2.570 | L2 | 1.086 | Y1 | 0.465 | M2 | 0.136 | C3 | 0.596 | B3 | 0.012 | 44.1 | I1 | 0.136 | 9.500 | 85.500 | A | A |
| Example 1-4 | PA1 | P3 | 3.017 | L4 | 0.754 | Y2 | 0.357 | M3 | 0.211 | C1 | 0.503 | B4 | 0.008 | 72.1 | I1 | 0.151 | 9.500 | 85.500 | B | A |
| Example 1-5 | PA2 | P1 | 2.598 | L3 | 1.039 | Y4 | 0.494 | M2 | 0.140 | C2 | 0.618 | B5 | 0.007 | 44.1 | I1 | 0.104 | 9.500 | 85.500 | A | A |
| Example 1-6 | PA1 | P4 | 2.440 | L5 | 1.220 | Y4 | 0.473 | M2 | 0.208 | C3 | 0.534 | B6 | 0.009 | 46.0 | I1 | 0.117 | 9.500 | 85.500 | A | A |
| Example 1-7 | PA1 | P1 | 2.660 | L6 | 1.209 | Y3 | 0.382 | M1 | 0.131 | C1 | 0.464 | B7 | 0.010 | 114.2 | I1 | 0.145 | 9.500 | 85.500 | C | B |
| Example 1-8 | PA1 | P1 | 2.669 | L4 | 1.099 | Y2 | 0.413 | M3 | 0.157 | C1 | 0.492 | B8 | 0.012 | 170.3 | I1 | 0.157 | 9.500 | 85.500 | C | C |
| Example 1-9 | PA1 | P3 | 2.593 | L2 | 1.089 | Y1 | 0.467 | M2 | 0.135 | C2 | 0.602 | B9 | 0.010 | 30.1 | I1 | 0.104 | 9.500 | 85.500 | A | A |
| Example 1-10 | PA2 | P2 | 2.634 | L4 | 1.064 | Y4 | 0.471 | M2 | 0.137 | C3 | 0.583 | B10 | 0.010 | 30.1 | I1 | 0.101 | 9.500 | 85.500 | A | A |
| Example 1-11 | PA1 | P5 | 2.418 | L6 | 1.306 | Y1 | 0.450 | M2 | 0.140 | C2 | 0.580 | B11 | 0.010 | 30.1 | I1 | 0.097 | 9.500 | 85.500 | A | A |
| Example 1-12 | PA2 | - | 0.000 | L1 | 3.620 | Y2 | 0.488 | M1 | 0.136 | C1 | 0.598 | B1 | 0.008 | 46.0 | I1 | 0.151 | 9.500 | 85.500 | B | c |
| Example 1-13 | PA2 | P1 | 3.615 | - | 0.000 | Y3 | 0.447 | M3 | 0.201 | C3 | 0.577 | B2 | 0.009 | 30.1 | I1 | 0.151 | 9.500 | 85.500 | B | B |
| Example 1-14 | PA1 | P2 | 2.693 | L3 | 1.270 | Y1 | 0.229 | M3 | 0.142 | C2 | 0.508 | B12 | 0.006 | 30.1 | I1 | 0.152 | 9.500 | 85.500 | A | A |
| Example 1-15 | PA2 | P1 | 2.793 | L1 | 1.205 | Y4 | 0.217 | M2 | 0.126 | C3 | 0.503 | B13 | 0.006 | 44.1 | I1 | 0.151 | 9.500 | 85.500 | A | A |
| Comparative Example 1-1 | PA1 | P2 | 2.633 | L2 | 1.043 | Y4 | 0.447 | M1 | 0.149 | C3 | 0.596 | R1 | 0.007 | - | I1 | 0.124 | 9.500 | 85.500 | D | D |
| Comparative Example 1-2 | PA1 | P3 | 2.569 | L1 | 1.058 | Y3 | 0.478 | M2 | 0.207 | C2 | 0.529 | R2 | 0.009 | - | I1 | 0.151 | 9.500 | 85.500 | D | D |
| Comparative Example 1-3 | PA2 | P1 | 2.569 | L2 | 1.058 | Y3 | 0.478 | M3 | 0.207 | C1 | 0.529 | R3 | 0.009 | - | I1 | 0.151 | 9.500 | 85.500 | D | D |

In the table, “total molecular weight of terminal groups” in the columns of the interface improver denotes the total molecular weight of the groups corresponding to R^{B11} and R^{B12} in Formula (N-1).

As listed in Table 1, it was found that an optically anisotropic layer with suppressed alignment defects and an excellent alignment degree was obtained in a case of using the liquid crystal composition containing a rod-like liquid crystal compound and a specific interface improver (Examples 1-1 to 1-15).

On the contrary, it was found that alignment defects occurred significantly and the alignment degree was also degraded in the optically anisotropic layer formed of the liquid crystal composition containing no specific interface improver (Comparative Examples 1-1 to 1-3).

Further, the liquid crystal compounds contained in the optically anisotropic layers of the examples and the comparative examples were all horizontally aligned.

### Example 2-1

Quartz glass was continuously coated with the coating solution PA1 for forming an alignment layer using a wire bar. The quartz glass on which a coating film was formed was dried at 140° C. for 120 seconds, and the coating film was irradiated with polarized ultraviolet rays (10 mJ/cm², using an ultra-high pressure mercury lamp) to form a photo-alignment layer PA1′, thereby obtaining quartz glass with a photo-alignment layer.

The photo-alignment layer PA1′ was continuously coated with the following liquid crystal composition 2-1 using a #20 wire bar to form a coating layer.

Next, the coating layer was heated at 130° C. for 30 seconds and cooled to room temperature (23° C.). Next, the coating layer was heated at 80° C. for 60 seconds and cooled to room temperature again.

Thereafter, an optically anisotropic layer 2-1 was prepared on the photo-alignment layer PA1′ by irradiation with light (center wavelength of 365 nm) of a light emitting diode (LED) lamp for 2 seconds under an irradiation condition of an illuminance of 200 mW/cm². The film thickness of the optically anisotropic layer 2-1 was 2.1 µm.

In this manner, a laminate 2-1 in which the optically anisotropic layer 2-1 was formed on the photo-alignment layer PA1′ of the quartz glass with a photo-alignment layer was obtained.

Composition of liquid crystal composition 2-1

| | |
|---|---|
| Polymer liquid crystal compound P1 shown above: | 5.597 parts by mass |
| Low-molecular-weight liquid crystal compound L1 shown above: | 2.112 parts by |
| Polymerization initiator I1 (IRGACURE OXE-02, by BASF SE): | 0.264 parts by mass |
| Interface improver B1 shown above: | 0.026 parts by mass |
| Cyclopentanone: | 82.800 parts by mass |
| Tetrahydrofuran: | 9.200 parts by mass |

### Evaluation Test

### Alignment Defect

One linear polarizer was set on a light source side and one linear polarizer was set on an ocular lens side of an optical microscope (product name, “ECLIPSE E600 POL”, manufactured by Nikon Corporation) such that the absorption axes were orthogonal to each other. The laminate 2-1 of Example 2-1 was set on a sample table between the two linear polarizers. Five sites were randomly selected from the sample and observed with a microscope and an objective lens at a magnification of 20 times. The average value of the number of alignment defects at the five measured sites was calculated, and the alignment defects were evaluated. The evaluation results are listed in Table 2.
A: The number of alignment defects was less than 10.
B: The number of alignment defects was 10 or greater and less than 30.
C: The number of alignment defects was 30 or greater and less than 50.
D: The number of alignment defects was 50 or greater.

### Alignment Degree

For the laminate 2-1 of Example 2-1, in a state in which a linear polarizer was inserted on a light source side of JASCO V-600 (manufactured by JASCO Corporation), the absorbance of the optically anisotropic layer 2-1 in a wavelength range of 300 nm to 400 nm was measured at a pitch of 1 nm, and the alignment degree in a wavelength range of 300 nm to 400 nm was calculated according to the following equation.

$$\text{Alignment degree: S =} \left(\left(\text{Az0} / \text{Ay0}\right) \text{-} 1\right) / \left(\left(\text{Az0} / \text{Ay0}\right) + 2\right)$$

In the equation described above, “Az0” represents the absorbance of the optically anisotropic layer with respect to the polarized light in the absorption axis direction, and “Ay0” represents the absorbance of the optically anisotropic layer with respect to the polarized light in the transmittance axis direction.
A: 0.85 or greater
B: 0.75 or greater and less than 0.85
C: 0.65 or greater and less than 0.75
D: less than 0.65

### Examples 2-2 to 2-10 and Comparative Examples 1-1 and 1-2

Each laminate of Examples 2-2 and 2-3, 2-7, 2-9, and 2-10 was obtained in the same manner as in Example 2-1 except that the alignment layer PA2′ obtained by using the coating solution for forming an alignment film containing the above-described polymer PA2 was used in place of the polymer PA1 in the coating solution PA1 for forming an alignment layer and the composition of the liquid crystal composition 2-1 was changed to the composition listed in Table 2.

In addition, each laminate of Examples 2-4 to 2-6 and 2-8 and Comparative Examples 2-1 and 2-2 was obtained in the same manner as in Example 2-1 except that the composition of the liquid crystal composition 2-1 was changed to the composition listed in Table 2.

The alignment defects and the alignment degree were evaluated in the same manners as in Example 2-1 using each of the obtained laminates. The evaluation results are listed in Table 2.

TABLE 2

| | Photo-alignment layer | Polymer liquid crystal compound | | Low-molecular-weight liquid crystal compound | | Interface improver | | | Polymerization initiator | | Tetrahydrofuran | Cyclopentanone | Alignment defects | Alignment degree |
|---|---|---|---|---|---|---|---|---|---|---|---|---|---|---|
| | | | | | | Type | Parts by mass | Total molecular weight of terminal groups | | | | | | |
| | | Type | Parts by mass | Type | Parts by mass | | | | Type | Parts by mass | Parts by mass | Parts by mass | | |
| Example 2-1 | PA1′ | P1 | 5.597 | L1 | 2.112 | B1 | 0.026 | 46.0 | I1 | 0.264 | 9.200 | 82.800 | A | B |
| Example 2-2 | PA2′ | P3 | 5.406 | L2 | 2.283 | B3 | 0.024 | 44.1 | I1 | 0.287 | 9.200 | 82.800 | A | A |
| Example 2-3 | PA2′ | P1 | 5.545 | L3 | 2.218 | B5 | 0.016 | 44.1 | I1 | 0.222 | 9.200 | 82.800 | A | A |
| Example 2-4 | PA1′ | P4 | 5.156 | L5 | 2.578 | B6 | 0.018 | 46.0 | I1 | 0.247 | 9.200 | 82.800 | A | A |
| Example 2-5 | PA1′ | P1 | 5.288 | L6 | 2.404 | B7 | 0.019 | 114.2 | I1 | 0.288 | 9.2200 | 82.800 | C | B |
| Example 2-6 | PA1′ | P1 | 5.423 | L4 | 2.233 | B8 | 0.024 | 170.3 | I1 | 0.319 | 9.200 | 82.800 | C | C |
| Example 2-7 | PA2 | P2 | 5.532 | L4 | 2.234 | B10 | 0.021 | 30.1 | I1 | 0.213 | 9.200 | 82.800 | A | A |
| Example 2-8 | PA1′ | P5 | 5.051 | L6 | 2.727 | B11 | 0.020 | 30.1 | I1 | 0.202 | 9.200 | 82.800 | A | A |
| Example 2-9 | PA2′ | P2 | 5.051 | L1 | 2.727 | B12 | 0.026 | 30.1 | I1 | 0.202 | 9.200 | 82.800 | A | A |
| Example 2-10 | PA2 | P1 | 5.051 | L1 | 2.727 | B13 | 0.026 | 44.1 | I1 | 0.202 | 9.200 | 82.800 | A | A |
| Comparative Example 2-1 | PA1′ | P2 | 5.532 | L2 | 2.192 | R1 | 0.016 | - | I1 | 0.261 | 9.200 | 82.800 | D | D |
| Comparative Example 2-2 | PA1′ | P3 | 5.428 | L1 | 2.233 | R2 | 0.018 | - | I1 | 0.319 | 9.200 | 82.800 | D | D |

As listed in Table 2, it was found that an optically anisotropic layer with suppressed alignment defects and an excellent alignment degree was obtained in a case of using the liquid crystal composition containing a rod-like liquid crystal compound and a specific interface improver (Examples 2-1 to 2-10).

On the contrary, it was found that alignment defects occurred significantly and the alignment degree was also degraded in the optically anisotropic layer formed of the liquid crystal composition containing no specific interface improver (Comparative Examples 2-1 and 2-2).

Further, the liquid crystal compounds contained in the optically anisotropic layers of the examples and the comparative examples were all horizontally aligned.

Here, a disk-like liquid crystal layer X containing the following discotic liquid-crystalline compound and the above-described interface improver R-1 was prepared with reference to the method described in paragraphs [0215] to [0219] of JP2006-126768A.

In addition, 1,2,1′,2′,1″,2″-tris[4,5-di(vinylcarbonyloxybutoxybenzoyloxy)phenylene (JP1996-50206A(JP-H8-50206A), (8) of the exemplary compound TE-8 described in paragraph 0044, m = 4) was used as the discotic liquid-crystalline compound.

Further, a disk-like liquid crystal layer Y was prepared in the same manner as in the method of preparing the disk-like liquid crystal layer X except that the interface improver R-1 was changed to the interface improver B-1.

One linear polarizer was set on a light source side and one linear polarizer was set on an ocular lens side of an optical microscope (product name, “ECLIPSE E600 POL”, manufactured by Nikon Corporation) such that the absorption axes were orthogonal to each other. The disk-like liquid crystal layer X or Y was set on a sample table between two linear polarizers and observed with a microscope and an objective lens at a magnification of 20 times, and as a result, it was confirmed that there was no difference in alignment defects.

In this manner, it was confirmed that the effects of the present invention are exhibited in a case of using the rod-like liquid crystal compound.

What is claimed is:

1. A liquid crystal composition comprising:
a rod-like liquid crystal compound; and
an interface improver having a repeating unit B1 represented by Formula (N-1) and a repeating unit B2 having a fluorine atom, 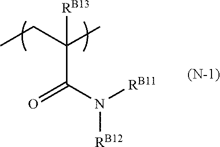
in Formula (N-1), R^{B11} and R^{B12} each independently represent a hydrogen atom or a substituent, and R^{B13} represents a hydrogen atom, an alkyl group having 1 to 5 carbon atoms, a halogen atom, or a cyano group, where, in a case where R^{B11} and R^{B12} represent a substituent, R^{B11} and R^{B12} may be linked to each other to form a ring.

2. The liquid crystal composition according to claim 1,
wherein in Formula (N-1), a total molecular weight of R^{B11} and R^{B12} is 100 or less.

3. The liquid crystal composition according to claim 1,
wherein in Formula (N-1), R^{B11} and R^{B12} each independently represent a hydrogen atom or an organic group having 1 to 15 carbon atoms.

4. The liquid crystal composition according to claim 1,
wherein a content of the repeating unit B1 is in a range of 3% to 75% by mass with respect to all repeating units of the interface improver.

5. The liquid crystal composition according to claim 1,
wherein the rod-like liquid crystal compound includes a polymer liquid crystal compound.

6. The liquid crystal composition according to claim 5,
wherein the rod-like liquid crystal compound further includes a low-molecular-weight liquid crystal compound.

7. The liquid crystal composition according to claim 1,
wherein the repeating unit B2 includes at least one of a repeating unit represented by Formula (F-1) or a repeating unit represented by Formula (F-2), 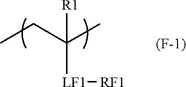
in Formula (F-1),
LF1 represents a single bond or a divalent linking group,
R1 represents a hydrogen atom, a fluorine atom, a chlorine atom, or an alkyl group having 1 to 20 carbon atoms,
RF1 represents a group containing at least one of groups (a) to (e),
(a) a group represented by Formula (1), (2), or (3),
(b) a perfluoropolyether group,
(c) an alkyl group having 1 to 20 carbon atoms, which has a hydrogen bond between a proton-donating functional group and a proton-accepting functional group and in which at least one carbon atom has a fluorine atom as a substituent,
(d) a group represented by Formula (1-d), and
(e) a group represented by Formula (1-e), 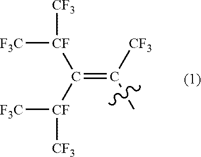 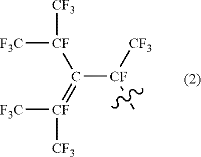 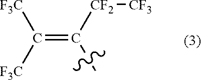 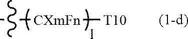
in Formula (1-d),
X represents a hydrogen atom or a substituent,
T10 represents a terminal group,
1 represents an integer of 1 to 20, m represents an integer of 0 to 2, n represents an integer of 1 to 2, and m + n is 2, 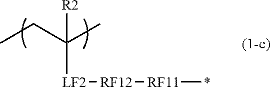
in Formula (1-e),
R2 represents a hydrogen atom, a fluorine atom, a chlorine atom, or an alkyl group having 1 to 20 carbon atoms,
LF2 represents a single bond or a divalent linking group,
RF11 and RF12 each independently represent a perfluoropolyether group, and
* represents a bonding position with respect to LF1 in Formula (F-1), 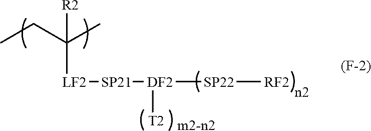
in Formula (F-2),
R2 represents a hydrogen atom, a fluorine atom, a chlorine atom, or an alkyl group having 1 to 4 carbon atoms, and LF2 represents the same group as LF1 in Formula (F-1),
SP21 and SP22 each independently represent a spacer group,
DF2 represents an (m2 + 1)-valent group,
T2 represents a terminal group,
RF2 represents a group having a fluorine atom,
n2 represents an integer of 2 or greater, m2 represents an integer of 2 or greater, and m2 is greater than or equal to n2.

8. The liquid crystal composition according to claim 1, further comprising: a dichroic substance.

9. An optically anisotropic layer which is formed of the liquid crystal composition according to claim 1.

10. A laminate comprising:
a base material; and
the optically anisotropic layer according to claim 9 which is provided on the base material,
wherein the rod-like liquid crystal compound contained in the optically anisotropic layer is fixed in a state of being aligned in a horizontal direction.

11. The laminate according to claim 10, further comprising: a λ/4 plate provided on the optically anisotropic layer.

12. An image display device comprising:
the optically anisotropic layer according to claim 9.

13. An image display device comprising:
the laminate according to claim 10.

14. The liquid crystal composition according to claim 2,
wherein in Formula (N-1), R^{B11} and R^{B12} each independently represent a hydrogen atom or an organic group having 1 to 15 carbon atoms.

15. The liquid crystal composition according to claim 2,
wherein a content of the repeating unit B1 is in a range of 3% to 75% by mass with respect to all repeating units of the interface improver.

16. The liquid crystal composition according to claim 2,
wherein the rod-like liquid crystal compound includes a polymer liquid crystal compound.

17. The liquid crystal composition according to claim 16,
wherein the rod-like liquid crystal compound further includes a low-molecular-weight liquid crystal compound.

18. The liquid crystal composition according to claim 2,
wherein the repeating unit B2 includes at least one of a repeating unit represented by Formula (F-1) or a repeating unit represented by Formula (F-2), 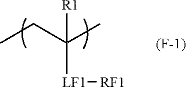
in Formula (F-1),
LF1 represents a single bond or a divalent linking group,
R1 represents a hydrogen atom, a fluorine atom, a chlorine atom, or an alkyl group having 1 to 20 carbon atoms,
RF1 represents a group containing at least one of groups (a) to (e),
(a) a group represented by Formula (1), (2), or (3),
(b) a perfluoropolyether group,
(c) an alkyl group having 1 to 20 carbon atoms, which has a hydrogen bond between a proton-donating functional group and a proton-accepting functional group and in which at least one carbon atom has a fluorine atom as a substituent,
(d) a group represented by Formula (1-d), and
(e) a group represented by Formula (1-e), 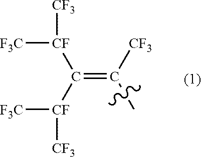 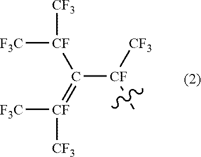 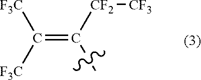 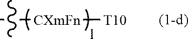
in Formula (1-d),
X represents a hydrogen atom or a substituent,
T10 represents a terminal group,
1 represents an integer of 1 to 20, m represents an integer of 0 to 2, n represents an integer of 1 to 2, and m + n is 2, 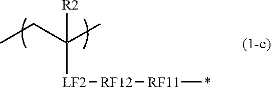
in Formula (1-e),
R2 represents a hydrogen atom, a fluorine atom, a chlorine atom, or an alkyl group having 1 to 20 carbon atoms,
LF2 represents a single bond or a divalent linking group,
RF11 and RF12 each independently represent a perfluoropolyether group, and
* represents a bonding position with respect to LF1 in Formula (F-1), 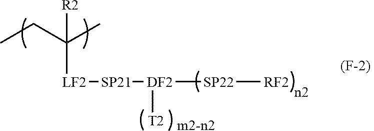
in Formula (F-2),
R2 represents a hydrogen atom, a fluorine atom, a chlorine atom, or an alkyl group having 1 to 4 carbon atoms, and LF2 represents the same group as LF1 in Formula (F-1),
SP21 and SP22 each independently represent a spacer group,
DF2 represents an (m2 + 1)-valent group,
T2 represents a terminal group,
RF2 represents a group having a fluorine atom,
n2 represents an integer of 2 or greater, m2 represents an integer of 2 or greater, and m2 is greater than or equal to n2.

19. The liquid crystal composition according to claim 2, further comprising: a dichroic substance.

20. An optically anisotropic layer which is formed of the liquid crystal composition according to claim 2.
